(19) United States
(12) Patent Application Publication
(10) Pub. No.: US 2016/0112723 A1
(43) Pub. Date: Apr. 21, 2016

(54) TRANSFER OF VIDEO AND RELATED DATA OVER SERIAL DATA INTERFACE (SDI) LINKS

(71) Applicant: ROSS VIDEO LIMITED, Iroquois (CA)

(72) Inventors: Yu LIU, Kanata (CA); Kizito Gysbertus Antonius VAN ASTEN, Kanata, Ontario (CA)

(21) Appl. No.: 14/516,599

(22) Filed: Oct. 17, 2014

(51) Int. Cl. H04N 19/65; H04N 19/102

(52) U.S. Cl. CPC H04N 19/65; H04N 19/102

(57) ABSTRACT

Video mix parameter data that is associated with video data is converted into link-compatible video mix parameter data for transfer over an SDI link. The video mix parameter data has a first range of permissible values, and the link-compatible video mix parameter data has a second range of permissible values permissible for the SDI link and narrower than the first range. Based on the video mix parameter data and data range conversion, error data for transfer over the SDI link is generated. The error data is indicative of an error introduced by the data range conversion. At a receive side, the error data is applied to received link-compatible video mix parameter data in converting the received link-compatible video mix parameter data into recovered video mix parameter data that is associated with the video data.

### CROSS-REFERENCE TO RELATED APPLICATION

The present application is related to U.S. patent application Ser. No. ______, entitled “PARALLEL VIDEO EFFECTS, MIX TREES, AND RELATED METHODS”, filed concurrently herewith and incorporated herein by reference.

### FIELD OF THE INVENTION

This invention relates generally to video processing and, in particular, to transfer of information between video processing components, such as for parallel video effects and mix trees.

### BACKGROUND

Video production switchers provide a function which layers multiple video sources. Each video source is associated with an alpha source which defines transparent areas of the video source on the top over lower layers. The base layer or the base source is called the background. Traditionally, the background is not associated with any alpha. It can be thought of as a fully visible layer which blocks any scenes behind it.

Conventional cascaded or sequential processing of video effects such as layering can entail significant delay. Although parallel structures are possible, such structures may entail higher precision for video and/or alpha data beyond what is typically transferred between video processing components.

### SUMMARY

An aspect of the present disclosure relates to a data encoder that includes: a data range converter to convert video mix parameter data that is associated with video data into link-compatible video mix parameter data for transfer over a Serial Data Interface (SDI) link, the video mix parameter data having a first range of permissible values and the link-compatible video mix parameter data having a second range of permissible values, the second range being a range of values permissible for the SDI link and narrower than the first range; and an error generator operatively coupled to the data range converter to generate, based on the video mix parameter data and data range conversion by the data range converter, error data for transfer over the SDI link, the error data indicative of an error introduced by the data range conversion.

The error generator could be operable to generate the error data based on a difference between the video mix parameter data and scaled video mix parameter data, or based on a difference between the video mix parameter data and video mix parameter data that has been scaled and subsequently upscaled.

A transmitter could include such a data encoder and an SDI transceiver operatively coupled to the data encoder.

In an embodiment, the SDI transceiver is to receive the link-compatible video mix parameter data, the error data, and additional-precision video mix parameter data that provides additional precision for the video mix parameter data, to transfer the link-compatible video mix parameter data in first video slots on the SDI link, and to transfer the error data concatenated with the additional-precision video mix parameter data in second video slots on the SDI link.

In another embodiment, the SDI transceiver is to receive the link-compatible video mix parameter data, additional-precision video mix parameter data that provides additional precision for the video mix parameter data, and a signal comprising the error data, to transfer the link-compatible video mix parameter data in first video slots on the SDI link, to transfer the additional-precision video mix parameter data in second video slots on the SDI link, and to transfer the signal comprising the error data in third video slots on the SDI link.

The SDI transceiver, in a further embodiment, is to receive the link-compatible video mix parameter data and a signal comprising a concatenation of the error data, additional-precision video mix parameter data that provides additional precision for the video mix parameter data, and additional-precision video data that provides additional precision for a component of the video data, to transfer the link-compatible video mix parameter signal in first video slots on the SDI link, and to transfer the signal comprising the concatenation in second video slots on the SDI link.

According to yet another embodiment, the SDI transceiver is to receive the link-compatible video mix parameter data, a signal comprising the error data, and a signal comprising a concatenation of additional-precision video mix parameter data that provides additional precision for the video mix parameter data and additional-precision video data that provides additional precision for a component of the video data, to transfer the link-compatible video mix parameter data in first video slots on the SDI link, to transfer the signal comprising the concatenation in second video slots on the SDI link, and to transfer the signal comprising the error data in third video slots on the SDI link.

The SDI transceiver could receive the link-compatible video mix parameter data and a signal comprising a concatenation of the error data, additional-precision video mix parameter data that provides additional precision for the video mix parameter data, additional-precision video data that provides additional precision for a first component of the video data, and additional-precision video data that provides additional precision for a second component of the video data, transfer the link-compatible video mix parameter data in first video slots on the SDI link, and transfer the signal comprising the concatenation in second video slots on the SDI link.

In a still further embodiment, the SDI transceiver is to receive the link-compatible video mix parameter signal, a signal comprising the error data, and a signal comprising a concatenation of additional-precision video mix parameter data that provides additional precision for the video mix parameter data, additional-precision video data that provides additional precision for a first component of the video data, and additional-precision video data that provides additional precision for a second component of the video data, to transfer the link-compatible video mix parameter data in first video slots on the SDI link, to transfer the signal comprising the concatenation in second video slots on the SDI link, and to transfer the signal comprising the error data in third video slots on the SDI link.

A video processing system includes a transmitter and a receiver. The transmitter includes a data encoder as disclosed herein and a first SDI transceiver, operatively coupled to the data encoder, to transfer the link-compatible video mix parameter data in first video slots on the SDI link, and to transfer the error data and additional-precision video mix parameter data that provides additional precision for the video mix parameter data in at least second video slots on the SDI link. The receiver includes a second SDI transceiver, operatively coupled to the SDI link, to receive the link-compatible video mix parameter data, the error data, and the additional-precision video mix parameter data on the SDI link; and a data decoder, operatively coupled to the second SDI transceiver. The data decoder includes a data range converter to convert the link-compatible video mix parameter data into recovered video mix parameter data having the first range of permissible values; and an error correction module to apply the error data to the recovered video mix parameter data.

In such a video processing system, the transmitter could also include a third SDI transceiver coupled to receive the video data and to transfer the video data over a second SDI link, and the receiver could also include a fourth SDI transceiver, operatively coupled to the second SDI link, to receive the video data over the second SDI link.

A method involves: converting video mix parameter data that is associated with video data into link-compatible video mix parameter data for transfer over an SDI link, the video mix parameter data having a first range of permissible values and the link-compatible video mix parameter data having a second range of permissible values, the second range being a range of values permissible for the SDI link and narrower than the first range; and generating, based on the video mix parameter data and data range conversion, error data for transfer over the SDI link, the error data indicative of an error introduced by the data range conversion.

The generating could involve generating the error data based on a difference between the video mix parameter data and scaled video mix parameter data, or generating the error data based on a difference between the video mix parameter data and video mix parameter data that has been scaled and subsequently upscaled.

In an embodiment, the method also involves transferring the link-compatible video mix parameter data in first video slots on the SDI link, and transferring other data or signals in at least second video slots on the SDI link.

The method could involve transferring the error data, concatenated with additional-precision video mix parameter data that provides additional precision for the video mix parameter data, in second video slots on the SDI link.

According to another embodiment, the method involves transferring, in second video slots on the SDI link, additional-precision video mix parameter data that provides additional precision for the video mix parameter data; and transferring a signal comprising the error data in third video slots on the SDI link.

The method could involve transferring, in second video slots on the SDI link, a signal comprising a concatenation of the error data, additional-precision video mix parameter data that provides additional precision for the video mix parameter data, and additional-precision video data that provides additional precision for a component of the video data.

In yet another embodiment, the method involves transferring, in second video slots on the SDI link, a signal comprising a concatenation of additional-precision video mix parameter data that provides additional precision for the video mix parameter data and additional-precision video data that provides additional precision for a component of the video data; and transferring a signal comprising the error data in third video slots on the SDI link.

The method could involve transferring, in second video slots on the SDI link, a signal comprising a concatenation of the error data, additional-precision video mix parameter data that provides additional precision for the video mix parameter data, additional-precision video data that provides additional precision for a first component of the video data, and additional-precision video data that provides additional precision for a second component of the video data.

Another embodiment of such a method involves transferring, in second video slots on the SDI link, a signal comprising a concatenation of additional-precision video mix parameter data that provides additional precision for the video mix parameter data, additional-precision video data that provides additional precision for a first component of the video data, and additional-precision video data that provides additional precision for a second component of the video data; and transferring a signal comprising the error data in third video slots on the SDI link.

A method could also include transferring, in at least second video slots on the SDI link, the error data and additional-precision video mix parameter data that provides additional precision for the video mix parameter data; and at a receiver: receiving the link-compatible video mix parameter data, the error data, and the additional-precision video mix parameter data on the SDI link; converting the link-compatible video mix parameter data into recovered video mix parameter data having the first range of permissible values; and applying the error data to the recovered video mix parameter data.

A data decoder includes: an input to receive link-compatible video mix parameter data and link-compatible error data that are transferred over an SDI link, the link-compatible error data being indicative of an error introduced in generating the link-compatible video mix parameter data from video mix parameter data that is associated with video data; and an error corrector, operatively coupled to the input, to apply the error data in converting the received link-compatible video mix parameter into recovered video mix parameter data that is associated with the video data.

The data decoder could also include a data range converter to convert the received link-compatible video mix parameter data into converted video mix parameter data having a first range of permissible values, the link-compatible video mix parameter data having a second range of permissible values, the second range being a range of values permissible for the SDI link and narrower than the first range. The error corrector could then be coupled to the data range converter, to apply the error data to the converted video mix parameter data.

A method according to another aspect of the present disclosure involves: receiving link-compatible video mix parameter data and link-compatible error data that are transferred over an SDI link, the link-compatible error data being indicative of an error introduced in generating the link-compatible video mix parameter data from video mix parameter data that is associated with video data; and applying the error data in converting the received link-compatible video mix parameter data into recovered video mix parameter data that is associated with the video data.

The method could also involve converting the received link-compatible video mix parameter data into converted video mix parameter data having a first range of permissible values, the link-compatible video mix parameter data having a second range of permissible values, the second range being a range of values permissible for the SDI link and narrower than the first range, in which case the applying involves applying the error data to the converted video mix parameter data.

Other aspects and features of embodiments of the present disclosure may become apparent to those ordinarily skilled in the art upon review of the following description.

### BRIEF DESCRIPTION OF THE DRAWINGS

Examples of embodiments of the invention will now be described in greater detail with reference to the accompanying drawings.

FIG. 1 illustrates an example of layering of multiple video sources.

FIG. 2 illustrates A/B mixing.

FIG. 3 is a block diagram of a binary tree depicting a cascaded chain of multiple A/B mix processes.

FIG. 4 illustrates an example parallel structure for a binary mix tree.

FIG. 5 illustrates an example parallel span for complementary alphas in a binary mix tree.

FIG. 6 is an example plot of errors for video data and alpha data in terms of complementary alpha values.

FIGS. 7A to 7D are example plots of total errors in terms of various video calculation fractional precisions and various source alpha values for N=4, 8, 32, and 64 layers mix trees (with L=2, 3, 5, and 6 levels), respectively.

FIG. 8A is an example plot of total errors in terms of various video calculation fractional precisions and various source alpha values for N=256 layers with L=8, and

FIG. 8B is a magnified view of a portion of FIG. 8A.

FIG. 9A is an example plot of total errors in terms of various video calculation fractional precisions and various source alpha values for N=2048 layers with L=11, and FIG. 9B is a magnified view of a portion of FIG. 9A.

FIG. 10 is an example plot of errors in terms of various video calculation precisions and random source alpha values for N=256 layers with L=8, for fractional precision from 1 to 10 bits but a smaller error range than in FIGS. 8A and 8B.

FIG. 11 is an example plot of errors in terms of various video calculation precisions and random source alpha values for N=2048 layers with L=11, for fractional precision from 1 to 11 bits but a smaller error range than in FIGS. 9A and 9B.

FIG. 12 is a block diagram illustrating an example video processing system.

FIG. 13 is a block diagram illustrating another example video processing system.

FIG. 14 is a block diagram illustrating a further example video processing system.

FIG. 15 is an example plot of errors between source alpha and expanded alpha.

FIGS. 16A and 16B illustrate example alpha data structures in Standard Definition (SD) Serial Data Interface (SDI) and High Definition (HD) SDI, respectively.

FIG. 17 is a block diagram of an example system that implements scaling and expansion of alpha data.

FIG. 18 is an example plot of errors between source alpha and scaled alpha.

FIG. 19 illustrates further example alpha data structures in SD SDI and HD SDI.

FIG. 20 is a block diagram illustrating another example video processing system.

FIG. 21 is a block diagram illustrating a further example video processing system.

FIG. 22 illustrates still further example alpha data structures in SD SDI and HD SDI.

FIG. 23 is a block diagram illustrating another example video processing system.

FIG. 24 is a block diagram illustrating a further example video processing system.

FIGS. 25 and 26 illustrate example alpha data structures using horizontal (H) blank periods in SD SDI and HD SDI, respectively.

FIG. 27 is a block diagram illustrating an example video processing system, and shows an ancillary data processing flow.

FIGS. 28 and 29 together illustrate an example video processing system that implements embedding of 2-bit alpha errors into the H blank period on an SDI link.

FIG. 30 illustrates example alpha+luminance (luma) data structures in SD SDI and HD SDI.

FIG. 31 is a block diagram illustrating another example video processing system.

FIG. 32 illustrates example alpha+luma data structures in which 2-bit errors are embedded into an H blank period in SD SDI and HD SDI.

FIGS. 33 and 34 together illustrate an example video processing system that implements an alpha+luma data structure and embedding of 2-bit alpha errors into the H blank period on an SDI link.

FIG. 35 illustrates example alpha+luminance (luma)+chrominance (chroma) data structures in SD SDI and HD SDI.

FIG. 36 is a block diagram illustrating another example video processing system.

FIG. 37 illustrates example alpha+luma+chroma data structures in which 2-bit errors are embedded into an H blank period in SD SDI and HD SDI.

FIGS. 38 and 39 together illustrate an example video processing system that implements an alpha+luma+chroma data structure and embedding of 2-bit alpha errors into the H blank period on an SDI link.

FIGS. 40 and 41 are flow diagrams illustrating example methods.

### DETAILED DESCRIPTION

### Video Layering

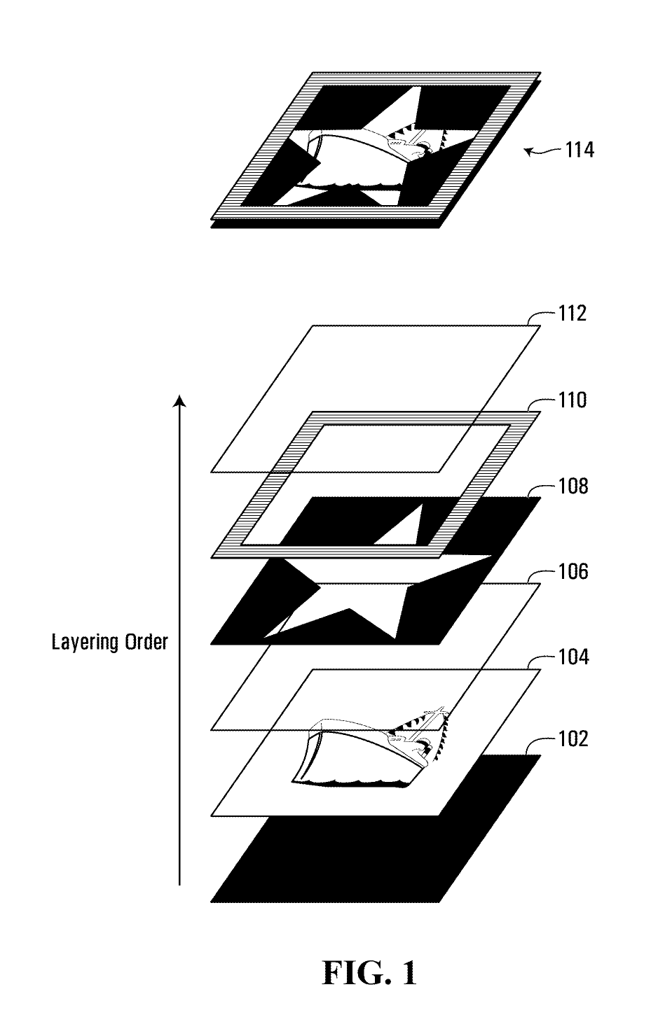

FIG. 1 illustrates an example of layering of multiple video sources. On the bottom of the drawing above the drop shadow background 102, the base video source 104 is a ship against a backdrop. On the top over the base video source 104, a pre-lighting layer 106 sheds a light on the center of the base video source. A pattern mask 108 crops the shining ship by a star shape. A border 110 is superimposed on the pre-lit and star-cropped base video source 104. Finally, post-lighting 112 is applied to the combination of lower layers, to re-shine the ship again, with a different color light for example. The resultant layered video is shown at 114.

Such video layering is illustrative of a type of video processing to which embodiments of the present disclosure could be applied.

### A/B Mix Effect

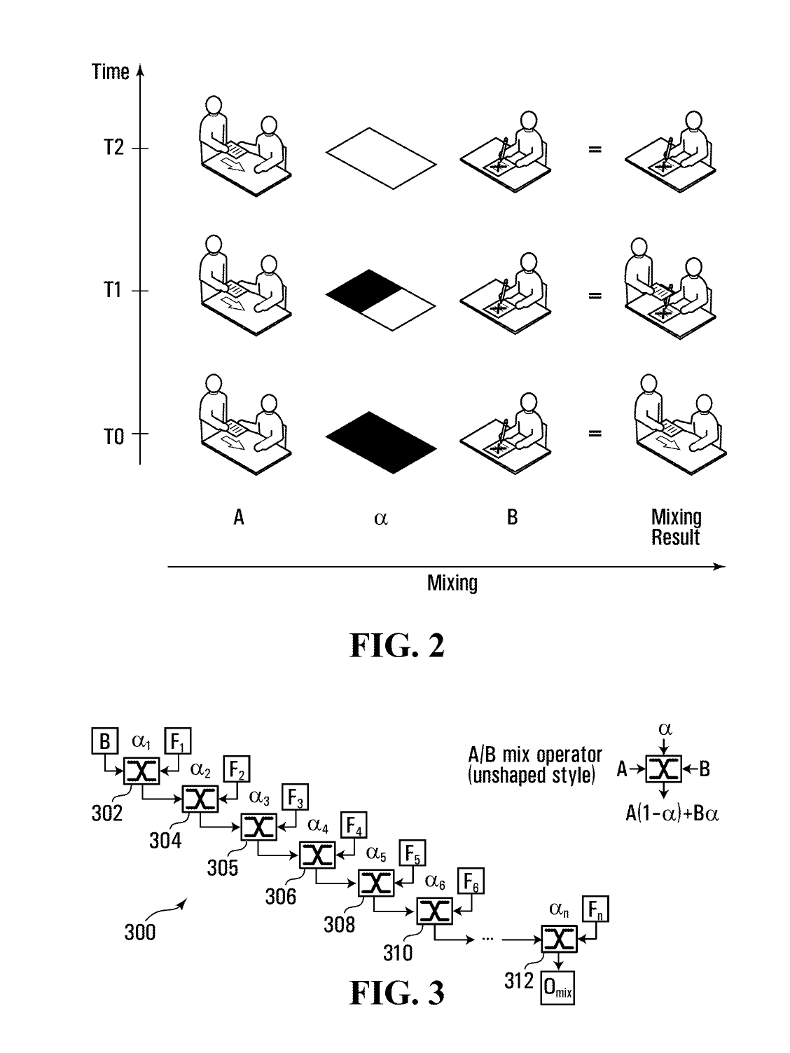

One possible way to implement video layering such as shown in FIG. 1 is to layer each video source on the top over preceding layers by applying a so-called A/B mix effect or operation. FIG. 2 illustrates A/B mixing, or a process of A/B mix effect, where a preceding layer video source A is gradually overlapped by an upper layer video source B. At time T0, an alpha channel associated with video source B defines all areas of layer B as see-through to the bottom layer A. At time T1, the associated alpha channel defines a part of layer B as opaque to the lower layer A, and video source B takes over the opaque area. At time T2, the associated alpha channel defines the entire area of layer B as opaque to video source A, and hence video source B covers the entire lower layer video source A.

The A/B mix effect is expressed in such a formula as:

Oₘᵢₓ=(1−α)A+αB, where αε[0,1] Eq. 1-1

The A/B mix effect has following properties.
1. Only two video sources A and B are involved. The layering process does not involve other video sources.
2. There is seamless transition between two equal sources, when A=B. In this case Oₘᵢₓ=(1−α)A+αB=(1−α)A+αA=A and no transition error occurs, under a condition that any arithmetic operation maintains sufficient precision.
3. There is also no error propagation because any limited precision of the alpha channel does not carry on into following layering processes. In other words, the associated alpha channel is only used in a single mix effect related only to a current upper layer.
4. An alpha channel associated with video source B could be an attribute extracted from layer B such as a chrominance (chroma) key and/or luminance (luma) key. It could instead be designed specifically for layer B use but not be extracted from layer B, such as an auto-key. It could also or instead include a completely independent control signal created and modified externally regardless of layer B, such as a preset pattern key. Thus, an alpha channel is associated with a video source, but need not necessarily be extracted from a video source or layer.

Another style of expression of the A/B mix effect is as follows:

Oₘᵢₓ=Aα′+\hat{B}, where α′=(1−α) and \hat{B}=αB Eq. 1-2

Eq. 1-2 is called the shaped style of A/B mix effect because the new upper layer video source B is pre-multiplied or pre-shaped by its associated alpha channel ahead of the mix operation, while the bottom layer video source A is multiplied or weighted by layer B's complementary alpha, α′. This shaped style of A/B mix effect is useful for further layering-related mathematic derivations set out herein.

### Cascade Mix Tree

When multiple video sources are layered through cascaded A/B mix effects, the resultant output can be expressed in a formula:

$$\begin{matrix}{o}_{mix} = ( … ( ( B {α}_{1}^{′} + {F}_{1} {α}_{1} ) {α}_{2}^{′} + {F}_{2} {α}_{2} ) {α}_{3}^{′} + … ) {α}_{n}^{′} + {F}_{n} {α}_{n} = \\ = ( … ( ( B {α}_{1}^{′} + {\hat{F}}_{1} ) {α}_{2}^{′} + {\hat{F}}_{2} ) {α}_{3}^{′} + … + {\hat{F}}_{n - 1} ) {α}_{n}^{′} + {\hat{F}}_{n}\end{matrix} \qquad Eq . 1 \text{-} 3$$

where
Oₘᵢₓ is output of cascaded A/B mix processes,
B is a base layer or background,
Fᵢ is a foreground video source at layer i
\hat{F}ᵢ is a preshaped foreground video at layer i
αᵢ is the mixing alpha at layer i, associated with Fᵢ
αᵢ′ is a complementary alpha equal to (1−αᵢ).

In Eq. 1-3, all layers except the base layer or background are referred to as foreground.

A graph or binary tree is used to describe Eq. 1-3, as illustrated in FIG. 3. FIG. 3 is a block diagram of a binary tree depicting a cascaded chain of multiple A/B mix processes. Such a binary tree is called a mix tree in the video production switcher industry.

As shown, the example binary tree 300 includes a background video source B, and n foreground video sources F₁ through Fₙ each having an associated alpha channel. The A/B mix operators 302, 304, 305, 306, 308, 310, 312, and any further mix operators between 310 and 312, perform A/B mixing on their video input data. The A/B mix operator 302 receives two video sources B and F₁, and each subsequent A/B mix operator in the example binary tree receives as its video input data one video source Fᵢ and one output from a lower layer A/B mix operator. The output Oₘᵢₓ is the final output from the last A/B mix operator 312 in the example binary tree 300.

### Issues on Cascade Mix Trees

A binary tree of cascaded mix processes, expressed in Eq. 1-3 and illustrated in FIG. 3, has an issue of a long electronic delay. In order to appreciate the amount of delay and its impact on video production switcher performance, consider an example of advanced video production switchers which can provide
4 to 8 Multiple Level Effect devices (MLEs) per switcher,
4 to 8 keys per MLE, and
4 to 8 effect layers per key.

The minimum number of layers in this example is 4×4×4=2⁶, and the maximum layers is 8×8×8=2⁹. In the future, the number of keys and the number of MLEs could be even higher. If each layer mix requires 4 or 5 pixel samples to implement Eq. 1-1, then the maximum number of calculation cycles could be beyond 2¹¹=2048, which is close to a High Definition (HD) horizontal resolution of 2200 pixels. However, according to SMPTE RP168-2009 from the Society of Motion Picture & Television Engineers (SMPTE), a switch position shall keep a variation within a half of an HD line. A cascade tree may produce a process delay beyond this requirement from SMPTE RP168-2009.

### Parallel Mix Trees

A parallel structure for a mix tree could not only reduce the number of stages and the corresponding delays, but could also take advantage of advanced parallel computing techniques. For instance, if a full parallel structure is used, processing stages could be reduced from 2⁹=512 for a cascade mix tree to just 9 for a parallel structure as described below.

Although parallel structures are useful for implementing mix trees, a parallel structure could introduce concerns regarding calculation precision and data accuracy, as discussed below. Fortunately, advanced processing techniques provide computing devices with floating-point arithmetic units or wider-bit fixed-point arithmetic units sufficient to alleviate such concerns.

### Full Parallel Structure

With reference to Eq. 1-3, in order to simplify derivations the following are defined:
1) the top layer is layer n=2^{L}−1 where L is the number of levels in the parallel binary tree,
2) including the background, the total number of video sources is 2^{L}, and
3) the cascade tree splits into two segments, including a first segment starting at the background and ending at layer (2^{L-1}−1), and a second segment starting at layer 2^{L-1} and ending at layer (2^{L}−1).

Then, Eq. 1-3 can be re-written as:

Oₘᵢₓ=( . . . ((( . . . ((Bα₁′+\hat{F}₁)α₂′+\hat{F}₂) . . . )α₂_{^{L-1}}₋₁′+\hat{F}₂_{^{L-1}}₋₁)α₂_{^{L-1}}′+\hat{F}₂_{^{L-1}}) . . . +\hat{F}₂_{^{L}}₋₂)α₂_{^{L}}₋₁′+\hat{F}₂_{^{L}}₋₁ Eq. 2-1

where \hat{F}ᵢ=Fᵢαᵢ, iε[1,2^{L}−1].
\hat{F}ᵢ is the shaped style of A/B mix defined in Eq. 1-2.

Defining the first segment of the mix tree in Eq. 2-1 as a background O_{L-1,1} at the second level (L−1):

O_{L-1,1}=( . . . ((Bα₁′+\hat{F}₁)α₂′+\hat{F}₂)α₃′+ . . . )α₂_{^{L-1}}₋₁′+\hat{F}₂_{^{L-1}}₋₁ Eq. 2-2

The subscript notation i,j means node j at level i. Using this notation, Eq. 2-1 becomes:

$$\begin{matrix}{o}_{mix} = ( … ( ( {o}_{L - 1 , 1} {α}_{{2}^{L - 1}}^{′} + {\hat{F}}_{{2}^{L - 1}} ) {α}_{{2}^{L - 1} + 1}^{′} + {\hat{F}}_{{2}^{L - 1} + 1} ) \\ {α}_{{2}^{L - 1} + 2}^{′} … + {\hat{F}}_{{2}^{L} - 2} ) {α}_{{2}^{L} - 1}^{′} + {\hat{F}}_{{2}^{L} - 1} \\ = {o}_{L - 1 , 1} {α}_{{2}^{L - 1}}^{′} … {α}_{2 \cdot {2}^{L - 1} - 1}^{′} + ( … ( {\hat{F}}_{{2}^{L - 1}} {α}_{{2}^{L - 1} + 1}^{′} ) \\ {α}_{2 \cdot {2}^{L - 1} - 1}^{′} + {\hat{F}}_{2 \cdot {2}^{L - 1} - 1}\end{matrix} \qquad Eq . 2 \text{-} 3$$

Define the second segment of the mix tree in Eq. 2-1 as a foreground O_{L-1,2} relative to the background O_{L-1,1}:

O_{L-1,2}=( . . . ((\hat{F}₂_{^{L-1}}α₂_{^{L-1}}₊₁′+\hat{F}₂_{^{L-1}}₊₁)α₂_{^{L-1}}₊₂′+\hat{F}₂_{^{L-1}}₊₂)α₂_{^{L-1}}₊₃′+ . . . )α_{2·2}_{^{L-1}}₋₁′+\hat{F}_{2·2}_{^{L-1}}₋₁ Eq. 2-4

Then, Eq. 2-3 as well as Eq. 2-1 simplify to:

$${o}_{mix} = {o}_{L - 1 , 1} {α}_{L - 1 , 2}^{′} + {o}_{L - 1 , 2} , where {α}_{L - 1 , 2}^{′} = {\prod }_{i = 1 \cdot {2}^{L - 1}}^{2 \cdot {2}^{L - 1} - 1} {α}_{i}^{′} \qquad Eq . 2 \text{-} 5$$

Further splits in level (L−1) produce the level (L−2) of A/B mixes. For instance, O_{L-1,1} splits into O_{L-2,1} and O_{L-2,2} such that:

$$\begin{matrix} {o}_{L - 1 , 1} = ( ( ( … ( ( B {α}_{1}^{′} + {\hat{F}}_{1} ) {α}_{2}^{′} + {\hat{F}}_{2} ) {α}_{3}^{′} + … ) {α}_{{2}^{L - 2} - 1}^{′} + \\ {\hat{F}}_{{2}^{L - 2} - 1} ) {α}_{{2}^{L - 2}}^{′} + {\hat{F}}_{{2}^{L - 2}} ) … + {\hat{F}}_{2 \cdot {2}^{L - 2} - 1} \\ = {o}_{L - 2 , 1} {α}_{L - 2 , 2}^{′} + {o}_{L - 2 , 2}\end{matrix} \\ where \\ {α}_{L - 2 , 2}^{′} = {α}_{{2}^{L - 2}}^{′} {α}_{{2}^{L - 2} + 1}^{′} … {α}_{{2}^{L - 1} - 2}^{′} {α}_{{2}^{L - 1} - 1}^{′} = {\prod }_{i = {2}^{L - 2}}^{2 \cdot {2}^{L - 2} - 1} {α}_{i}^{′} \\ {o}_{L - 2 , 1} = ( … ( ( B {α}_{1}^{′} + {\hat{F}}_{1} ) {α}_{2}^{′} + {\hat{F}}_{2} ) {α}_{3}^{′} + … ) {α}_{1 \cdot {2}^{L - 2} - 1}^{′} + {\hat{F}}_{1 \cdot {2}^{L - 2} - 1} \\ {o}_{L - 2 , 2} = ( ( {\hat{F}}_{{2}^{L - 2}} {α}_{{2}^{L - 2} + 1}^{′} + {\hat{F}}_{{2}^{L - 2} + 1} ) {α}_{{2}^{L - 2} + 2}^{′} … ) {α}_{2 \cdot {2}^{L - 2} - 1}^{′} + {\hat{F}}_{2 \cdot {2}^{L - 2} - 1} \qquad Eq . 2 \text{-} 6$$

Similarly, O_{L-1,2} splits into O_{L-2,3} and O_{L-2,4} such that:

$$\begin{matrix}{o}_{L - 1 , 2} = ( … ( ( ( … ( {\hat{F}}_{2 \cdot {2}^{L - 2}} {α}_{2 \cdot {2}^{L - 2} + 1}^{′} + {\hat{F}}_{2 \cdot {2}^{L - 2} + 1} ) … ) {α}_{3 \cdot {2}^{L - 2} - 1}^{′} + \\ {\hat{F}}_{3 \cdot {2}^{L - 2} - 1}^{′} ) {α}_{3 \cdot {2}^{L - 2}}^{′} + {\hat{F}}_{3 \cdot {2}^{L - 2}} ) {α}_{3 \cdot {2}^{L - 2} + 1}^{′} … ) {α}_{{2}^{L - 1}}^{′} + {\hat{F}}_{{2}^{L} - 1} \\ = {o}_{L - 2 \cdot 3} {α}_{L - 2 , 4}^{′} + {o}_{L - 2 , 4}\end{matrix} \\ where \\ {α}_{L - 2 , 4}^{′} = {α}_{3 \cdot {2}^{L - 2}}^{′} {α}_{3 \cdot {2}^{L - 2} + 1}^{′} … {α}_{4 \cdot {2}^{L - 2} - 2}^{′} {α}_{4 \cdot {2}^{L - 2} - 1}^{′} = {\prod }_{i = 3 \cdot {2}^{L - 2}}^{4 \cdot {2}^{L - 2} - 1} {α}_{i}^{′} \\ {o}_{L - 2 , 3} = ( … ( {\hat{F}}_{2 \cdot {2}^{L - 2}} {α}_{2 \cdot {2}^{L - 2} + 1}^{′} + {\hat{F}}_{2 \cdot {2}^{L - 2} + 1} ) … ) {α}_{3 \cdot {2}^{L - 2} - 1}^{′} + {\hat{F}}_{3 \cdot {2}^{L - 2} - 1} \\ {o}_{L - 2 , 4} = ( … ( {\hat{F}}_{3 \cdot {2}^{L - 2}} {α}_{3 \cdot {2}^{L - 2} + 1}^{′} + {\hat{F}}_{3 \cdot {2}^{L - 2} + 1} ) {α}_{3 \cdot {2}^{L - 2} + 2}^{′} … ) {α}_{4 \cdot {2}^{L - 2} - 1}^{′} + {\hat{F}}_{4 \cdot {2}^{L - 2} - 1} \qquad Eq . 2 \text{-} 7$$

If such split actions are repeated until reaching to all sources from B to Fₙ, then a parallel binary tree is completed. This binary tree has 2^{L-l} nodes at level l. Data at each node is formed using data from two lower-level children nodes. For instance, video data output from a node at level (l+1) is expressed such that

O_{l+1,i}=O_{l+1,i-1}×α_{l,2i}′+O_{l,2i}, Eq. 2-8

where i=1, 2, . . . , 2^{L-l-1}, l=0, 1, . . . , L

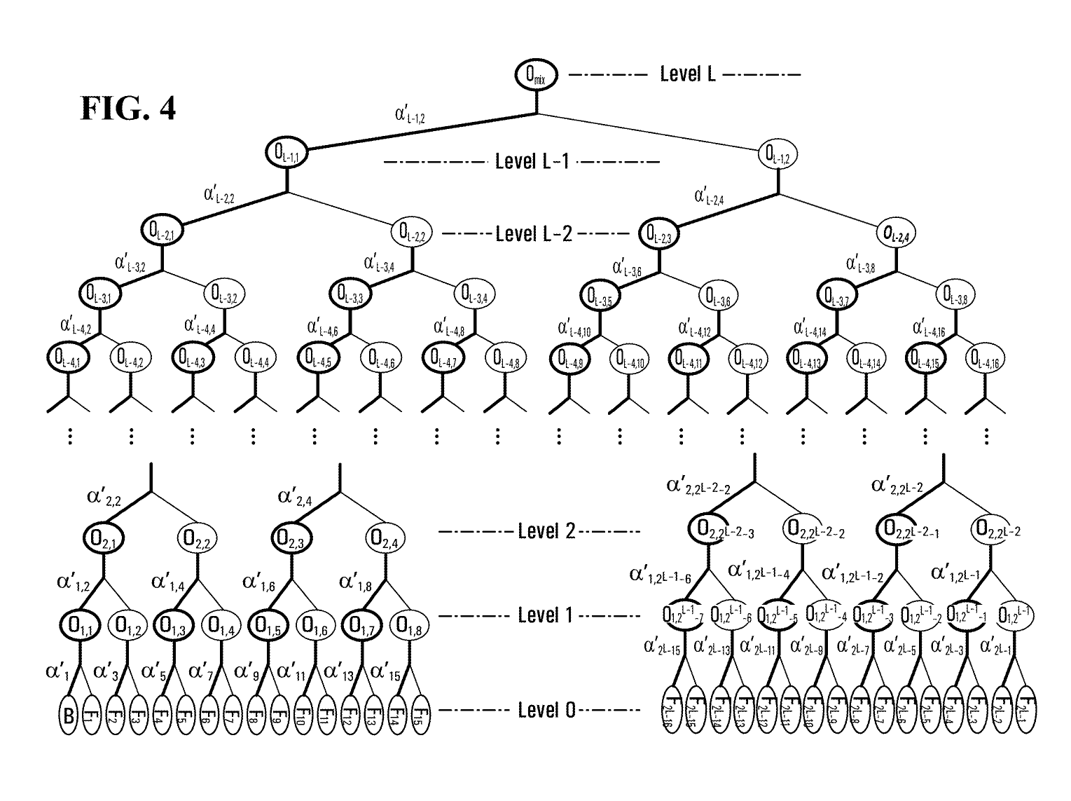

For convenience, O_{l,2i-1} is referred to as video output from an odd child node and O_{l,2i} is referred to as video output from an even child node in terms of video data O_{l+1,i} from a node i at level (l+1). FIG. 4 illustrates an example parallel structure for a binary mix tree, and shows how a binary tree spans from top level to bottom level for parallel calculation.

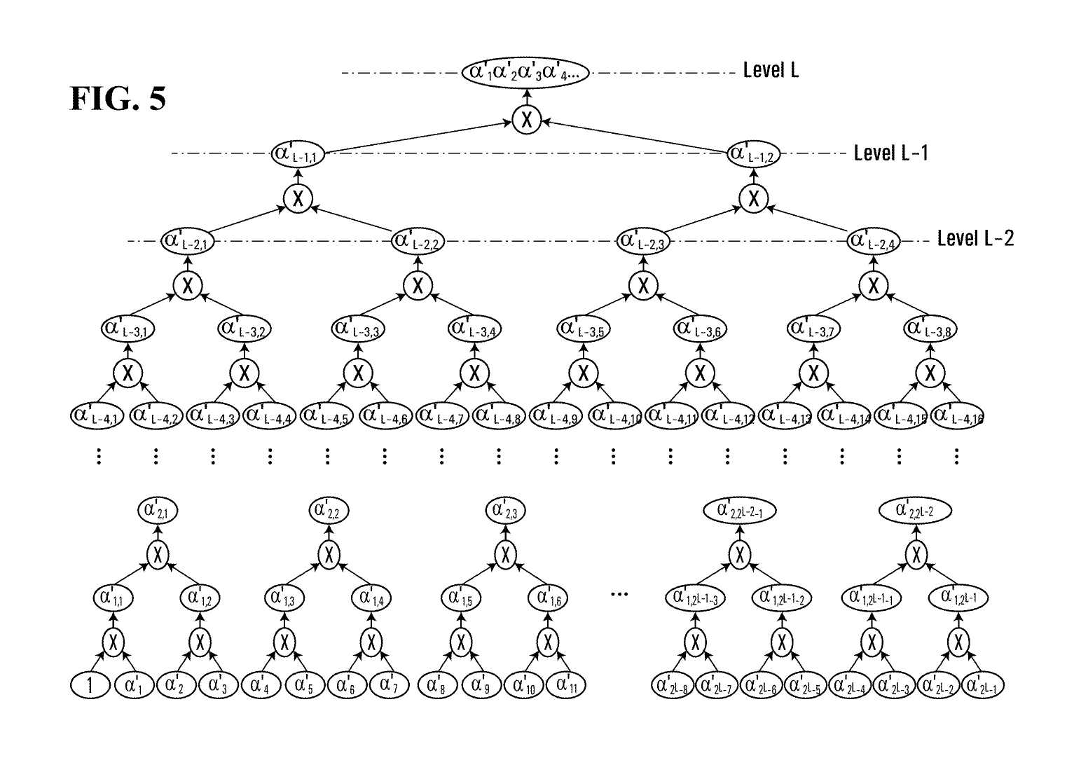

FIG. 4 also illustrates how mixing could be implemented in parallel at each level of the mix tree. For a binary tree implementation a video data mixing module to perform A/B mixing could be provided for each node in the binary tree, to mix two video data input signals that include respective video data output signals from two child nodes in the binary tree. With reference to FIG. 4, for instance, the output signals shown at each node could be calculated by respective video data mixing modules using the complementary alphas and composite complementary alphas shown in FIG. 5.

### Composite Alphas

Eq. 2-8 includes a composite of complementary alphas at level l which can be expressed in alphas at lower level (l−1) such that:

$$\begin{matrix}{α}_{l , 2 i}^{′} = {\prod }_{( 2 i - 1 ) {2}^{l}}^{2 i \cdot {2}^{l} - 1} {α}_{k}^{′} \\ = {\prod }_{( 4 i - 2 ) {2}^{l - 1}}^{4 i \cdot {2}^{l - 1} - 1} {α}_{k}^{′} \\ = ( {\prod }_{( 4 i - 2 ) {2}^{l - 1}}^{( 4 i - 1 ) \cdot {2}^{l - 1} - 1} {α}_{k}^{′} ) \times ( {\prod }_{( 4 i - 2 ) {2}^{l - 1}}^{4 i \cdot {2}^{l - 1} - 1} {α}_{k}^{′} )\end{matrix} \qquad Eq . 2 \text{-} 9$$

where i=1, 2, . . . , 2^{L-l-1}, l=0, 1, . . . , L

Eq. 2-9 illustrates that:
1) a composite alpha for A/B mix effect involves alphas from even child nodes;
2) the even node alpha for A/B mix is formed from two lower-level composite alphas, including one from an odd child node (4i−1) and the other from an even child node 4i.

FIG. 5 illustrates an example parallel span for complementary alphas in a binary mix tree. FIG. 5 indicates:
1) if viewing the schematic graph from bottom to top, a pair of alphas from an odd node and an even node forms an upper-level alpha, although alphas from odd nodes are not applied to the A/B mix formula in 2-8, generally;
2) if viewing the schematic graph from top to bottom, at level L the right-hand side complementary alpha is used for the final node output (see Eq. 2-3) while the left-hand side complementary alpha only involves calculations starting at level L-2.

General complementary alpha and composite complementary alpha expressions are populated in Table 1 below.

TABLE 1
complementary alpha and composite complementary alpha expressions

| Level | Carry-on Complementary Alpha (Composite Complementary Alpha for Levels above 0) | | | | | | | |
|---|---|---|---|---|---|---|---|---|
| L-1 | ${α}_{L - 1 , 2}^{′} = {\prod }_{i = 1 \cdot {2}^{L - 1}}^{2 \cdot {2}^{L - 1} - 1} {α}_{i}^{′} = {\prod }_{i = 2 \cdot {2}^{L - 2}}^{3 \cdot {2}^{L - 2} - 1} {α}_{i}^{′} \times {\prod }_{i = 3 \cdot {2}^{L - 2}}^{4 \cdot {2}^{L - 2} - 1} {α}_{i}^{′} = {α}_{L - 2 , 3}^{′} \times {α}_{L - 2 , 4}^{′}$ | | | | | | | |
| L-2 | ${α}_{L - 2 , 2}^{′} = {\prod }_{i = 1 \cdot {2}^{L - 2}}^{2 \cdot {2}^{L - 2} - 1} {α}_{i}^{′} = {\prod }_{i = 2 \cdot {2}^{L - 3}}^{4 \cdot {2}^{L - 3} - 1} {α}_{i}^{′} = {α}_{L - 3 , 3}^{′} \times {α}_{L - 3 , 4}^{′}$ | | | | ${α}_{L - 2 , 4}^{′} = {\prod }_{i = 3 \cdot {2}^{L - 2}}^{4 \cdot {2}^{L - 2} - 1} {α}_{i}^{′} = {\prod }_{i = 6 \cdot {2}^{L - 3}}^{8 \cdot {2}^{L - 3} - 1} {α}_{i}^{′} = {α}_{L - 3 , 7}^{′} \times {α}_{L - 3 , 8}^{′}$ | | | |
| L-3 | ${α}_{L - 3 , 2}^{′} = {\prod }_{i = 1 \cdot {2}^{L - 3}}^{2 \cdot {2}^{L - 3} - 1} {α}_{i}^{′}$ | | ${α}_{L - 3 , 4}^{′} = {\prod }_{i = 3 \cdot {2}^{L - 3}}^{4 \cdot {2}^{L - 3} - 1} {α}_{i}^{′}$ | | ${α}_{L - 3 , 6}^{′} = {\prod }_{i = 5 \cdot {2}^{L - 3}}^{6 \cdot {2}^{L - 3} - 1} {α}_{i}^{′}$ | | ${α}_{L - 3 , 8}^{′} = {\prod }_{i = 7 \cdot {2}^{L - 3}}^{8 \cdot {2}^{L - 3} - 1} {α}_{i}^{′}$ | |
| L-4 | ${\prod }_{i = 1 \cdot {2}^{L - 4}}^{2 \cdot {2}^{L - 4} - 1} {α}_{i}^{′}$ | ${\prod }_{i = 3 \cdot {2}^{L - 4}}^{4 \cdot {2}^{L - 4} - 1} {α}_{i}^{′}$ | ${\prod }_{i = 5 \cdot {2}^{L - 4}}^{6 \cdot {2}^{L - 4} - 1} {α}_{i}^{′}$ | ${\prod }_{i = 7 \cdot {2}^{L - 4}}^{8 \cdot {2}^{L - 4} - 1} {α}_{i}^{′}$ | ${\prod }_{i = 9 \cdot {2}^{L - 4}}^{10 \cdot {2}^{L - 4} - 1} {α}_{i}^{′}$ | ${\prod }_{i = 11 \cdot {2}^{L - 4}}^{12 \cdot {2}^{L - 4} - 1} {α}_{i}^{′}$ | ${\prod }_{i = 13 \cdot {2}^{L - 4}}^{14 \cdot {2}^{L - 4} - 1} {α}_{i}^{′}$ | ${\prod }_{i = 15 \cdot {2}^{L - 4}}^{16 \cdot {2}^{L - 4} - 1} {α}_{i}^{′}$ |

| . . . | . . . | | | | | | | | |
|---|---|---|---|---|---|---|---|---|---|
| 1 | α^{′}_{1,2} = | | α^{′}_{1,4} = | | | α^{′}_{1,2}_{^{L−1}}₋₂ = | | α^{′}_{1,2}_{^{L−1}} = | |
| | α^{′}₂ · α^{′}₃ | | α^{′}₆ · α^{′}₇ | | | α^{′}₂_{^{L}}₋₆α^{′}₂_{^{L}}₋₅ | | α^{′}₂_{^{L}}₋₂α^{′}₂_{^{L}}₋₁ | |
| 0 | α^{′}₁ | α^{′}₃ | α^{′}₅ | α^{′}₇ | . . . | α^{′}₂_{^{L}}₋₇ | α^{′}₂_{^{L}}₋₅ | α^{′}₂_{^{L}}₋₃ | α^{′}₂_{^{L}}₋₁ |

In order to easily understand the composite alphas, Table 2 lists all alpha indices for complementary alphas and composite complementary alphas from an instance of 5 levels or 32 video layers.

TABLE 2
alpha indices for 5-level parallel tree

| Level | Carry-on Complementary Alpha (Composite Complementary Alpha for Levels above 0) | | | | | | | | | | | | | | | |
|---|---|---|---|---|---|---|---|---|---|---|---|---|---|---|---|---|
| 4 | α′₁₆α′₁₇α′₁₈α′₁₉α′₂₀α′₂₁α′₂₂α′₂₃α′₂₄α′₂₅α′₂₆α′₂₇α′₂₈α′₂₉α′₃₀α′₃₁ | | | | | | | | | | | | | | | |
| 3 | α′₈α′₉α′₁₀α′₁₁α′₁₂α′₁₃α′₁₄α′₁₅ | | | | | | | | α′₂₄α′₂₅α′₂₆α′₂₇α′₂₈α′₂₉α′₃₀α′₃₁ | | | | | | | |
| 2 | α′₄α′₅α′₆α′₇ | | | | α′₁₂α′₁₃α′₁₄α′₁₅ | | | | α′₂₀α′₂₁α′₂₂α′₂₃ | | | | α′₂₈α′₂₉α′₃₀α′₃₁ | | | |
| 1 | α′₂α′₃ | | α′₆α′₇ | | α′₁₀α′₁₁ | | α′₁₄α′₁₅ | | α′₁₈α′₁₉ | | α′₂₂α′₂₃ | | α′₂₆α′₂₇ | | α′₃₀α′₃₁ | |
| 0 | α′₁ | α′₃ | α′₅ | α′₇ | α′₉ | α′₁₁ | α′₁₃ | α′₁₅ | α′₁₇ | α′₁₉ | α′₂₁ | α′₂₃ | α′₂₅ | α′₂₇ | α′₂₉ | α′₃₁ |

### Seamless Switching and Precision

Seamless switching between layers is generally desirable in the video production switcher industry, and means that if B=F₁= . . . =Fₙ=A, then

$$\begin{matrix}{O}_{mix} = ( … ( ( A {α}_{1}^{′} + A {α}_{1} ) {α}_{2}^{′} + A {α}_{2} ) {α}_{3}^{′} + ⋯ ) \\ {α}_{n}^{′} + A {α}_{n} \\ = A ( ( … ( ( {α}_{1}^{′} + {α}_{1} ) {α}_{2}^{′} + {α}_{2} ) {α}_{3}^{′} + ⋯ ) {α}_{n}^{′} + {α}_{n} ) \\ = A\end{matrix} , \qquad Eq . 2 \text{-} 10$$

Eq. 2-10 can be interpreted in such a way that if all layers are identical, then the mix output shall be also identical to each layer regardless of any layer alpha. As discussed above, the upper A/B mix node data are formed from lower node data in a parallel binary tree, and composite complementary alphas are also formed from lower node complementary alphas. The complementary alphas carry on through the binary tree from bottom to top. These carry-on complementary alphas could raise a question of precision in a parallel mix tree due to limited alpha precisions. Although the traditional cascade A/B mix tree employs limited precision of alpha, using a 10-bit unit to represent a fractional part to 10-bit decimal precision for instance, the alpha is not carried on to the following A/B mix layers and therefore no error spreads due to limited precision. In contrast, truncation errors due to limited precision could propagate in a parallel A/B mix tree. Precisions and a target for maintaining a certain fractional precision in truncation at each layer in order to sustain seamless switching, between layers in parallel structures for example, are disclosed herein.

A key-combiner in a Digital Video Effects (DVE) device and a layer-mode MLE are examples of components and related processes in which parallel structures could be used. A 4-layer DVE or layer-mode MLE with 4 keys, for example, could use 4-bit fractional precision in truncation during each layer mix, and in this example transfer of those 4 extra bits would use additional bandwidth on links between DVE devices and DVE users or between layer-mode MLEs.

Serial Digital Interface (SDI) is often used as the link between video devices in broadcast equipment. Several techniques for transfer of extra fractional precision bits through an SDI link, without breaking rules imposed on SDI data structures, are disclosed herein. The following sections cover error analysis for fractional precision in truncation in order to determine a number of bits used in parallel structures, and then propose techniques which embed the extra fractional precision bits into SDI links.

### Error Analysis

### Mixed Video

Consider an example in which each A/B mix has a truncation error εᵢ at layer i and the final result Oₘᵢₓ has a total error Eᵥ in N layers of a mix tree. Due to truncation rather than rounding, the total error Eᵥ is subtracted from Oₘᵢₓ to produce the real result, such that

$$\begin{matrix}\begin{matrix}{O}_{mix} - {E}_{v} = ( ( ( ( B {α}_{1}^{′} + {F}_{1} {α}_{1} - {ɛ}_{1} ) {α}_{2}^{′} + {F}_{2} {α}_{2} - {ɛ}_{2} ) {α}_{3}^{′} … \\ - {ɛ}_{N - 2} ) {α}_{N - 1}^{′} + {F}_{N - 1} {α}_{N - 1} - {ɛ}_{N - 1} ) {α}_{N}^{′} + {F}_{N} {α}_{N} - {ɛ}_{N} \\ = ( ( ( ( B {α}_{1}^{′} + {F}_{1} {α}_{1} ) {α}_{2}^{′} + {F}_{2} {α}_{2} ) … ) \\ {α}_{N - 1}^{′} + {F}_{N - 1} {α}_{N - 1} ) {α}_{N}^{′} + \\ {F}_{N} {α}_{N} - ( {ɛ}_{1} {α}_{2}^{′} … {α}_{N}^{′} ) - ( {ɛ}_{2} {α}_{3}^{′} … {α}_{N}^{′} ) - ⋯ - {ɛ}_{N} \\ = {O}_{mix} - ( ( {ɛ}_{1} {α}_{2}^{′} … {α}_{N}^{′} ) + ( {ɛ}_{2} {α}_{3}^{′} … {α}_{N}^{′} ) + ⋯ + {ɛ}_{N} )\end{matrix} & Eq . 2 \text{-} 11\end{matrix}$$

In order to find the maximum error, consider an example in which all layers have the same maximum truncation error ε and all layers have the same complementary alpha value α′. Eq. 2-11 then produces the total error

$$\begin{matrix}{E}_{v} = ( {ɛ}_{1} {α}_{2}^{′} … {α}_{N}^{′} ) + ( {ɛ}_{2} {α}_{3}^{′} … {α}_{N}^{′} ) + ⋯ + \\ ( {ɛ}_{N - 2} {α}_{N - 1}^{′} {α}_{N}^{′} ) + {ɛ}_{N - 1} {α}_{N}^{′} + {ɛ}_{N} \\ = ɛ ( {α}^{′ N - 1} + {α}^{′ N - 2} + ⋯ + {α}^{′} + 1 ) \\ = ɛ \frac{1 - {α}^{′ N}}{1 - {α}^{′}}\end{matrix} \qquad Eq . 2 \text{-} 12$$

### Carry-on Alpha

Now suppose that a carry-on alpha is in the worst case where all complementary alphas are carried on through a mix tree to the top layer such that

$${α}_{mix}^{′} = {\prod }_{i = 1}^{N} {α}_{i}^{′} , where N is the number of layers \qquad Eq . 2 \text{-} 13$$

When implementing Eq. 2-13, truncation error εᵢ is introduced to layer i. Due to the truncation, the total error E_{α} is subtracted from αₘᵢₓ′ to produce the final result such that

$$\begin{matrix}{α}_{mix}^{′} - {E}_{α} = ( ( ( {α}_{1}^{′} {α}_{2}^{′} - {ɛ}_{2} ) {α}_{3}^{′} - {ɛ}_{3} ) {α}_{4}^{′} … {α}_{N - 1}^{′} - {ɛ}_{N - 1} ) \\ {α}_{N}^{′} - {ɛ}_{N} \\ = {\prod }_{i = 1}^{N} {α}_{i}^{′} - ( {ɛ}_{2} {α}_{3}^{′} {α}_{4}^{′} … {α}_{N}^{′} ) - \\ ( {ɛ}_{3} {α}_{4}^{′} … {α}_{N}^{′} ) - ⋯ - ( {ɛ}_{N - 1} {α}_{N}^{′} ) - {ɛ}_{N}\end{matrix} \qquad Eq . 2 \text{-} 14$$

In order to find the maximum error, further consider an example in which each layer has the same maximum truncation error ε and each layer uses the same complementary alpha value α′. The total error in Eq. 2-14 is expressed such that

$$\begin{matrix}{E}_{α} = {ɛ}_{2} {α}^{′ N - 2} + {ɛ}_{3} {α}^{′ N - 3} + ⋯ + {ɛ}_{N - 1} {α}^{′} + {ɛ}_{N} & if {α}_{1}^{′} = {α}_{2}^{′} = ⋯ = {α}_{N - 1}^{′} = {α}_{N}^{′} = {α}^{′} \\ = ɛ \frac{1 - {α}^{′ N - 1}}{1 - {α}^{′}} & if {ɛ}_{1} = {ɛ}_{2} = ⋯ = {ɛ}_{N - 1} = {ɛ}_{N} = ɛ\end{matrix} \qquad Eq . 2 \text{-} 15$$

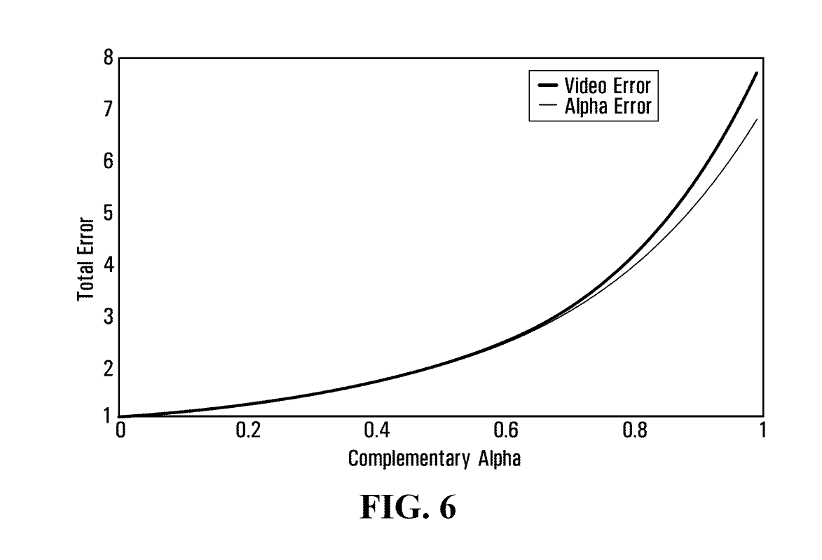

Eq. 2-15 is similar to Eq. 2-12, and both are shown in FIG. 6, which is an example plot of errors for video data and alpha signals in terms of complementary alpha values under N=8 video layers. This similarity between Eq. 2-12 and Eq. 2-15 might direct focus to the video error because video error is larger than alpha error.

### Maximum Error

Eq. 2-12 and Eq. 2-15 disclose that the total accumulated error monotonically increases with complementary alpha values and hence the maximum error occurs at maximum complementary alpha value (unit of alpha) such that

Eₘₐₓ=Nε, if α′=1 Eq. 2-16

α′=1 means that each upper layer is transparent to lower layers and so the lower layers' errors are visible. In contrast, α′=0 means that each upper layer blocks lower layers and also prevents error propagation from the lower layers. If the total error is limited to a certain value such as 2^{-M} in terms of a unit, then Eₘₐₓ≦2^{-M} and the maximum truncation error ε in each layer follows

$$ɛ \leq \frac{{2}^{- M}}{{2}^{L}} = \frac{1}{{2}^{L + M}} \leq \frac{1}{N} , where {2}^{L - 1} < N \leq {2}^{L} \qquad Eq . 2 \text{-} 17$$

Eq. 2-17 can be interpreted as a general target or guide for each layer truncation to sustain a certain calculation accuracy. This target defines each layer truncation with the number of fraction bits equal to (L+M). According to Eq. 2-17, M=0 means a 1-bit error and M=2 means a quarter-bit error. A quarter-bit error might be chosen for certain applications, for example, in which after rounding to integer is applied to the end video mixing result, an error-free Oₘᵢₓ is produced for the case where all layers are from identical video sources, such that

└Oₘᵢₓ−Eₘₐₓ+0.5┘=└Oₘᵢₓ−0.25+0.5┘=└Oₘᵢₓ+0.25┘=Oₘᵢₓ, Eq. 2-18
where └ ┘ is truncation to integer

A quarter-bit error might be preferred, for example, to give more guard margin to a system than a half-bit error. Under a quarter-bit error condition (or M=2), the L+M target for four layers (or N=2²) specifies (2+2)=4 bits fractional precision in each mix truncation, and for 256 layers (or N=2⁸) the L+M target specifies (2+8)=10 bits fractional precision in each mix truncation.

In order to verify the above analysis on the total error from Eq. 2-12 and Eq. 2-15, C programs were used to sweep parameters and find the maximum error. C-Code 2-1 below lists C code where 3 parameters, including video data, direct alpha value, and number of additional fraction bits, are swept in ranges, one after the other.

C-Code 2-1: sweep of values in terms of alpha, video, and fractions

| | | |
|---|---|---|
| const int | L = 10; | // number of levels |
| const int | N = 1<<L; | // number of layers |
| static int | aBuf[2*N]; | // alpha buffer holds alpha source & result in each level |
| static int | vBuf[2*N]; | // video buffer nolds video source & result in each level |

| | | |
|---|---|---|
| static int | aFRC; | // the number of fraction bits in each truncation |
| static int | aBit; | // the total number of bits for video and alpha |

| void sweep_all( void ){ | | |
|---|---|---|
| int | max_frc=L+2; | // L+M where M=2 |

| | |
|---|---|
| if(max_frc>11) | // L+M has no need for more bits than 11 |

| max_frc = 11; | |
|---|---|
| // sweep 10-bit video data | |
| for(int video=1; video<1024; video++){ | |
| - - - | |
| // sweep 10-bit alphas | |
| for(int alpha=0; alpha<1024; alpha++){ | |
| - - - | |
| // sweep fractions | |
| for(int frc_cnt=1; frc_cnt<=max_frc; frc_cnt++){ | |
| aFRC = frc_cnt; | |
| aBit = 10 + aFRC; | |
| data = run_full_paralle1( ); | |
| data >>= aFRC-1; | // rounding is performed because |
| data += 1; | // each layer does truncation only, and |
| data >>= 1; | // thus always produces negative errors. |
| error = video-data; | // total error between source and mix output |

```
      }
    }
  }
}
```

Note that:
1) In this example, 10-bit fractional precision source alphas are considered. Maximum additional fraction bits, specifying additional fractional precision for alpha values, sustained in each truncation are not beyond 11 bits in some embodiments. It has been found that additional fractional precision of more than 11 bits sustained by each truncation in this example might not be helpful for error reduction. Fractional precision of source alpha and additional fractional precision sustained by each truncation, as referenced in this example, are different.
   For example, when a source alpha of 10-bit fractional precision is multiplied by 10-bit integer video data, the product is 20-bit fixed point data, including a 10-bit fractional part and a 10-bit integer part. Truncation after multiplication may cut 20-bit data to 15 bits, for instance, by sustaining 5-bit fractional precision. Note that, in the present disclosure, the product with 5-bit fractional precision from one mixing module may be a video data input to another mixing module. When this new video data input is multiplied with a source alpha of 10-bit fractional precision, the further new product is 25-bit fixed point data, including a 10-bit integer part and a 15-bit fractional part. If the product is to be truncated to 15 bits including a 10-bit integer part and a 5-bit fractional part, then 10 bits are to be cut.
   In C-Code 2-1 and 2-2, consider an example of 10-bit video data, 10-bit fractional precision alpha data, and each truncation sustaining 5-bit fractional precision. Appending 5-bit Os to both the video and alpha data provides video data with a 10-bit integer part and a 5-bit fractional part, and alpha data with 15-bit fractional precision. The alpha data could also have an integer part, illustratively with 10 bits, but only the least significant bit would be non-zero for alpha values between 0 and 1. Next, each mix is to multiply 15-bit video data with the alpha data, and could cut the 30-bit product (10-bit integer and 20-bit fraction) to 15 bits by dropping the last 15 bits of the fractional part. The product is keeping 15 bits (10-bit integer, 5-bit fraction). This is done recursively in multiplications for further mixing. In this example, the 5-bit fraction illustrates what is meant by sustaining 5-bit fractional precision, and this can extend to other fractional precisions as well.
2) Two buffers {aBuf, vBuf}, which are double-sized relative to the number of layers, contain source video and source alpha in the first half of arrays, respectively. The other half takes intermediate calculation results.
3) The final result is rounded by adding 0.5 and truncating to integer.
4) In this example, a full parallel structure for a mix tree is to run in a function run_full_( ), which is listed in C-Code 2-2 below.

C-Code 2-2: example parallel implementation of mix tree

| int run_full_parallel( void ){ | |
|---|---|
| int src_addr = 0; | // source address in each level |
| int tgt_addr = N; | // target address in each level |
| int pair_num = N; | // numer of A/B mix in each level |
| for(int level_cnt=0; level_cnt<L; level_cnt++){ | |
| pair_num >>=1; | // pair number reduces to half |

| for(int pair_cnt=0; pair_cnt<pair_num; pair_cnt++){ | |
|---|---|
| aBuf[tgt_addr] = (aBuf[src_addr+0] * aBuf[src_addr+1]) >>aBit; | // truncation |
| vBuf[tgt_addr] = (vBuf[src_addr+0] * aBuf[src_addr+1]) >>aBit; | // truncation |

```
      vBuf[tgt_addr] += vBuf[src_addr+ 1];
      tgt_addr++;
      src_addr += 2;
    }
  }
  return vBuf[src_addr];
}
```

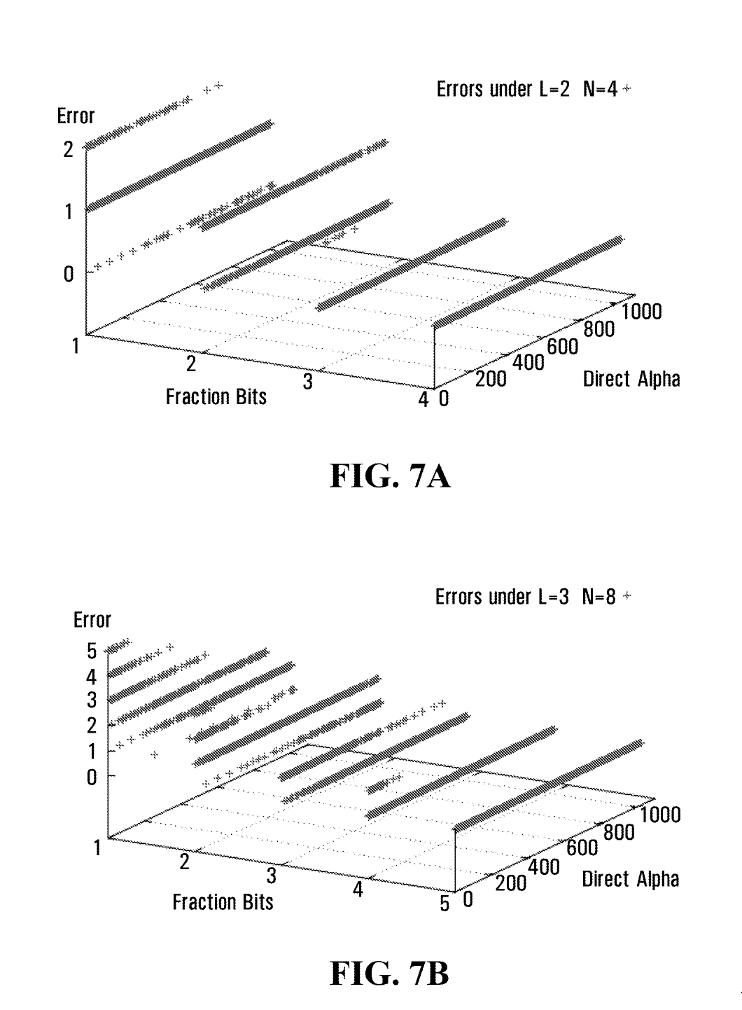

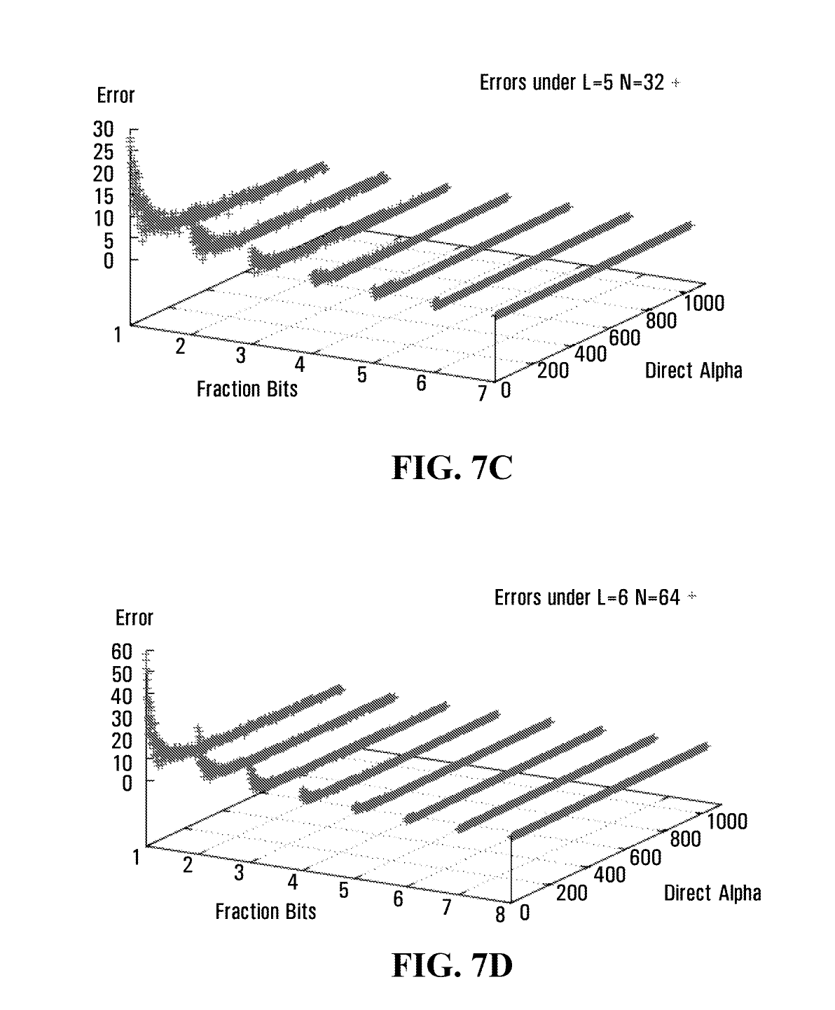

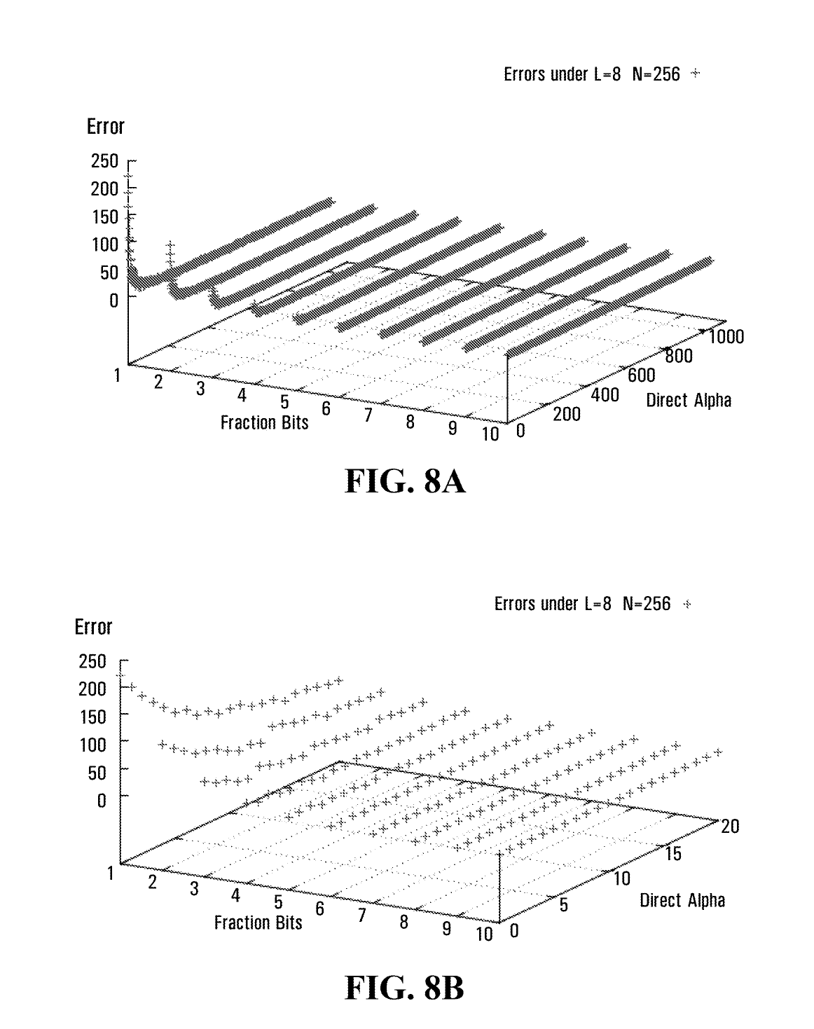

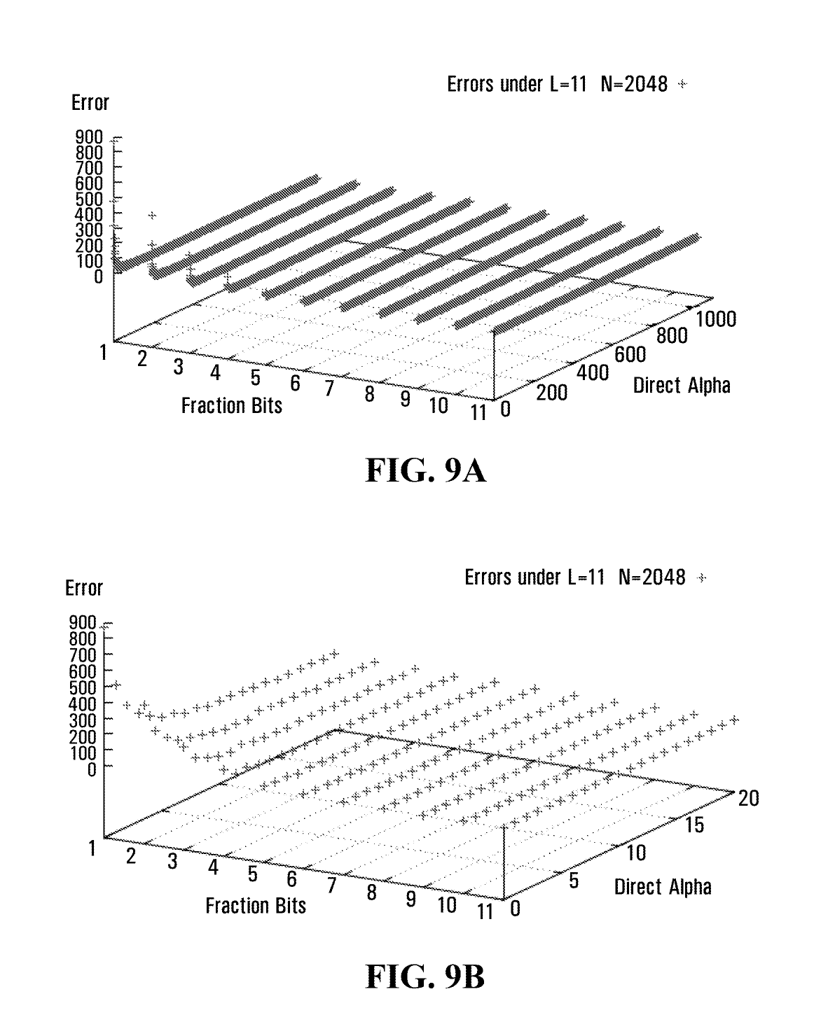

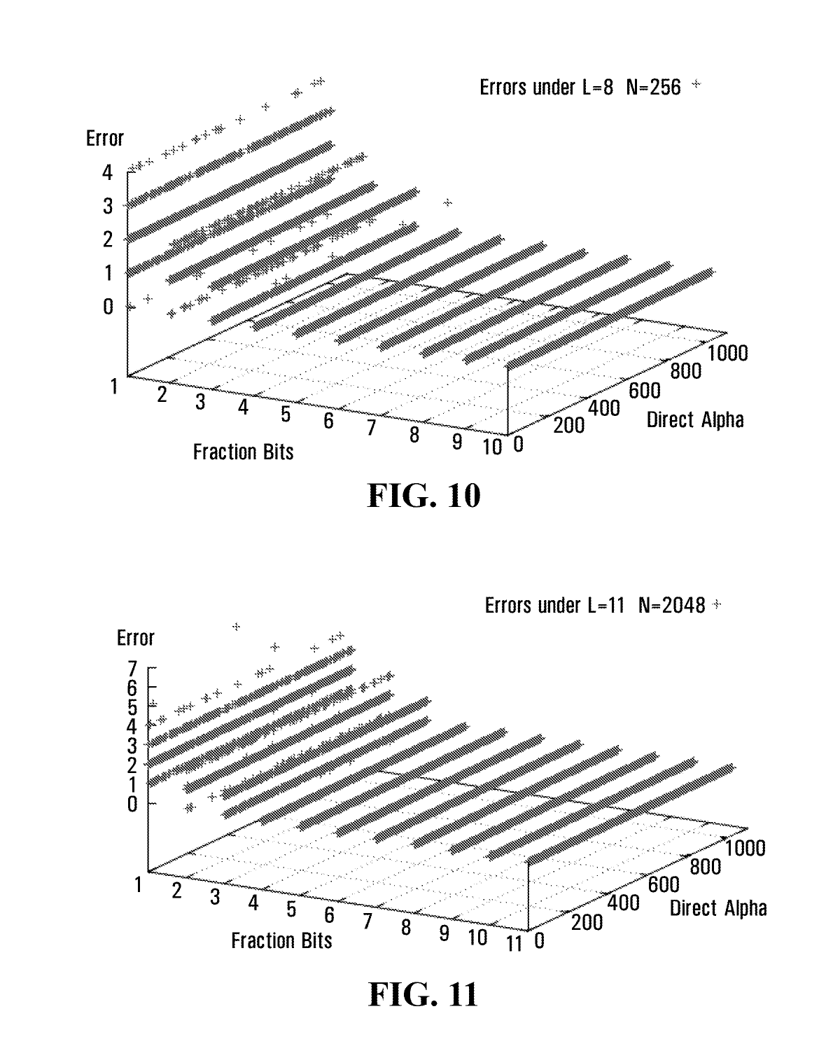

Example sweep results are plotted in FIGS. 7A to 11, in which FIGS. 7A to 7D are example plots of total errors in terms of various video calculation fractional precisions and various source alpha values for 4, 8, 32, and 64 layers (L=2, 3, 5, and 6), respectively; FIG. 8A is an example plot of total errors in terms of various video calculation fractional precisions and various source alpha values for 256 layers with L=8 and FIG. 8B is a magnified view of a portion of FIG. 8A; FIG. 9A is an example plot of total errors in terms of various video calculation fractional precisions and various source alpha values for 2048 layers with L=11 and FIG. 9B is a magnified view of a portion of FIG. 9A; FIG. 10 is an example plot of errors in terms of various video calculation precisions and random source alpha values under 256 layers with L=8 for fractional precision from 1 to 10 bits but a smaller error range than in FIGS. 8A and 8B; and FIG. 11 is an example plot of errors in terms of various video calculation precisions and random source alpha values under 2048 layers with L=11 for fractional precision from 1 to 11 bits but a smaller error range than in FIGS. 9A and 9B.

Note that:
1) All of the example sweeps produce 0 errors when each layer truncation sustains (L+M) bits for fractional precision, or the maximum 11 bits for L=11.
2) FIGS. 7A to 9B use identical alpha values in each layer, swept from 1 to 1024.
3) FIGS. 10 and 11 use random alpha values to replace sweep values.

From these sweep results, it can be observed that seamless error-free switching between layers with identical video values could be realized in parallel structures under a condition that each layer sustains truncation with L+M bits fractional precision. Such a condition is referred to herein as a target of (L+M) bits for fraction in truncation.

Quarter-bit error or error tolerance as discussed above is intended solely for illustrative purposes. Other errors or error tolerances are possible. A maximum error or error tolerance could be chosen for video effects and mix processing, and fractional precision could then be set based on the error or error tolerance. For different error or error tolerances, there could be different fractional precisions. For example, for the same L, a lower error or error tolerance (higher M) involves a higher fractional precision (L+M), and conversely a lower fractional precision can be used under a higher error tolerance (lower M) condition.

In some embodiments, when a maximum error or error tolerance is chosen, the same fixed fractional precision is used for video effects and mix processing. Other embodiments could support different maximum errors or error tolerances and different fractional precisions for different video effects, for example. It is also contemplated that maximum error or error tolerance values, fractional precisions, or both could be changed, as configuration settings for instance. This could enable changes to maximum error or error tolerance, for particular video effects or mix processing or for a video effects or mix processing system as a whole, by changing settings for maximum error or error tolerance and/or for fractional precision. Error or error tolerance settings, fractional precision settings, or both types of settings, could be configured in registers or other types of memory, for example. As discussed herein in terms of an (L+M) target, fractional precision could be calculated from maximum error or error tolerance, and therefore configuration settings could include either or both of error/tolerance settings and fractional precision settings.

### Partial Parallel Structures

Full parallel structures might use higher precisions for A/B mix calculations to avoid accumulated errors. The more layers and the higher the number of levels that a mix tree involves, the higher precisions the mix tree should use and the higher the implementation cost. A tradeoff between performance and implementation cost is a partially parallel structure within a main cascade tree. For instance, a main trunk in a mix tree could still be a cascade structure while multiple branches could be paralleled to reduce electronic delays. The teachings provided herein could be used in conjunction with full or partial parallel structures, such as those disclosed in the above-referenced related application.

### Data Transfer

The following sections present and discuss several example applications of the target of L+M bits where multiple discrete devices implement A/B mix effects in parallel structures. These devices are often connected through SMPTE Serial Digital Interface (SDI) links. An SDI link might only offer 10-bit video data slots, for example, but according to the target of L+M bits for additional fractional precision, additional bits would be sent over SDI links for the extra L+M bits. The extra precision bits could be added for both video data and alpha data, and transferred over SDI links as disclosed herein.

### Example Application—Key Combiner

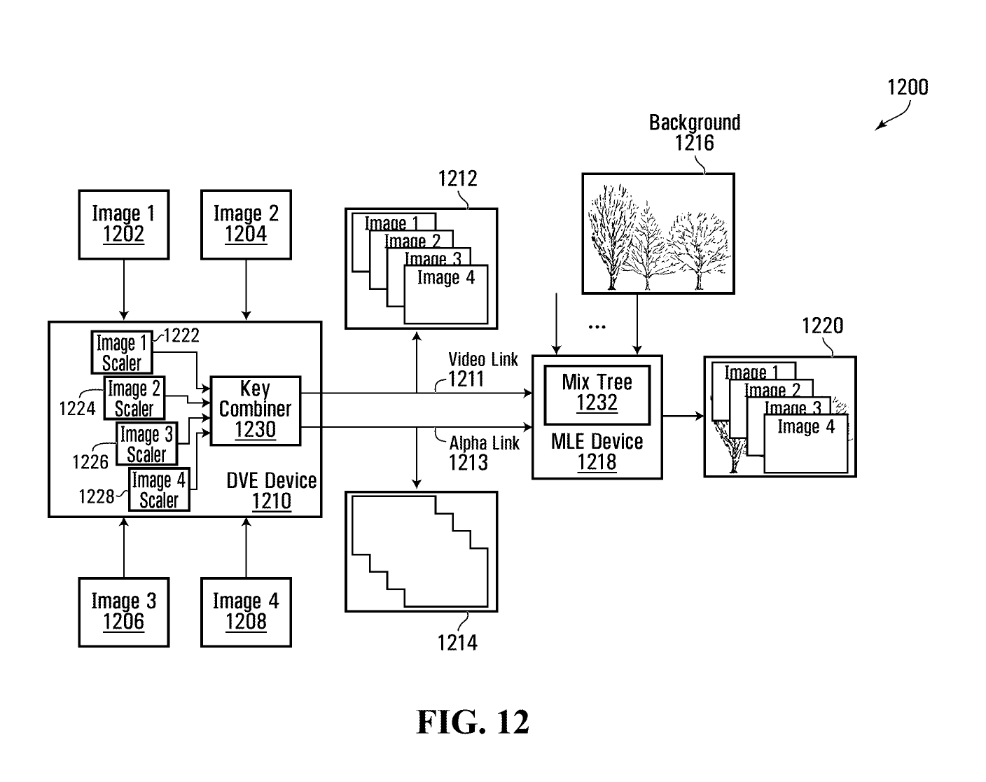

Digital Video Effect (DVE) achieves visual effects through video manipulation in a 3D space. FIG. 12 is a block diagram illustrating an example video processing system 1200. The example system 1200 includes a DVE device 1210, often simply referred to as a DVE, and an MLE device 1218, often referred to as an MLE. The DVE device 1210 communicates with the MLE device 1218 through a video link 1211 and an alpha link 1213 in the example shown. The DVE device 1210 includes image scalers 1222, 1224, 1226, 1228 coupled to a key combiner 1230, and the MLE device 1218 includes a mix tree 1232 in the example shown.

In general, hardware, firmware, components which execute software, or some combination thereof might be used in implementing the DVE device 1210, the MLE device 1218, the image scalers 1222, 1224, 1226, 1228, the key combiner 1230, and the mix tree 1232. Electronic devices that might be suitable for implementing any or all of these components include, among others, microprocessors, microcontrollers, Programmable Logic Devices (PLDs), General Purpose Graphic Processing Units (GPGPUs), Digital Signal Processors (DSPs), Field Programmable Gate Arrays (FPGAs), Application Specific Integrated Circuits (ASICs), and other types of “intelligent” integrated circuits. For instance, implementation options for the key combiner 1230 and/or the mix tree 1232 could include one or more of parallel multi-cores in a GPGPU, parallel multi-kernels in an FPGA, multiple processing cores in a Central Processing Unit (CPU), and/or multiple processing cores in an ASIC.

In operation of the example system 1200, multiple video sources 1202, 1204, 1206, 1208 are fed into the DVE device 1210, where each video source is manipulated independently. This manipulation is shown by way of example in FIG. 12 as scaling by the scalers 1222, 1224, 1226, 1228. The manipulated images are layered together in a certain order to form a single video image. This type of layering function inside DVE devices is called key combining, and in FIG. 12 the key combiner 1230 implements this function. The key combiner 1230 outputs one single video image 1212 with an associated alpha 1214, through respective physical links 1211, 1213 between the DVE device 1210 and the MLE device 1218. The single video image and associated alpha are fed into the mix tree 1232 to blend with other video layers, including the background 1216 in the example shown, to construct more layer effects and generate a final video output 1220.

From a point of view of the mix tree 1232, the key combiner 1230 could be seen as implementing a parallel process. For example, the key combiner 1230 could be combining the scaled images 1202, 1204, 1206, 1208 while at the same the mix tree 1232 could be mixing the background 1216 with other video inputs, and the single video output 1212 could then be mixed with an intermediate mix result in the mix tree 1232. In this manner, the single video output 1212 and the intermediate mix result are generated in parallel, or in other words the processes for generating these signals are parallel processes. Mixing within each of these processes, for example, could also or instead be implemented in full or partial parallel structures.

The associated alpha 1214 from the key combiner 1230 could be a carry-on alpha, if the key combiner 1230 is implemented at least partially in a parallel structure. The L+M bits target for fractional precision in each layer mix truncation is applicable to the key combiner 1230 in this example, and also to the mix tree 1232 if the mix tree is implemented as a full or partial parallel structure.

In FIG. 12, four video images 1202, 1204, 1206, 1208 are fed into the DVE device 1210, where each is scaled down. This is an example and there could be more or fewer inputs in other embodiments. Other manipulations such as shifting are also possible, and could be applied to video inputs individually, instead of or in addition to scaling. The key combiner 1230 in the DVE device 1210 combines the 4 down-scaled images into a single video 1212 which is fed into the mix tree 1232 in the MLE device 1218, as noted above. The video and alpha links 1211, 1213 could be SDI links, one for video data and the other for alpha data as shown. The alpha 1214 defines the boundary around the composite video image 1212 and the transparency inside the composite video image. The MLE device 1218 inputs the composite video 1212 through the video link 1211 and the associated alpha 1214 through the alpha link 1213, and then lays the video on the top of the background 1216, according to the associated alpha 1214. According to the target of L+M bits for fractional precision in each layer mix truncation, both links 1211, 1213 would accommodate 4 extra bits for up to quarter-bit error in this example of a 4-layer DVE output.

### Example Application—Layer-Mode MLE

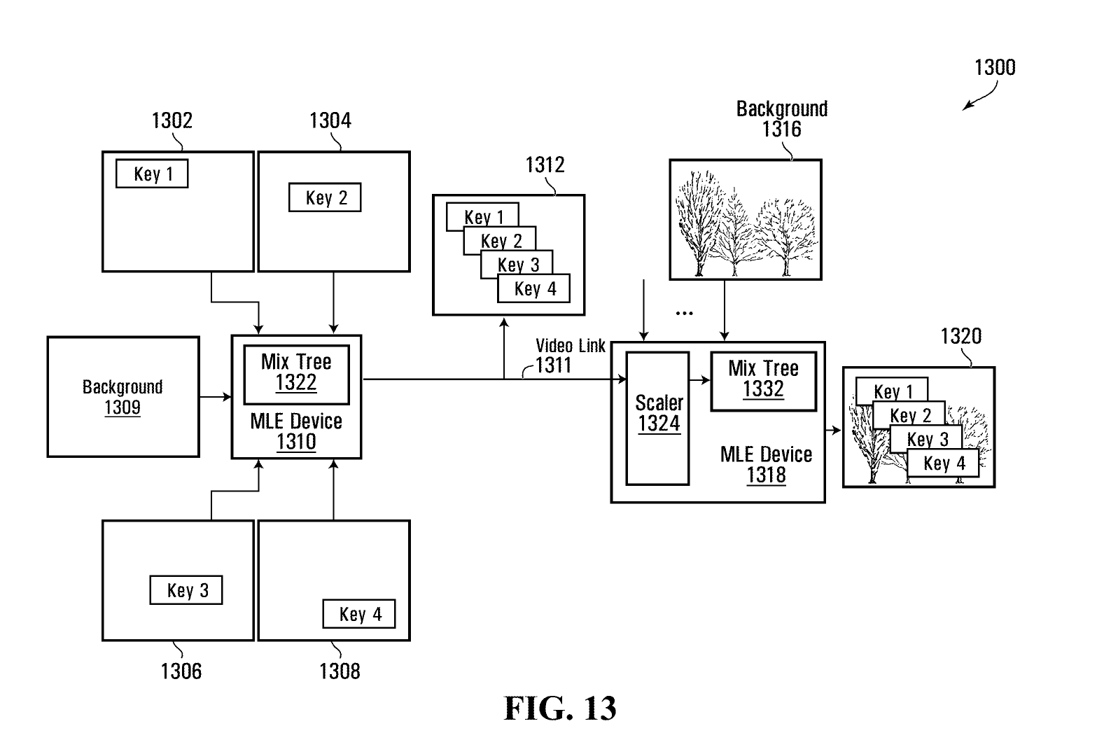

Generally, an MLE output is a single composite video image, constructed from multiple video layers on the top of a background without transparency. FIG. 13 is a block diagram illustrating another example video processing system 1300, in which two MLE devices 1310, 1318 are coupled together through a video link 1311. Each MLE device 1310, 1318 includes a mix tree 1322, 1332, and the MLE device 1318 also includes a scaler 1324. The implementation examples provided above with reference to FIG. 12 also apply to the example video processing system 1300.

The first MLE device 1310 inputs four video images 1302, 1304, 1306, 1308 as keys and a solid color image 1309 as background through video links, and then layers the 4 keys on the top of background. This layering is implemented in the mix tree 1322 in this example. The second MLE device 1318 inputs the first MLE output 1312 as a video layer, the scaler 1324 scales it down, and finally the scaled down first MLE output is laid on the top of the background 1316 to generate a final video output 1320. Again, the layering is implemented in a mix tree 1332 in the example shown. Normally, all video links follow the same standard to accommodate each video component on the video link 1311 with certain digital bits in broadcast equipment, such as 10-bit data over an SDI link as the video link 1311 for instance.

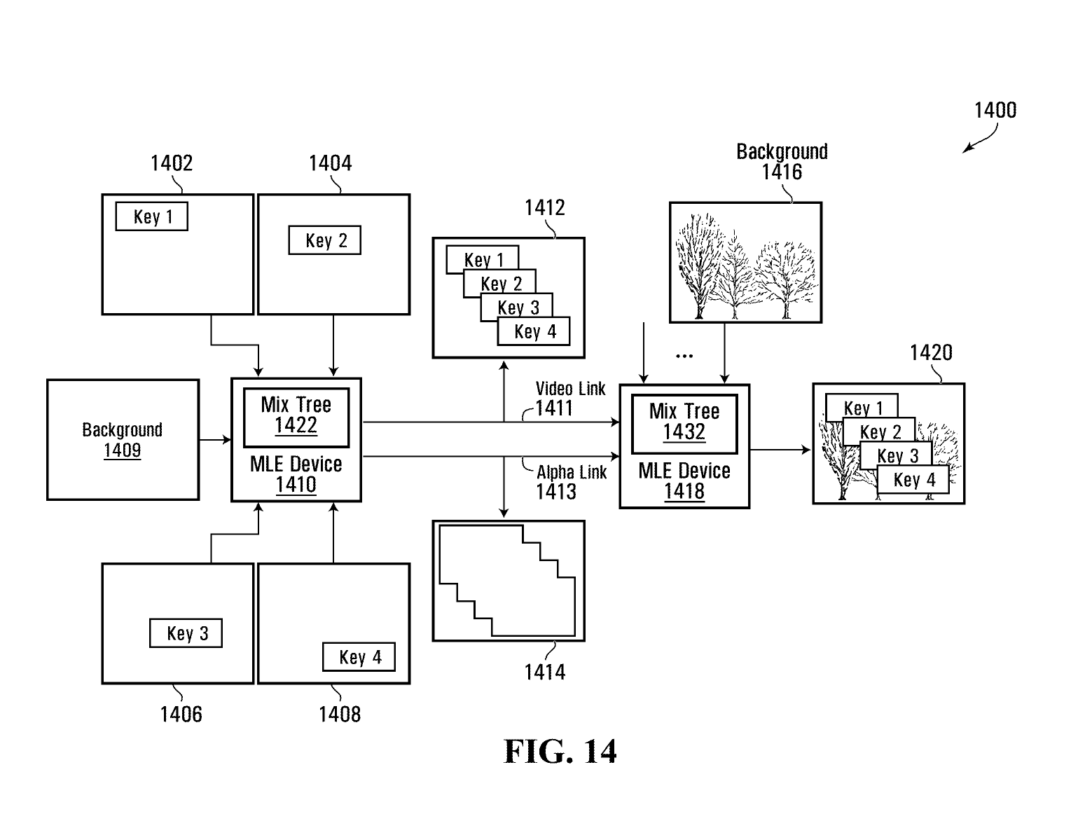

A layer-mode MLE output is a composite video image without a background or with transparency which defines a see-through area in the background. FIG. 14 is a block diagram illustrating a further example video processing system 1400, with a layer-mode MLE device 1410 connected to a general MLE device 1418 through a video link 1411 and an alpha link 1413. Each of the MLE devices 1410, 1418 includes a mix tree 1422, 1432, implemented in at least partially parallel structures. Example implementations of the MLE devices 1410, 1418, the mix trees 1422, 1432, and the video and alpha links 1411, 1413 could include the examples described above with reference to FIG. 12.

The first MLE device 1410 may perform substantially the same operations as the first MLE 1310 (FIG. 13) on its inputs 1402, 1404, 1406, 1408, 1409, but outputs the video 1412 with its associated alpha 1414. The second MLE device 1418 inputs the first MLE output video 1412 and lays it on the top of a new background 1416 to generate a final video output 1420. The first MLE device 1410 could carry on a composite alpha through all the way to the second MLE device 1418, and hence the first MLE device could be partially parallel to the second MLE device. According to the target of L+M additional bits for fractional precision in each layer mix truncation, both the video link 1411 and the alpha link 1413 would accommodate 2+M extra bits for the 4-keys MLE output 1412 and alpha 1414. Under a quarter-bit error condition, for example, L+M would be 4.

### SDI Link for Alpha

The SMPTE defines a series of standards for video data links such as SDI. The following references, which include SMPTE documents and a document originating from the International Telecommunication Union (ITU), describe details for various video formats such as Standard Definition (SD), High Definition (HD), and 3 Gigabits per second (3G) serial interface:
SMPTE 259M, “SDTV Digital Signal/Data—Serial Digital Interface”
ITU-R BT 656, “Interfaces for Digital component Video Signals in 525-Line and 625-line Television Systems Operating at the 4:2:2 Level of Recommendation ITU-R BT.601 (PART A)”
SMPTE S292M, “1.5 Gb/s Signal/Data Serial Interface”
SMPTE 424M, “3 Gb/s Signal/Data Serial Interface”.

Although no specific standard is targeted at alpha data, in some cases an SDI link is used to transfer an alpha channel. In one implementation, alpha data is defined with 10 bits which actually define a fraction where alpha varies between 0 and 1, and there may or may not be an extra bit for integer, which would only be non-zero for an alpha value of 1. The range for 10-bit alpha would be 0 to 1024. However, SDI standards restrict 10-bit data to a range of 64 to 940 for normal luminance components and to a range of 64 to 960 for normal chrominance components. The table below captures a data table (Table 3) from SMPTE 274M-2008, “1920×1080 Image Sample Structure, Digital Representation and Digital Timing Reference Sequences for Multiple Picture Rates”, which includes the data ranges for luminance and chrominance components.

TABLE 3
Digital representation

| Items | | | 8-bit system | 10-bit system | 12-bit system | Note |
|---|---|---|---|---|---|---|
| R′, G′, B′, Y′ | | Upper | EBₕ(235) | 3ACₕ(940) | EB0ₕ(3760) | Section |
| | | Lower | 10ₕ(16) | 040ₕ(64) | 100ₕ(256) | 8.7 |
| C_{B}, C′_{R} | | Upper | F0ₕ(240) | 3C0ₕ(960) | F00ₕ(3840) | Section |
| | | Lower | 10ₕ(16) | 040ₕ(64) | 100ₕ(256) | 8.8 |
| Prohibited codes | | Upper | FFₕ(255) | 3FCₕ-3FFₕ(1020-1023) | FF0ₕ-FFFₕ(4080-4095) | Section |
| | | Lower | 00ₕ(0) | 000ₕ-003ₕ(0-3) | 000ₕ-00Fₕ(0-15) | 8.10 |
| Overshoot | G′ | Upper | ECₕ-FEₕ(236-254) | 3ADₕ-3FBₕ(941-1019) | EB1ₕ-FEFₕ(3761-4079) | Section |
| and | B′ | Lower | 01ₕ-0Fₕ(1-15) | 004ₕ-03Fₕ(4-63) | 010ₕ-0FFₕ(16-255) | 8.12 |
| undershoot | R′ | | | | | |
| | C′_{B} | Upper | F1ₕ-FEₕ(241-254) | 3C1ₕ-3FBₕ(961-1019) | F01ₕ-FEFₕ(3841-4079) | |
| | C′_{R} | Lower | 01ₕ-0Fₕ(1-15) | 004ₕ-03Fₕ(4-63) | 010ₕ-0FFₕ(16-255) | |

According to the captured table, SMPTE 274M-2008 not only defines normal data ranges but also allows overshoot and undershoot beyond the normal ranges.

As noted above, there is no specific standard targeted at alpha data. Since SDI links are widely used in video processing equipment, alpha data could be transferred over SDI links, but using time slots that are actually allocated for video data. For instance, alpha data could be scaled down to fit an SDI normal luminance data range

$$\begin{matrix}SDI TX : & {α}_{sdi} = ⌊ \frac{( 940 - 64 ) * {α}_{int}}{{2}^{10}} ⌋ + 64 \\ SDI RX : & {α}_{exp} = ⌊ \frac{( {α}_{sdi} - 64 ) * {2}^{10}}{940 - 64} ⌋ ,\end{matrix} \\ where \\ \begin{matrix}{α}_{int} ∈ [ 0 , 1024 ] \\ ⌊ ⌋ is floor operator\end{matrix} \qquad Eq . 3 \text{-} 1$$

Internal calculations could use higher precision for alpha under the L+M target, and hence alpha data could be split into an “integer” part αᵢₙₜ for general use and a “fraction” part α_{frc} for higher precision, which are concatenated such that

α_{src}={αᵢₙₜ,α_{frc}}, Eq. 3-2
where {,} is concatenation operator

Although reference is made to integer and fraction parts for alpha, it should be noted that for alpha values between 0 and 1, the integer and fraction parts together actually define a fractional value for alpha values other than 0 and 1. “Integer” and “fraction” are used solely for notation in reference to alpha, and should not be interpreted as defining an integer value for alpha and a separate fractional value for alpha. For alpha values between 0 and 1, these alpha parts together define fractional values.

In the SDI transmitter side, the integer αᵢₙₜ is scaled down and offset by 64 to fit a SDI luminance range in this example. The downscale alpha α_{sdi} can then be transferred in a luminance time slot in an SDI link. Overshoot and undershoot in SDI are not considered in the above example.

For an SDI link in which alpha data is transferred in luminance time slots, the chrominance time slots in the SDI link could be filled either with α_{sdi} or with the value 512 for gray color, for example.

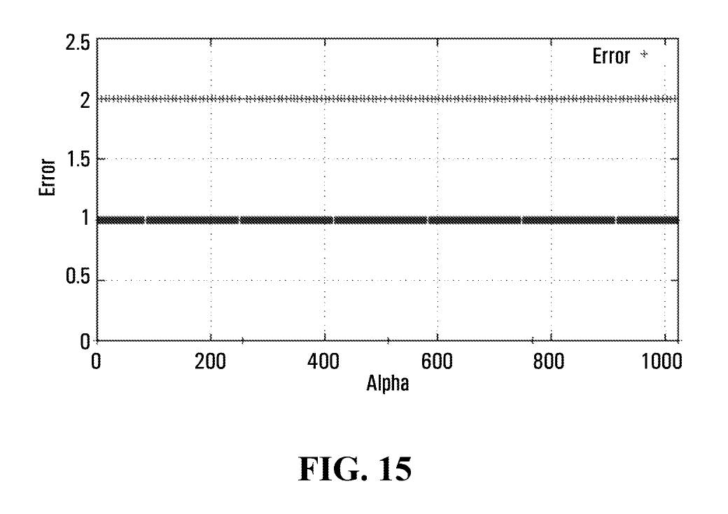

In the SDI receiver side, α_{sdi} is expanded to recover αₑₓₚ with a full range of 0 to 1024. The expanded alpha, however, deviates from the original source alpha. FIG. 15 is an example plot of errors between source alpha and expanded alpha, in which the error ranges between 0 and 2. Other error values could be observed, for example, for different scaling and expansion.

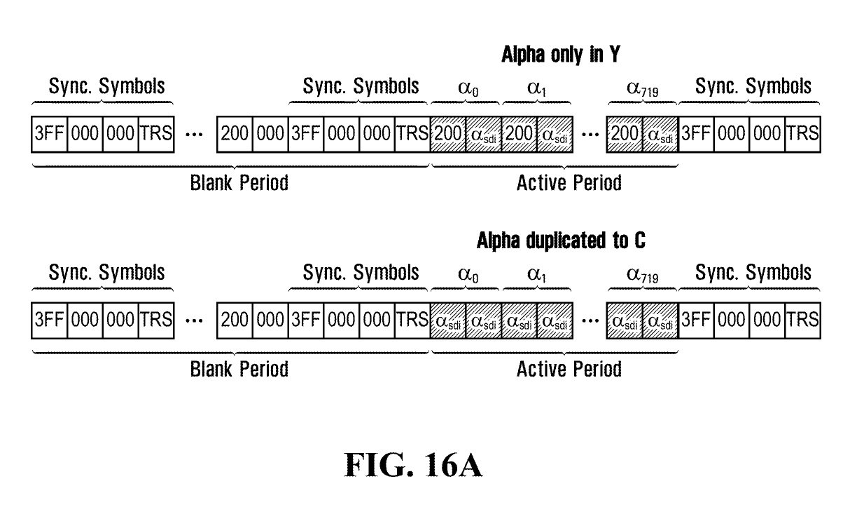

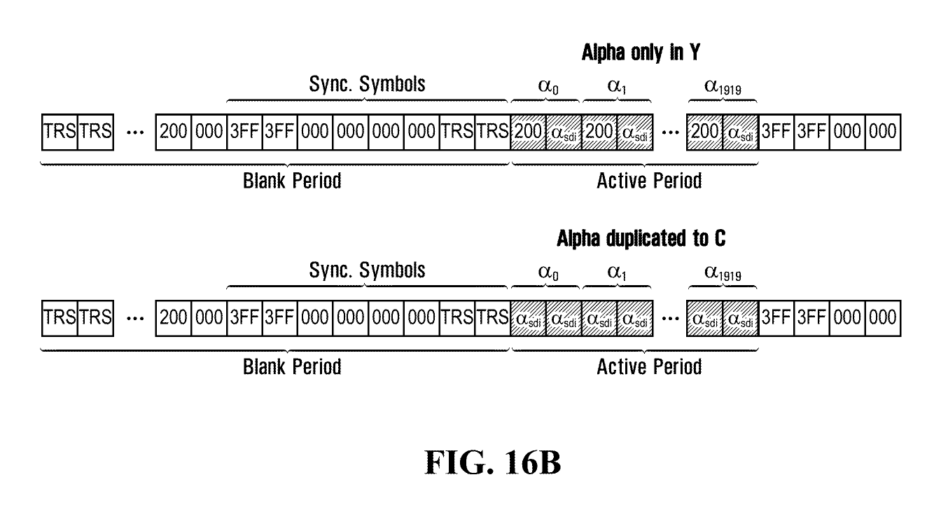

FIGS. 16A and 16B illustrate example alpha data structures in SD SDI and HD SDI, respectively. As shown, in each SDI link, alpha data is carried in luminance (Y) time slots, and the chrominance (C) time slots are filled with either repeated alpha data or the value 512, which is “200” in hexadecimal as shown.

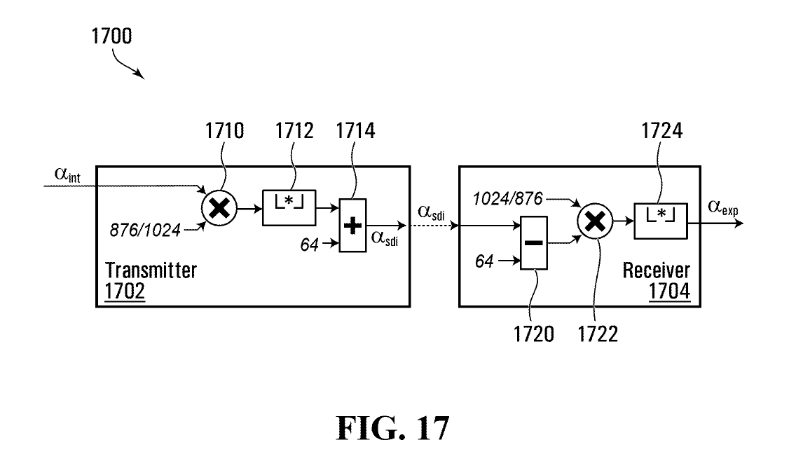

FIG. 17 is a block diagram of an example system that implements scaling and expansion of alpha data. The example system 1700 includes a transmitter 1702 and a receiver 1704. The transmitter 1702 includes a multiplier 1710 to apply scaling to αᵢₙₜ, a truncator 1712 to truncate the scaled αᵢₙₜ to 10 bits, and an adder 1714 to shift the truncated αᵢₙₜ to generate α_{sdi}, which is transferred through an SDI interface (not shown in FIG. 17 to avoid congestion in the drawing) over an SDI link in luminance time slots. The receiver 1704 includes an adder 1720 to shift α_{sdi}, a multiplier 1722 to expand the shifted α_{sdi}, and a truncator 1724 to truncate the expanded α_{sdi} to 10 bits, to generate αₑₓₚ.

As an alternative to the example system 1700, Eq. 3-1 could instead be implemented using memory devices storing lookup tables.

### Alpha-Only Structures

The preceding section describes transfer of alpha data through an SDI link. However, there are intrinsic errors due to the downscale in the transmitter and the upscale or expansion in the receiver with limited precisions. Also, there are no extra bits in the SDI links for higher precision in these techniques, and therefore extra bits for additional precision under the L+M target cannot be transferred over SDI links using these techniques.

In accordance with embodiments disclosed herein, additional alpha information is transferred with α_{sdi}. This additional alpha information could provide error information to enable compensation for intrinsic errors, and/or bits for higher precision of alpha. Two example representation forms are presented to express the intrinsic errors due to data range scale, such as direct form of errors and expansion form of errors. Three example alpha-only structures are proposed to transmit these intrinsic errors and higher-precision alpha data, illustratively for applications where alpha precision might be more important than video data. These new structures are compatible with conventional SDI structure by sustaining the form of alpha data in the luminance time slot as described in the preceding section but yielding spare time slots to the additional alpha information. In this manner, legacy devices may still handle the form of alpha data as outlined in the preceding section, while devices that are capable of doing so also extract extra information from other time slots.

### Direct Form of Error

A direct form of error in alpha-only structures is so named herein because receivers can directly or simply re-construct high-precision alphas. The direct form of errors is calculated in transmitters as follows in one embodiment.

First, an integer part of source alpha αᵢₙₜ is scaled down to fit SDI luminance data range such that

$${α}_{scl} = ⌊ \frac{( 940 - 64 ) * {α}_{int}}{{2}^{10}} ⌋ , \\ where \\ \begin{matrix}{α}_{int} ∈ [ 0 , 1024 ] \\ ⌊ ⌋ is floor operator\end{matrix} \qquad Eq . 3 \text{-} 3$$

Errors between integer alpha αᵢₙₜ and the down-scaled alpha α_{scl} are then directly calculated for compensation. The SDI data is constructed in the transmitter such that

$$SDI Tx \text{:} \{ \begin{matrix}{α}_{sdi} = {α}_{scl} + 64 & {α}_{sdi} ∈ [ 64 , 940 ] \\ {α}_{err} = {α}_{int} - {α}_{scl} + 64 & {α}_{err} ∈ [ 64 , 212 ] \\ {α}_{frc} & {α}_{frc} ∈ [ 0 , 3 ]\end{matrix} \qquad Eq . 3 \text{-} 4$$

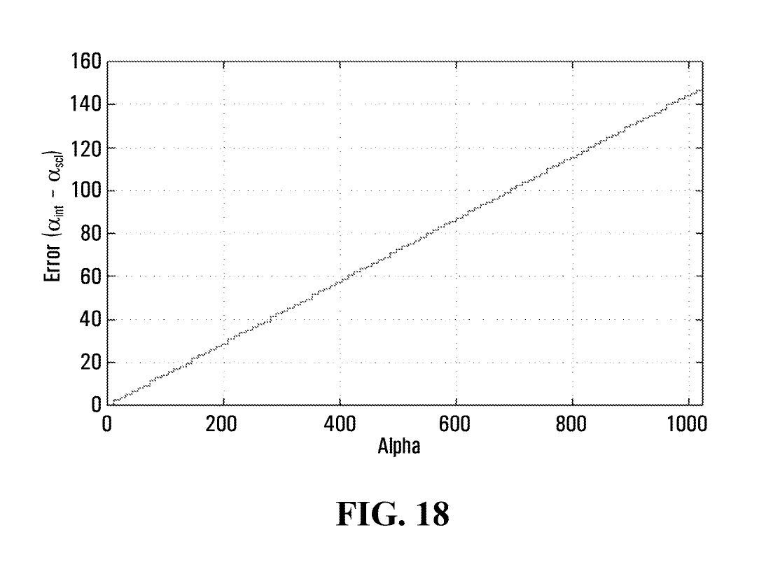

FIG. 18 is an example plot of errors between source alpha and scaled alpha, which is the difference (αᵢₙₜ−α_{scl}). The errors range from 0 to 148 over the entire range of alpha, and the full error range can be accommodated in 8 bits. Using a 10-bit additional SDI time slot, in addition to the luminance slot used to carry α_{sdi}, would leave only 2 more bits for extra L+M precision. Eq. 3-4 lists the 2 bits for extra precision as α_{frc}.

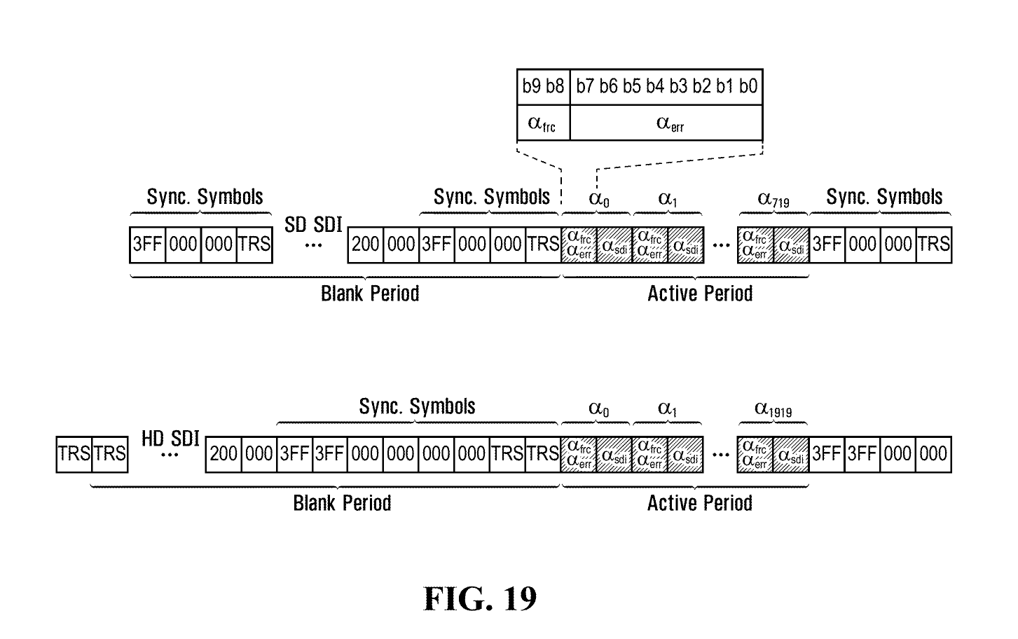

FIG. 19 illustrates further example alpha data structures in SD SDI and HD SDI. These drawings show the three components α_{sdi}, αₑᵣᵣ, and α_{frc} from Eq. 3-4 in SDI structures, where {α_{frc}, αₑᵣᵣ} are concatenated in chrominance time slots to construct data ranging between 64 and 980, beyond the normal range shown in the captured Table 3 above, but within the allowable overshoot range. Comparing FIGS. 16A and 16B with FIG. 19, it can be seen that the structures in the latter FIG. 19 use the chrominance time slots to transfer additional alpha data {α_{frc}, αₑᵣᵣ} instead of filling the chrominance time slots with repeated α_{sdi} or a value of 512.

In SDI receivers, the high-precision integer part of alpha data αᵢₙₜ is first reconstructed by adding the SDI compatible alpha α_{sdi} to the direct form of errors αₑᵣᵣ, and subtracting 128, since both α_{sdi} and αₑᵣᵣ are shifted by adding 64 in Eq. 3-4. The fraction part α_{frc} is then appended to the high-precision integer part αᵢₙₜ to determine a target alpha α_{tgt} with higher precision than in the techniques discussed in the preceding section, such that

$$SDI RX : \{ \begin{matrix}{α}_{int} = {α}_{sdi} + {α}_{err} - 128 \\ {α}_{tgt} = \{ {α}_{int} , {α}_{frc} \}\end{matrix} , \\ where \\ \{ \text{,} \} is concatentation operator \qquad Eq . 3 \text{-} 5$$

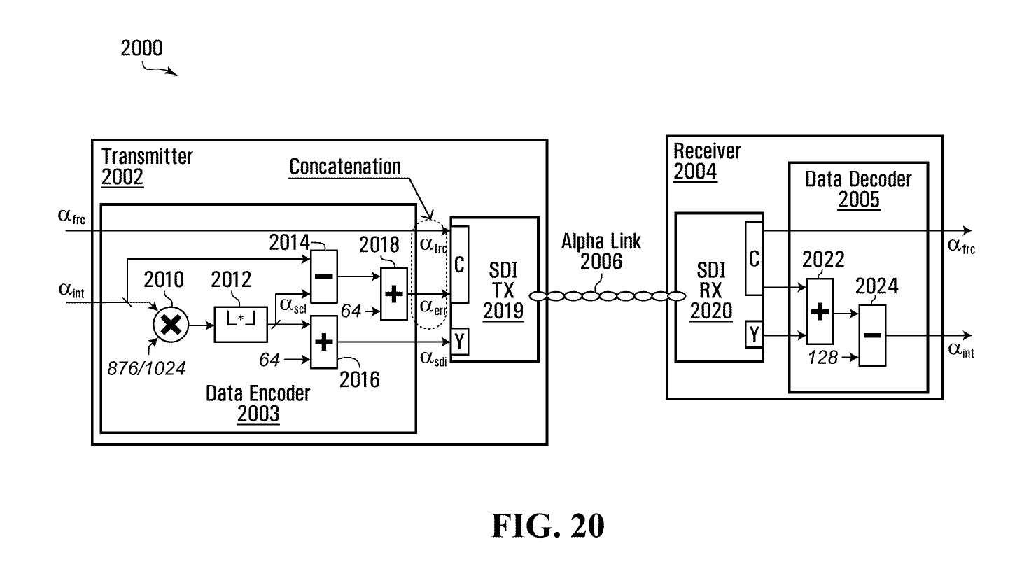

FIG. 20 is a block diagram illustrating another example video processing system 2000, which includes an transmitter 2002 and a receiver 2004 which communicate over an alpha link 2006, which in this example is an SDI link in which alpha information is transferred in luminance and chrominance SDI time slots. The receiver 2002 includes a data encoder 2003, which includes a multiplier 2010 to apply scaling to αᵢₙₜ, a truncator 2012 to truncate the scaled αᵢₙₜ (shown as α_{scl}) to the same length as αᵢₙₜ, an adder 2014 to calculate the direct form error, an adder 2016 to shift α_{scl} into luminance permitted range to generate α_{sdi}, and an adder 2018 to shift the direct form error to generate αₑᵣᵣ. At the receiver 2004, a data decoder 2005 includes an adder 2022 to calculate the sum of α_{sdi} and αₑᵣᵣ, and another adder 2024 to shift the result as shown in Eq. 3-5. These components of the data encoder 2003 and/or the data decoder 2005 could be implemented in respective discrete elements or in elements that execute software, for example.

SDI TX 2019 and SDI RX 2020 are high-speed transceivers in this example, and convert data between parallel data, illustratively 10-bit parallel data, and 1-bit serial data. Two ports in each transceiver are configured or otherwise provided to either input or output signals of chrominance (or chroma) C and luminance (or luma) Y, respectively. The SDI TX 2019 and SDI RX 2020 are examples of SDI interfaces that enable transfer of data over an SDI link, and would include some sort of physical interface to a physical data transfer medium, and transmitter/receiver components to implement transmission/reception processing to provide for data transfer. The transmitter/receiver components could be implemented in hardware, firmware, one or more components at each side of the SDI link that execute software, or some combination thereof.

In the example system 2000, additional alpha information, specifically the direct form error and extra precision bits, is embedded into an alpha-only data structure in chrominance and luminance SDI time slots at the transmitter 2002 and de-embedded from the data structure at the receiver 2004. The concatenation of the additional alpha data {α_{frc}, αₑᵣᵣ} for transfer in the chrominance time slots could be handled by the chrominance port at the SDI TX 2019, by the data encoder 2003, or possibly in a separate component. Similarly, separation of the received additional alpha data {α_{frc}, αₑᵣᵣ} in the chrominance time slots could be handled by the chrominance port at the SDI RX 2020, by the data decoder 2005, or possibly in a separate component.

Concatenation and separation in hardware need not necessarily involve any special components. For example, concatenation could potentially be implemented by simply grouping signal buses together. Although other embodiments might use separate or special components for concatenation and/or separation of signals, such components are not required in all embodiments.

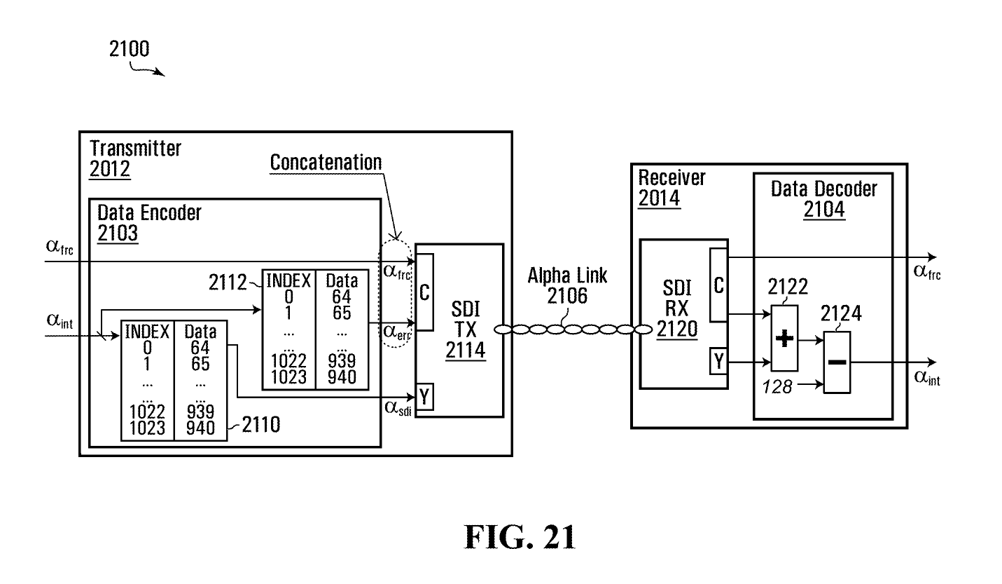

At the transmitter 2002, calculations for α_{scl} and αₑᵣᵣ in Eq. 3-3 and Eq. 3-4 could instead be realized through pre-calculated lookup tables, as shown in FIG. 21 which is a block diagram illustrating a further example video processing system. The example system 2100 in FIG. 21, like the example system 2000 in FIG. 20, includes a transmitter 2102 and a receiver 2104 which communicate over an alpha SDI link 2106. The data encoder 2103 at the transmitter 2102 includes one or more memory devices to store the lookup tables 2110, 2112, from which α_{sdi} and αₑᵣᵣ are read based on αᵢₙₜ. The example system 2100 also includes SDI TX 2114 at the transmitter 2102, as well as SDI RX 2120 and a data decoder 2105 with adders 2122, 2124 at the receiver 2104.

The memory in which the lookup tables 2110, 2112 are stored could include one or more memory devices, which could include one or more solid-state memory devices and/or memory devices having movable or even removable storage media. Such memory need not be dedicated to the lookup tables, and could be memory areas within memory devices that are also used to store other information as well. Implementation examples of elements which are common between FIGS. 20 and 21 are provided above with reference to FIG. 20.

From a comparison of FIGS. 20 and 21, it is apparent that alpha data and additional alpha information could be generated in different ways, including by calculation, as in FIG. 20, or otherwise, such as through memory lookup as in FIG. 21. Embodiments disclosed herein are not restricted to any specific one of these options for generating alpha data or additional alpha information for transfer over SDI links.

### Expansion Form of Error

Embedding of direct form errors only leaves 2 bits for extra precision when using SDI luminance time slots to transfer alpha data and SDI chrominance time slots to transfer additional alpha information in a 10-bit system. In another embodiment, an expansion form of errors is calculated by expanding the scaled-down alpha data first and then taking the error for compensation between the integer part and the expanded alpha. In this case the error only has values of 0, 1 or 2.

The expansion is expressed by

$${α}_{exp} = ⌊ \frac{{α}_{scl} * {2}^{10}}{940 - 64} ⌋ \qquad Eq . 3 \text{-} 6$$

In a transmitter side, the SDI data is constructed by

$$SDI TX \text{:} \{ \begin{matrix}{α}_{sdi} = {α}_{scl} + 64 & {α}_{sdi} ∈ [ 64 , 940 ] \\ {α}_{err} = {α}_{int} - {α}_{exp} & {α}_{err} ∈ [ 0 , 2 ] \\ {α}_{frc} = ⌊ ( {α}_{src} - {α}_{int} ) * {2}^{8} ⌋ + 64 & {α}_{frc} ∈ [ 64 , 319 ]\end{matrix} \qquad Eq . 3 \text{-} 7$$

The example error plot in FIG. 15 represents the expansion form of errors, and as shown most of the errors are 1, maximum error is 2, and the error is 0 at only 5 values of alpha, including the ends of the alpha range of 0 and 1024 and three intermediate alpha values. 2 bits can accommodate these error values and therefore the 8 remaining bits in the chrominance time slots in a 10-bit SDI system could be used for extra alpha precision.

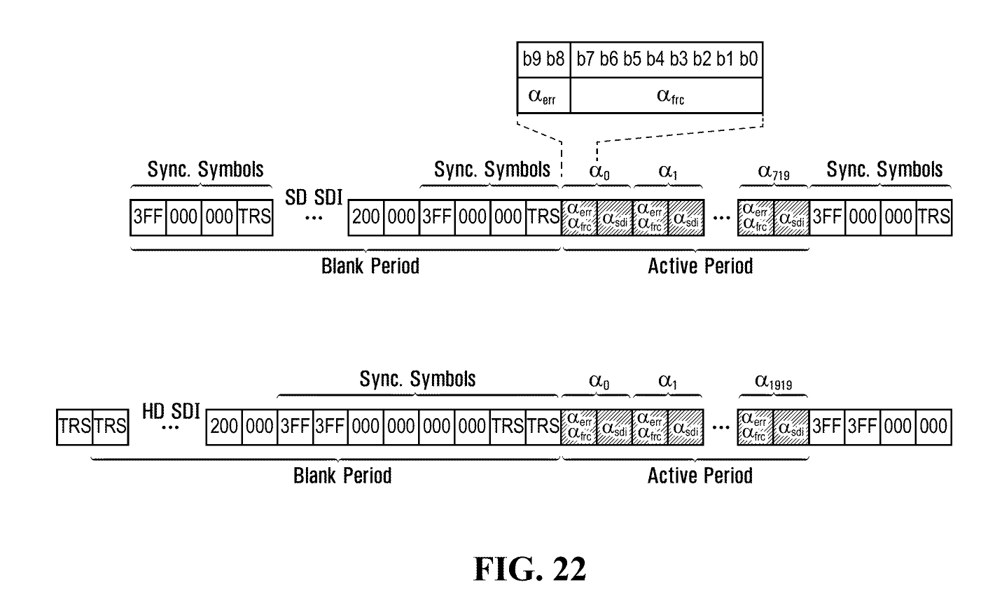

FIG. 22 illustrates still further example alpha data structures in SD SDI and HD SDI. The three components α_{sdi}, αₑᵣᵣ, and α_{frc} from Eq. 3-7 are shown in FIG. 22, and the overall arrangement of these components is similar to the arrangement shown in FIG. 19, except that {αₑᵣᵣ, α_{frc}} are concatenated by αₑᵣᵣ in most significant bits (MSBs) and α_{frc} in least significant bits (LSBs) in the chrominance time slots in FIG. 22.

On a receiver side, the downscaled integer part is first expanded and then added to the error to form the complete integer part. Concatenation of the integer part and fraction part produces the high-precision alpha such that

$$SDI RX : \{ \begin{matrix}{α}_{int} ⌊ \frac{( {α}_{sdi} - 64 ) * {2}^{10}}{940 - 64} ⌋ + {α}_{err} \\ α = \{ {α}_{int} , {α}_{frc} \}\end{matrix} \qquad Eq . 3 \text{-} 8$$

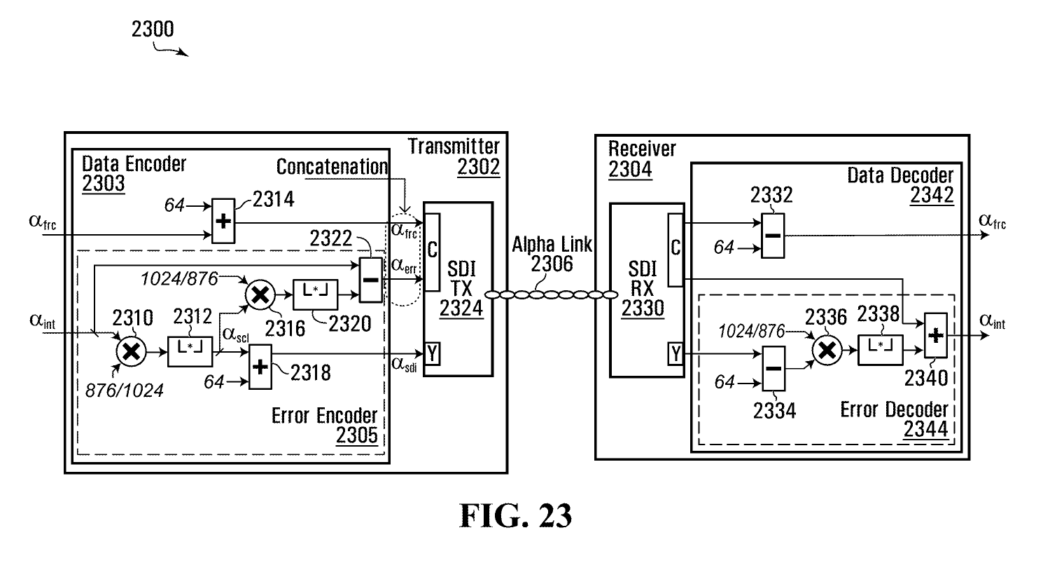

FIG. 23 is a block diagram illustrating another example video processing system 2300, which includes a transmitter 2302 and a receiver 2304 which communicate over an alpha link 2306, which in this example is an SDI link in which alpha information is transferred in luminance and chrominance SDI time slots.

A data encoder 2303 at the transmitter 2302 includes a multiplier 2310 to apply scaling to αᵢₙₜ, a truncator 2312 to truncate the scaled αᵢₙₜ (shown as α_{scl}) to the same length as αᵢₙₜ, and an adder 2318 to shift α_{scl} into luminance permitted range to generate α_{sdi}. Another multiplier 2316 is provided to upscale α_{scl}, and the upscaled α_{scl} is truncated to the same length as αᵢₙₜ by a truncator 2320 before calculation of the expansion form error αₑᵣᵣ by an adder 2322. For ease of reference below, these elements of the data encoder 2303 are shown in FIG. 23 as an error encoder 2305. An adder 2314 applies a shift to α_{frc}.

At the receiver 2304, a data decoder 2342 includes an adder 2332 to apply a shift to α_{frc}, and an error decoder 2344. The error decoder 2344 includes an adder 2334 to apply a shift to α_{sdi}. The shifted α_{sdi} is upscaled by a multiplier 2336 and truncated to the same length as αᵢₙₜ by a truncator 2338. Another adder 2340 is provided to sum the resultant truncated upscaled α_{sdi} and αₑᵣᵣ, to calculate αᵢₙₜ. SDI TX 2324 and SDI RX 2330 are high-speed transceivers in this example, and convert data between parallel data and serial data, and each has a chrominance port and a luminance port.

The various components in FIG. 23 could be implemented in much the same way as those in FIG. 20. The alpha data and additional alpha information are determined in different ways between FIGS. 20 and 23, but the actual implementations could be substantially the same. In the example system 2300 (FIG. 23), the additional alpha information is the expansion form error and extra precision bits, but is embedded into an alpha-only data structure in chrominance and luminance SDI time slots at the transmitter 2302 and de-embedded from the data structure at the receiver 2304, as in FIG. 20. The order of concatenation of the additional alpha data {α_{frc}, αₑᵣᵣ} could also be different in FIG. 23, with 2-bit αₑᵣᵣ in the MSBs and 8-bit α_{frc} in the LSBs of the chrominance time slots, for example, in the case of a 10-bit system.

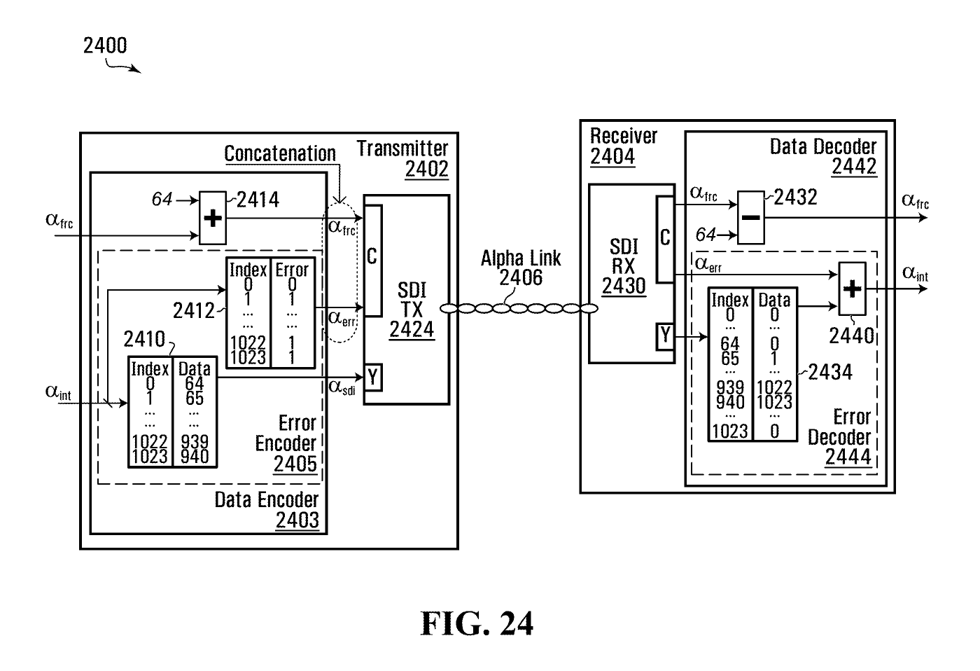

As noted above with reference to FIGS. 20 and 21, alpha data and additional alpha information could be calculated, or otherwise determined or obtained, such as through memory lookup. In FIG. 24, which is a block diagram illustrating a further example video processing system, α_{sdi} and αₑᵣᵣ are read from lookup tables 2410, 2412 at a transmitter 2402, and alpha data scaling and shifting at a receiver 2404 side are similarly replaced by table lookup at 2434. The example system 2400, in addition to memory storing the lookup tables 2410, 2412 at the error encoder 2405 and memory storing the lookup table 2434 at the error decoder 2444, includes other components similar to those in FIG. 23, including an alpha SDI link 2406, an adder 2414 in a data encoder 2403, an SDI TX 2424 at the transmitter 2402, an SDI RX 2430 at the receiver 2404, an adder 2432 in a data decoder 2442, and an adder 2440 in the error decoder 2444. As noted above with reference to FIG. 21, the lookup tables 2410, 2412 could be stored in memory that includes one or more memory devices, and similarly the lookup table 2434 could be stored in one or more memory devices at the receiver 2304. Such memory devices at the transmitter 2402 and the receiver 2404 could be dedicated memory devices or shared memory devices which also store information other than the lookup tables 2410, 2412, 2434.

### H-Blank Period for Error

Expansion form of errors can be embedded into a horizontal blank period, provided that auxiliary data such as audio data are not embedded. 2-bit errors from 5 pixels, for example, could be packed into 10-bit data, ranging from 0 to 2 AA in hexadecimal. After adding an offset of 64, the packed errors range from 64 to 746 in decimal, within the SDI data range [64,940] for luminance. Table 4 below lists the numbers of packed errors against budgets in main video formats.

TABLE 4
packed 2-bit errors versus budget in horizontal blank period

| Video | Packed | |
|---|---|---|
| Format | Errors | Budget |
| HD 1080 | 1920/5 = 384 | (2200 − 1920) × 2 = 560 |
| HD 720P | 1280/5 = 256 | (1650 − 1280) × 2 = 740 |
| SD NTSC | 720/5 = 144 | (858 − 720) × 2 = 276 |
| SD PAL | 720/5 = 144 | (864 − 720) × 2 = 288 |

Considering the first row of Table 4 as an example, there are 1920 valid pixels for HD/1080 horizontally. If 5 pixels with 2-bit error are packed to occupy a 10-bit time slot, then the packed errors would occupy 1920/5=384 time slots in SDI. The other formats are 1280 pixels for HD/720P and 720 pixels for NTSC/PAL horizontally, and the packed errors for those formats are calculated accordingly. The budgets in Table 4 are the numbers of 10-bit data slots in one horizontal blank period. Again for the example of HD/1080, the total number of time slots is 2200×2 horizontally (×2 means one slot for luma, one slot for chroma in SDI). Subtracting the number of valid time slots from the total number of time slots yields the number of blank time slots, for each format shown in Table 4.

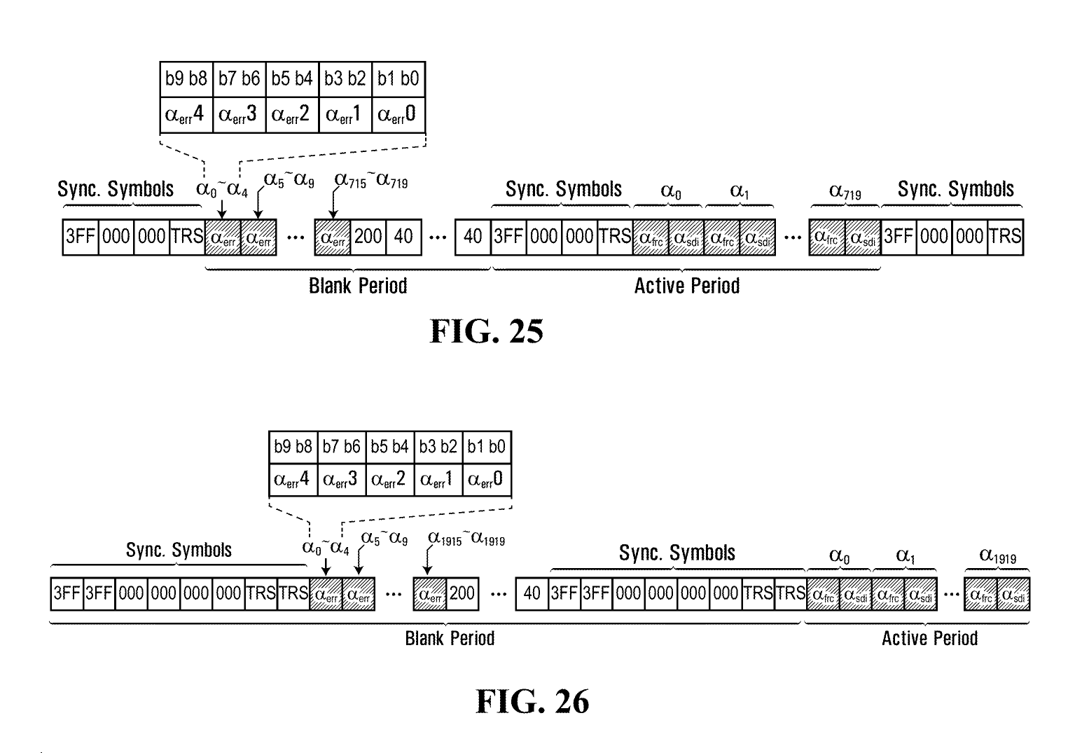

FIGS. 25 and 26 illustrate example alpha data structures using horizontal blank periods in SD SDI and HD SDI, respectively. The examples in FIGS. 25 and 26 are for 2-bit errors embedded into the horizontal blank periods. In FIGS. 25 and 26, 2-bit αₑᵣᵣ values are carried in the horizontal blank periods, and therefore each α_{frc} in FIGS. 25 and 26 is 10 bits instead of 8 bits as in FIGS. 22A and 22B.

From FIGS. 25 and 26, it will be apparent that 2-bit errors embedded into the horizontal (H) blank period will be ahead of the active period, which carries α_{frc} and α_{sdi}, rather than parallel to the active period. One possible solution for synchronization is to add line buffers to delay alpha data and related video data, either in a transmitter side or in a receiver side. Extra line buffers could be added into a system, but may add more cost. Fortunately, many systems such as MLE devices and DVE devices use line buffers to align multiple video sources to a common reference in both transmitters and receivers, and such existing line buffers could additionally be used for error synchronization, which means that there would be no “real” extra costs to implement a technique in which errors are embedded into the H blank period.

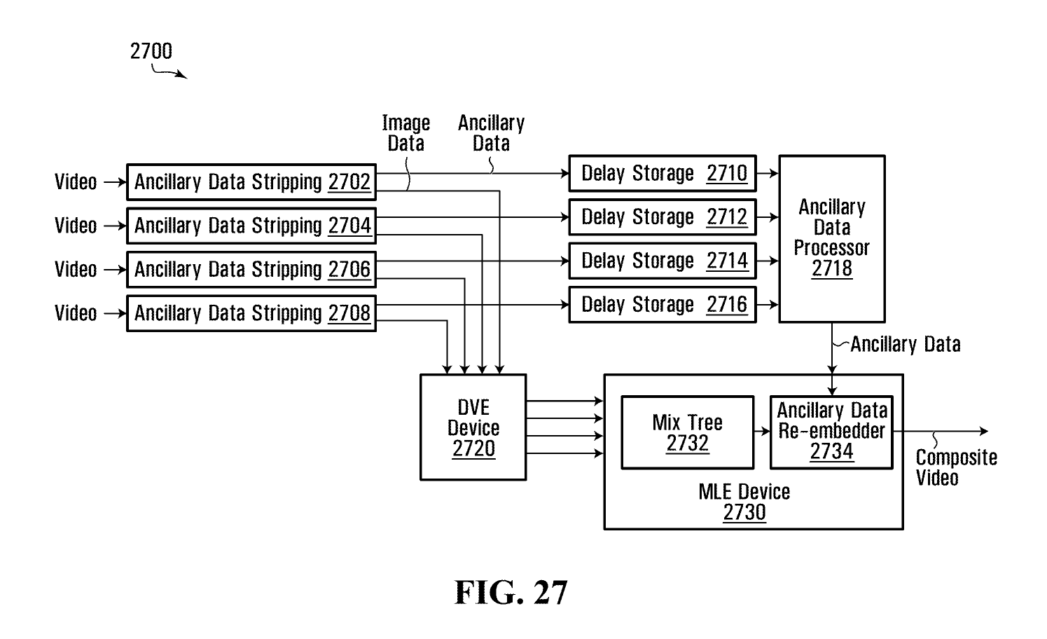

Errors embedded into the H blank period could potentially overlap with ancillary data. SMPTE 291M, “Ancillary Data Packet and Space Formatting” defines a standard for ancillary data in blank periods. In many MLE devices and DVE devices, extra storage components or devices are designed to retain all ancillary data separately. After layering processes are finished in DVE devices and MLE devices, for example, the ancillary data are re-embedded into composite video data. FIG. 27 is a block diagram illustrating an example video processing system 2700, and shows an ancillary data processing flow. Each ancillary data stripping block 2702, 2704, 2706, 2708 separates ancillary data from video blank periods and saves the ancillary data into delay storage 2710, 2712, 2714, 2716 to synchronize the ancillary data flow to a video layering flow inside the DVE device 2720 or the MLE device 2730. The ancillary data processor 2718 could perform such functions as audio data switching and/or mixing, fade-in or fade-out, loudness control, and/or other acoustic processing. In the example shown, the MLE device 2730 implements layering in a mix tree 2732. The re-embedder 2734 inserts the ancillary data back into composite video data.

With such re-embedding of ancillary data, use of the H-blank period for expansion form of errors is feasible.

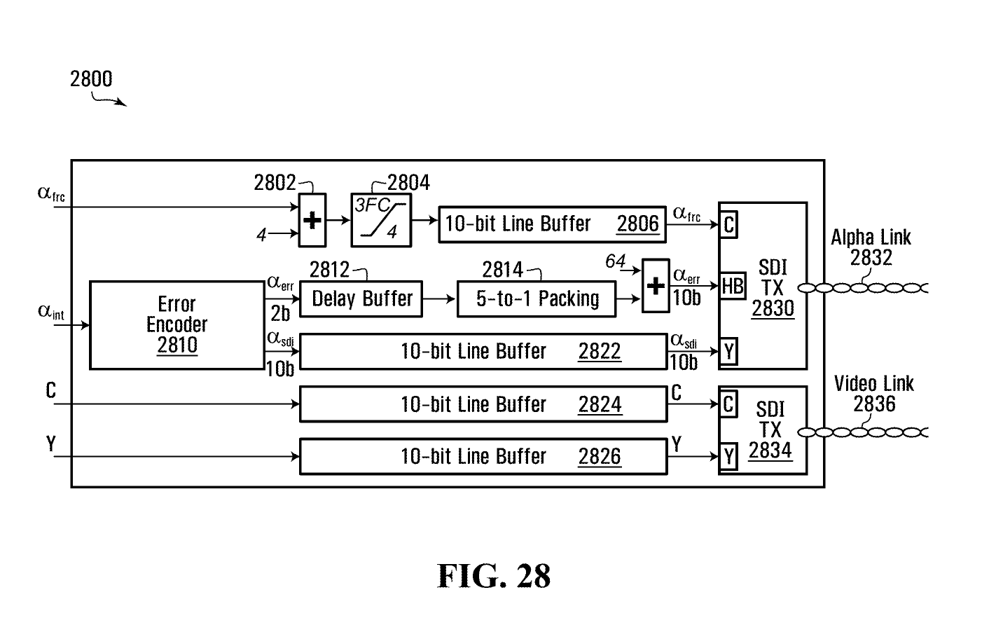

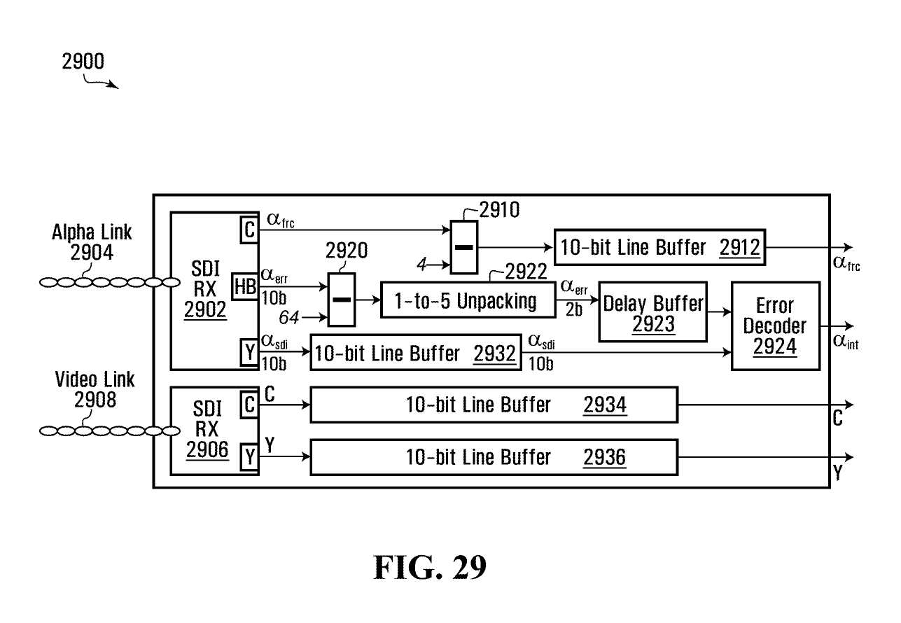

FIGS. 28 and 29 together illustrate an example video processing system that implements embedding of 2-bit alpha errors into the H blank period on an SDI link. FIG. 28 illustrates a block diagram for an example transmitter, and FIG. 29 illustrates a block diagram for an example receiver.

The example transmitter 2800 includes an adder 2802 to add an offset of 4 to α_{frc}, a clipper 2804 to clip the offset value of α_{frc} to a range between 4 and 1020 (3 FC in hexadecimal), and a 10-bit line buffer 2806 to store the clipped offset value of α_{frc}. The error encoder 2810 encodes the expansion form of errors, and examples of such an error encoder are shown at 2305 in FIGS. 23 and 2405 in FIG. 24. 2-bit αₑᵣᵣ values are provided to a delay buffer 2812, and a 5-to-1 packing module 2814 concatenates 5 of the 2-bit αₑᵣᵣ values together. The 5-to-1 packing module 2814 is an example of a concatenation module to concatenate data. In this example, the 5-to-1 packing module 2814 concatenates the 2-bit αₑᵣᵣ values, but in other embodiments a similar component could be provided to concatenate other data, such as α_{frc} and αₑᵣᵣ as in FIGS. 23 and 24.

An adder 2816 is provided to add an offset of 64 to the resultant 10-bit αₑᵣᵣ value. α_{sdi}, C, and Y values are stored in 10-bit line buffers 2822, 2824, 2826. SDI TX 2830 and SDI TX 2834 are high-speed transceivers in this example, and convert data between 10-bits parallel data and 1-bit serial data for transfer over an alpha SDI link 2832 and a video SDI link 2836. Each SDI TX 2830, 2834 has a chrominance port C and a luminance port Y, and a horizontal blank port HB is also shown for the SDI TX 2830.

The buffers 2806, 2812, 2822, 2824, 2826 in FIG. 28 could be implemented in one or more memory devices. These memory devices could include one or more dedicated memory devices that are used only for the buffers, and/or shared memory devices that are also used for other purposes. In an embodiment, at least the line buffers 2806, 2822, 2824, and 2826 are existing buffers that are used to align multiple video sources to a common reference. The other components in FIG. 28 could be implemented in hardware, firmware, one or more components that execute software, or some combination thereof.

The example transmitter 2800 includes an error encoder 2810 to generate αₑᵣᵣ and α_{sdi}. The error encoder 2810 and other components in the input paths that provide inputs to the ports of the SDI TX 2830 represent another example of a data encoder that encodes data for transfer over an SDI link through the SDI TX.

In FIG. 28, the 10-bit chrominance time slot uses a normal range plus overshoot and undershoot ranges for α_{frc}, ranging from 4 to 1020. After adding an offset of 4 to α_{frc}, the α_{frc} value is clipped to 1020, which restricts data within 4-1020 and may produce a maximum error of 7 against the 10-bit α_{frc}.

An expansion-form of error encoder, expressed in Eq. 3-7 above and illustrated in FIGS. 23 and 24, could be employed in FIG. 28 at 2810 to produce a 10-bit SDI-compatible alpha (α_{sdi}) plus a 2-bit αₑᵣᵣ.

Five 2-bit errors are packed into 10-bit data and offset by 64 at 2814, 2816 to form a 10-bit αₑᵣᵣ value ranging from 64 to 746. The 10-bit αₑᵣᵣ value is fed into a port HB of the SDI TX 2830 which inputs a horizontal blank signal for transfer over the alpha SDI link 2832.

The 4 full-line buffers 2806, 2822, 2824, 2826 delay the alpha fraction part α_{frc}, the SDI-compatible alpha integer part α_{sdi}, the video chrominance C component, and the video luminance Y component, respectively, to enable insertion of the 2-bit errors into H blank periods ahead of these main components in horizontal active periods.

The two SDI high-speed transceivers 2830, 2834 transmit video components and alpha components individually, over separate SDI links 2832, 2836.

Turning to the receiver side, the example receiver 2900 in FIG. 29 includes SDI RX 2902 and SDI RX 2906, which are high-speed transceivers in this example to receive data over an alpha SDI link 2904 and a video SDI link 2908. Each SDI RX 2902, 2906 has a chrominance port C and a luminance port Y, and a horizontal blank port HB is also shown for the SDI RX 2902. An adder 2910 applies a shift to α_{frc}, to reverse the offset applied at 2802 (FIG. 28), and the resultant shifted α_{frc} value is stored in line buffer 2912. Similarly, an adder 2920 applies a shift to the received 10-bit αₑᵣᵣ value, to reverse the offset applied at 2816 (FIG. 28). The 1-to-5 unpacking module 2922 separates the 5, 2-bit αₑᵣᵣ values which were concatenated together at 2814 (FIG. 28), and the resultant 2-bit αₑᵣᵣ values are stored in a delay buffer 2923. The delay buffer 2923 is used to effectively “stretch” the blank period error data across the full active period. In an SDI video data transmission period, for example HD/1080, the blank period (380 pixels) is ahead of the active period (1920 pixels). The delay buffer 2923 enables the error data in the blank period to be gradually released from the buffer and evenly applied to 1920 pixels in the active period.

The αₑᵣᵣ values are provided to the error decoder 2924, along with received α_{sdi} values which are stored in line buffer 2932. These components coupled to the SDI RX 2902 represent another example of a data decoder. The received C and Y video components are received over the video link 2908 and are stored in line buffers 2934, 2936. The error decoder 2924 decodes the expansion form of errors, and examples of such a decoder are shown at 2344 in FIGS. 23 and 2444 in FIG. 24.

The buffers 2912, 2923, 2932, 2934, 2936, like the buffers in FIG. 28, could be implemented in one or more memory devices, including one or more dedicated memory devices that are used only for the buffers, and/or shared memory devices that are also used for other purposes such as existing buffers that are also used to align multiple video sources to a common reference. The other components in FIG. 29 could be implemented in hardware, firmware, one or more components that execute software, or some combination thereof.

The example receiver 2900 in FIG. 29 illustrates line buffers 2912, 2932, 2934, 2936 which could be provided at the receiver if the transmitter does not synchronize the 2-bit errors with video components using the line buffers 2806, 2822, 2824, 2826. The line buffers could be provided at either a transmitter or a receiver, but need not be used at both. The full-line buffers 2912, 2932, 2934, 2936, if used at the receiver 2900, synchronize the alpha data and video data with the 2-bit alpha errors.

From FIG. 29, it can be noted that the two SDI high-speed transceivers 2902, 2906 receive serial alpha data and a serial video data individually over the alpha SDI link 2904 and the video SDI link 2908, and then convert the serial data into 10-bit parallel data. The alpha link transceiver 2904 outputs C/Y through port C and port Y, and also outputs horizontal blank signals through port HB.

The 1-to-5 unpacking module 2922 splits a 10-bit αₑᵣᵣ signal into 5 parts as noted above, and aligns them to the SDI-compatible alpha α_{sdi}.

An expansion-form error decoder, expressed in Eq. 3-8 and illustrated in FIGS. 23 and 24 by way of example, could be used as the error decoder 2924 to reconstruct an alpha integer part αᵢₙₜ.

### Alpha+Video Structure

An example application of a 4-layer key combiner in DVE devices involves 4 extra bits in both a video link and an alpha link for a parallel structure and maximum quarter-bit error. Extra bits for alpha channels are described in detail above. This section discusses extra bits for both video channels and alpha channels. The video channel includes both luminance Y and chrominance C components. Spare time slots could be incapable of accommodating all of them. Normally, luminance error is more visible than chrominance error, and therefore packing alpha and luminance (luma) together at the cost of loss in chrominance precision is first considered. Packing of alpha with luminance and chrominance is then considered, at the cost of loss in additional precision.

Alpha+Luma Structure

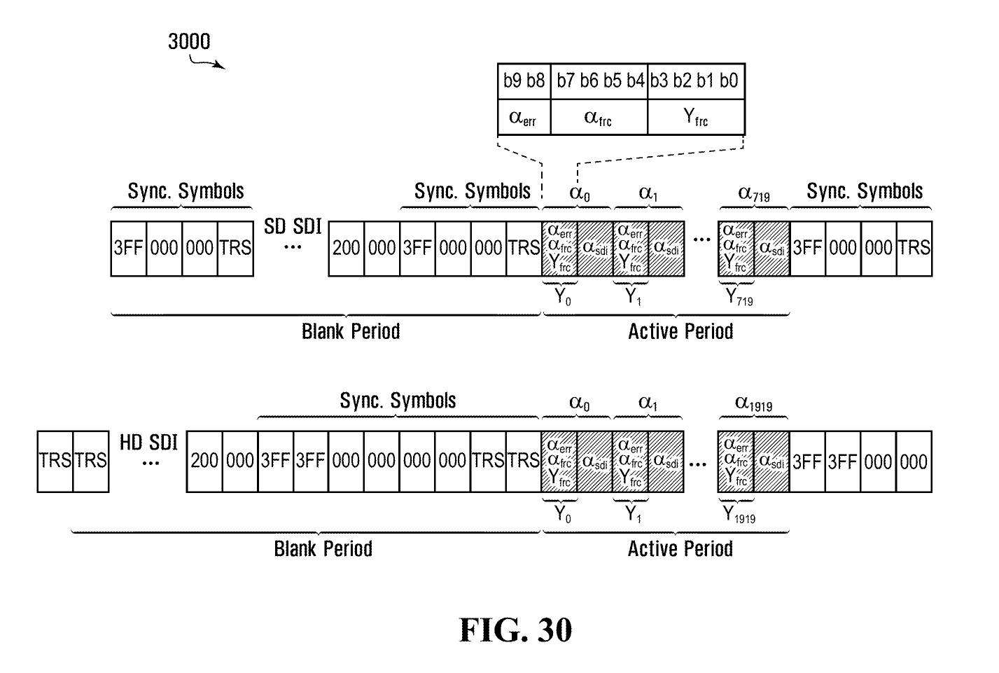

FIG. 30 illustrates example alpha+luma data structures in SD SDI and HD SDI, and depicts data structures for extra bits to fit chrominance time slots. The 3 components {αₑᵣᵣ, α_{frc}, Y_{frc}} are concatenated by αₑᵣᵣ in MSBs and Y_{frc} in LSBs. Due to 2-bits expansion form of errors in MSBs, no overflow occurs after offset 64 is added to the concatenated data {αₑᵣᵣ, α_{frc}, Y_{frc}}. It should be noted that the 4 bits for Y_{frc} are additional bits for additional precision for Y. 10-bit Y data would still be transferred over a video SDI link in this example, and the additional 4 bits for Y_{frc} would be transferred over an alpha SDI link, to provide a total of 14-bit precision for Y.

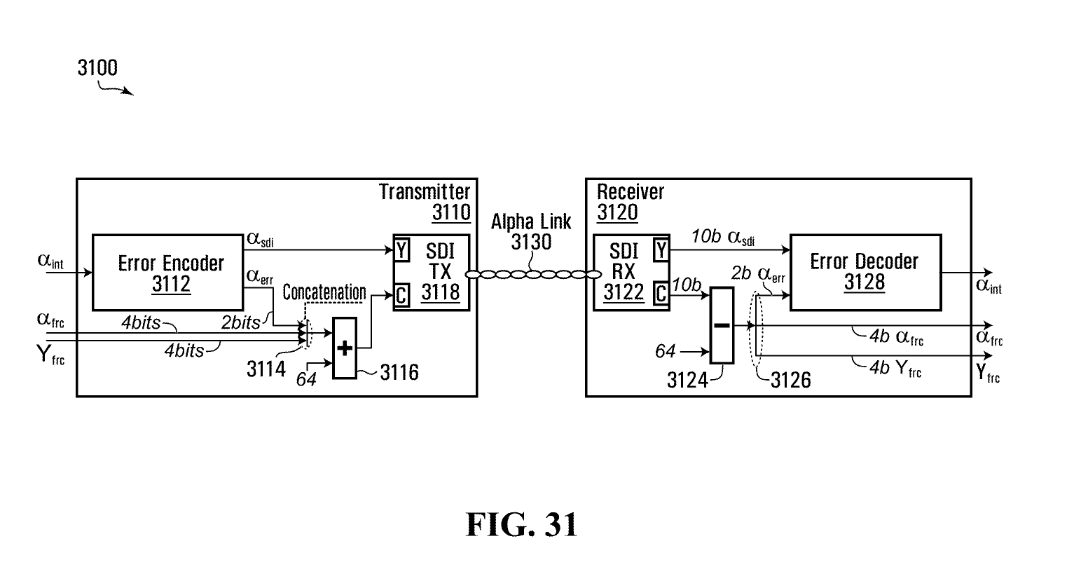

FIG. 31 is a block diagram illustrating another example video processing system 3100, which includes a transmitter 3110 and a receiver 3120 which communicate over an alpha SDI link 3130. The transmitter includes an error encoder 3112, an adder 3116, and an SDI TX interface 3118. The receiver 3120 includes an SDI RX interface 3122, an adder 3124, and an error decoder 3128. The components in FIG. 31 could be implemented in hardware, firmware, one or more components that execute software, or some combination thereof.

The error encoder 3112 encodes the expansion form of errors, and examples of such an encoder are shown at 2305 in FIGS. 23 and 2405 in FIG. 24. The adder 3116 is provided to add an offset of 64 to a concatenation of αₑᵣᵣ, α_{frc}, and Y_{frc}. The concatenation of αₑᵣᵣ, α_{frc}, and Y_{frc} is shown at 3114, and could potentially be handled by the error encoder 3112, by a separate component, or without any special component in hardware by regrouping signal buses together, for example. The error encoder 3112 and the adder 3116 represent another example of a data encoder to encode data for transfer over the SDI link 3130 through the SDI TX 3118.

At the receiver 3120, the adder 3124 is provided to apply an inverse shift to the concatenation of αₑᵣᵣ, α_{frc}, and Y_{frc}, to reverse the offset applied by the adder 3116 at the transmitter 3110. Unpacking or separation of αₑᵣᵣ, α_{frc}, and Y_{frc} is shown at 3126, and could be implemented in the error decoder 3128, separately, or without any special component. The error decoder 3128 decodes the expansion form of errors, and examples of such a decoder are shown at 2344 in FIGS. 23 and 2444 in FIG. 24.

SDI TX 3118 and SDI RX 3122 are high-speed transceivers in this example, and convert data between 10-bits parallel data and 1-bit serial data for transfer over the alpha SDI link 3130. Each of SDI TX 3118 and SDI RX 3122 has a chrominance port C and a luminance port Y. A separate video SDI link with separate SDI TX and RX interfaces may also be provided, to separately carry C and Y data.

From FIG. 31 and the description above, it can be noted that an error encoder and an error decoder for expansion-form of errors shown in FIGS. 23 and 24 could be directly employed at 3112 and 3128 in FIG. 31 to produce SDI-compatible alpha and expansion form of errors. In the transmitter 3110, packed data {αₑᵣᵣ, α_{frc}, Y_{frc}} is offset by 64 at 3116 to fit within the SDI data range, but in the receiver 3120, the offset is removed at 3124.

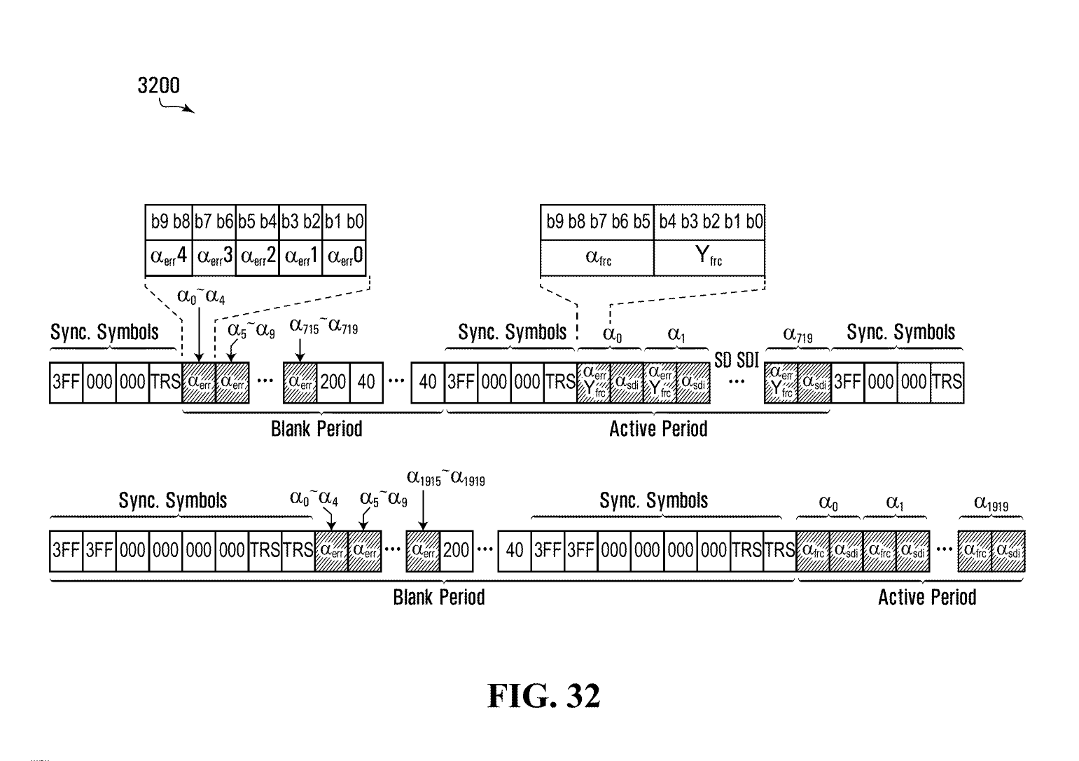

FIG. 32 illustrates example alpha+luma data structures in which 2-bit errors are embedded into an H blank period in SD SDI and HD SDI. In horizontal active periods on the alpha SDI link, each chrominance time slot is shared by 5-bit alpha fraction and 5-bit luma fraction. {α_{frc}, Y_{frc}} are packed by α_{frc} in MSBs and Y_{frc} in LSBs. After adding an offset 4 and ceiling to 1020 to fit into the permissible C data range including overshoot and undershoot, the data {α_{frc}, Y_{frc}} may overflow to produce maximum losses of 7 in α_{frc} against the 5-bit alpha fraction data.

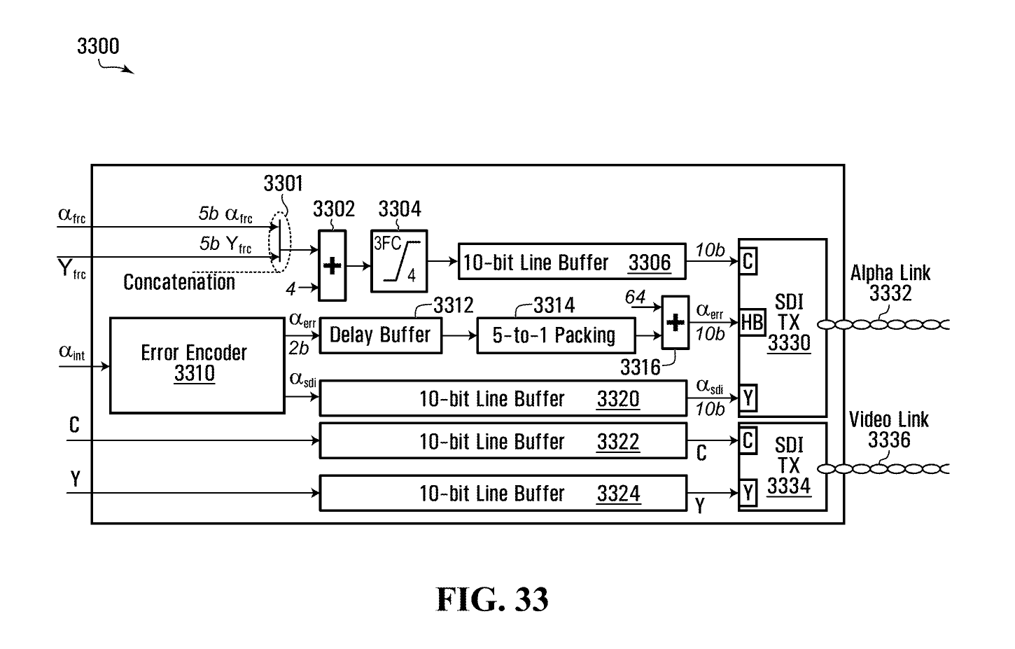

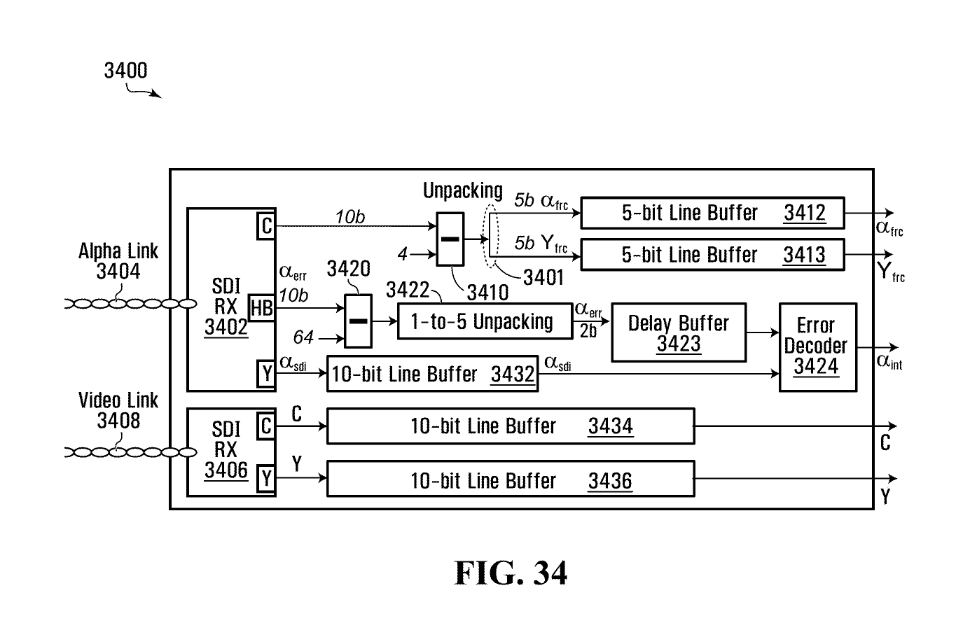

FIGS. 33 and 34 together illustrate an example video processing system that implements an alpha+luma data structure and embedding of 2-bit alpha errors into the H blank period on an SDI link. FIG. 33 illustrates a block diagram for an example transmitter, and FIG. 34 illustrates a block diagram for an example receiver.

The example transmitter 3300 includes an adder 3302 to add an offset of 4 to a concatenation of α_{frc} and Y_{frc}, a clipper 3304 to clip the offset value of {α_{frc}, Y_{frc}} to a range between 4 and 1020 (3 FC in hexadecimal), and a 10-bit line buffer 3306 to store the clipped offset value of {α_{frc}, Y_{frc}}. The error encoder 3310 encodes the expansion form of errors, and examples of such an encoder are shown at 2305 in FIGS. 23 and 2405 in FIG. 24. 2-bit αₑᵣᵣ values are provided to a delay buffer 3312, and the 5-to-1 packing module 3314 concatenates 5 of the 2-bit αₑᵣᵣ values together. An adder 3316 is provided to add an offset of 64 to the resultant 10-bit αₑᵣᵣ value.

α_{sdi}, C, and Y values are stored in 10-bit line buffers 3320, 3322, 3324. SDI TX 3330 and SDI TX 3334 are high-speed transceivers in this example, and convert data between 10-bits parallel data and 1-bit serial data for transfer over an alpha SDI link 3332 and a video SDI link 3336. Each SDI TX 3330, 3334 has a chrominance port C and a luminance port Y, and a horizontal blank port HB is also shown for the SDI TX 3330.

The various components shown in FIG. 33 could be implemented in substantially the same way as in FIG. 28. The overall structure of the transmitter 3300 in FIG. 33 could be nearly identical to the transmitter 2800 in FIG. 28. However, in FIG. 33 the concatenation {α_{frc}, Y_{frc}} is used instead of α_{frc} alone. The concatenation of α_{frc} and Y_{frc} could be handled by a separate component at 3301, or possibly integrated with the adder 3302 without any special component. The components in FIG. 33 which encode α_{frc}, Y_{frc}, and αᵢₙₜ for transfer over the alpha SDI link 3332 through the SDI TX 3330 represent yet another example of a data encoder.

With reference now to FIG. 34, the example receiver 3400 includes SDI RX 3402 and SDI RX 3406, which are high-speed transceivers in this example to receive data over an alpha SDI link 3304 and a video SDI link 3408. Each SDI RX 3402, 3406 has a chrominance port C and a luminance port Y, and a horizontal blank port HB is also shown for the SDI RX 3402. An adder 3410 applies a shift to the received concatenation {α_{frc}, Y_{frc}}, to reverse the offset applied at 3302 (FIG. 33), and the resultant shifted {α_{frc}, Y_{frc}} value is separated or unpacked into α_{frc} and Y_{frc}, which are stored in 5-bit line buffers 3412, 3413. The separation or unpacking at 3401 could be implemented in a separate component or integrated with the adder 3410 or otherwise implemented without any special component.

An adder 3420 applies a shift to the received 10-bit αₑᵣᵣ value, to reverse the offset applied at 3316 (FIG. 33). The 1-to-5 unpacking module 3422 separates the 5, 2-bit αₑᵣᵣ values which were concatenated together at 3314 (FIG. 33), and the resultant 2-bit αₑᵣᵣ values are aligned to the SDI-compatible alpha α_{sdi} by the 1-to-5 unpacking module and are stored in a delay buffer 3423. The αₑᵣᵣ values are provided to the error decoder 3424, along with received α_{sdi} values which are stored in line buffer 3432. The received C and Y video components are also stored in line buffers 3434, 3436. The error decoder 3424 decodes the expansion form of errors, and examples of such a decoder are shown at 2344 in FIGS. 23 and 2444 in FIG. 24. The components involved in decoding α_{frc}, Y_{frc}, and αᵢₙₜ at the receiver 3400 represent another example of a data decoder.

On comparison of FIGS. 29 and 34, it will be apparent that the example receivers 2900 and 3400 could be implemented in substantially the same way. In FIG. 34, however, the concatenation {α_{frc}, Y_{frc}} is received instead of α_{frc} alone, and α_{frc} and Y_{frc} are separated or unpacked at 3401. The 10-bit line buffer 2912 for α_{frc} in FIG. 29 is replaced with two 5-bit line buffers 3412, 3413 in FIG. 34. Another possible option would be to buffer the shifted concatenation {α_{frc}, Y_{frc}} output from the adder 3401 in a 10-bit line buffer and then handle the separation or unpacking into α_{frc} and Y_{frc} as part of the buffer read process to read α_{frc} and Y_{frc} separately out of the buffer.

The receiver 3400 in FIG. 34 illustrates line buffers 3412, 3413, 3432, 3434, 3436 which could be provided at the receiver if the transmitter 3300 does not synchronize the 2-bit errors with video components using the line buffers 3306, 3320, 3322, 3324. The line buffers could be provided in either a transmitter side device or a receiver side device, but need not be used at both sides. The line buffers 3412, 3413, 3432, 3434, 3436, if used at the receiver 3400, synchronize the alpha data and video data with the 2-bit alpha errors.

### Alpha+Luma+Chroma

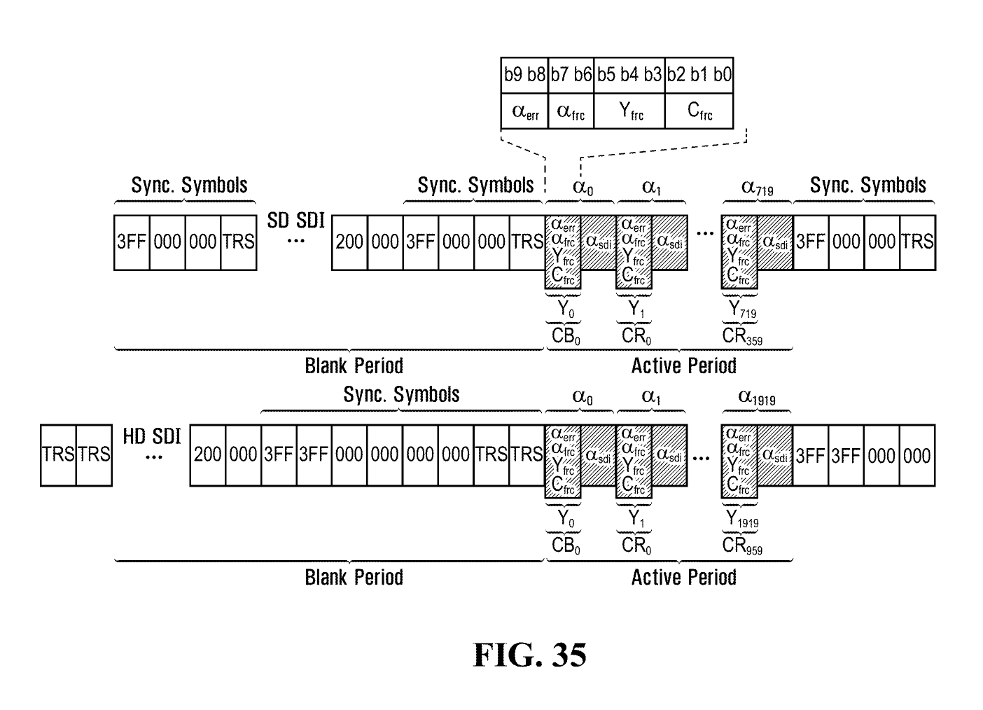

It is also possible to include higher precision for other video components. For example, additional precision bits for the chrominance component could be added, at a cost of lower precision for other components. FIG. 35 illustrates example alpha+luminance (luma)+chrominance (chroma) data structures in SD SDI and HD SDI.

The bit allocation is determined as follows in the example shown, although other bit allocations are possible:
1) Video data with higher additional precision, including 3 bits for each of luma (Y_{frc}) and chroma (C_{frc})
2) Alpha data α_{frc} with less precision, including 2 bits for fraction
3) Expansion form of errors αₑᵣᵣ with 2 bits, as in other examples
4) No range overflow after adding offset 64 due to expansion form of errors in MSBs.

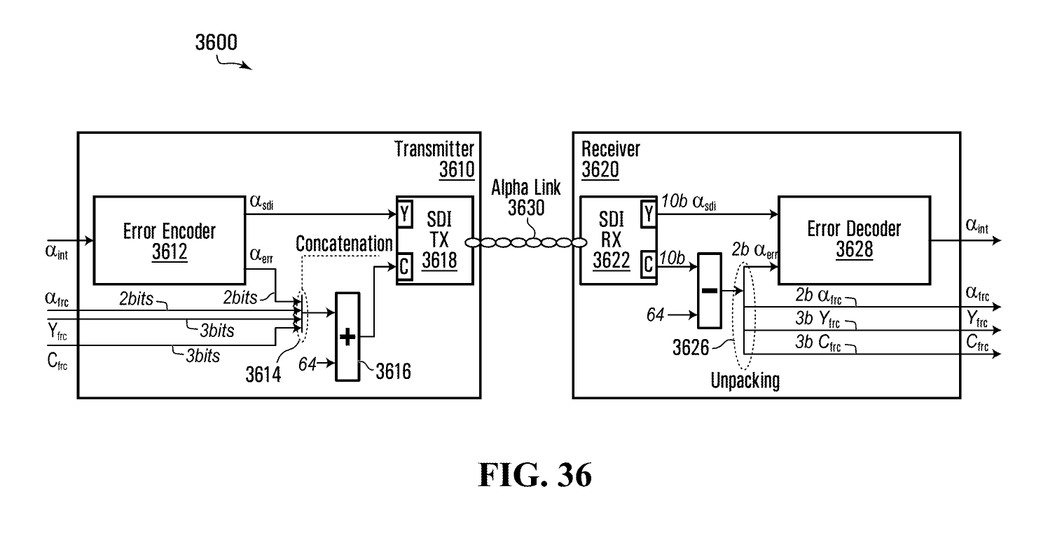

FIG. 36 is a block diagram illustrating another example video processing system 3600, which implements an example data structure as depicted in FIG. 35. The example video processing system 3600 includes a transmitter 3610 and a receiver 3620 which communicate over an alpha SDI link 3630. The transmitter includes an error encoder 3612 and an adder 3616 which form a data encoder, and an SDI TX interface 3618. The receiver 3620 includes an SDI RX interface 3622, and a data decoder that includes an adder 3624 and an error decoder 3628.

The error encoder 3612 encodes the expansion form of errors, and examples of such an encoder are shown at 2305 in FIGS. 23 and 2405 in FIG. 24. The adder 3616 is provided to add an offset of 64 to a concatenation of αₑᵣᵣ, α_{frc}, Y_{frc}, and C_{frc}. The concatenation of αₑᵣᵣ, α_{frc}, Y_{frc}, and C_{frc} is shown at 3614, and could potentially be handled by the error encoder 3612, by a separate component, or without any special component.

At the receiver 3620, the adder 3624 is provided to apply an inverse shift to the concatenation of αₑᵣᵣ, α_{frc}, Y_{frc}, and C_{frc}, to reverse the offset applied by the adder 3616 at the transmitter 3610. Unpacking or separation of αₑᵣᵣ, α_{frc}, Y_{frc}, and C_{frc} is shown at 3626, and could be implemented in the error decoder 3628, separately, or without any special component. The error decoder 3628 decodes the expansion form of errors, and examples of such a decoder are shown at 2344 in FIGS. 23 and 2444 in FIG. 24.

SDI TX 3618 and SDI RX 3622 are high-speed transceivers in this example, and convert data between 10-bits parallel data and 1-bit serial data for transfer over the alpha SDI link 3630. Each of SDI TX 3618 and SDI RX 3622 has a chrominance port C and a luminance port Y. A separate video SDI link with separate SDI TX and RX interfaces may also be provided, to separately carry C and Y data.

The example systems 3600 and 3100 (FIG. 31) could be implemented in substantially the same way. In FIG. 36, however, C_{frc} is additionally concatenated with αₑᵣᵣ, α_{frc}, and Y_{frc} at 3614, and C_{frc} is additionally separated or unpacked at 3626.

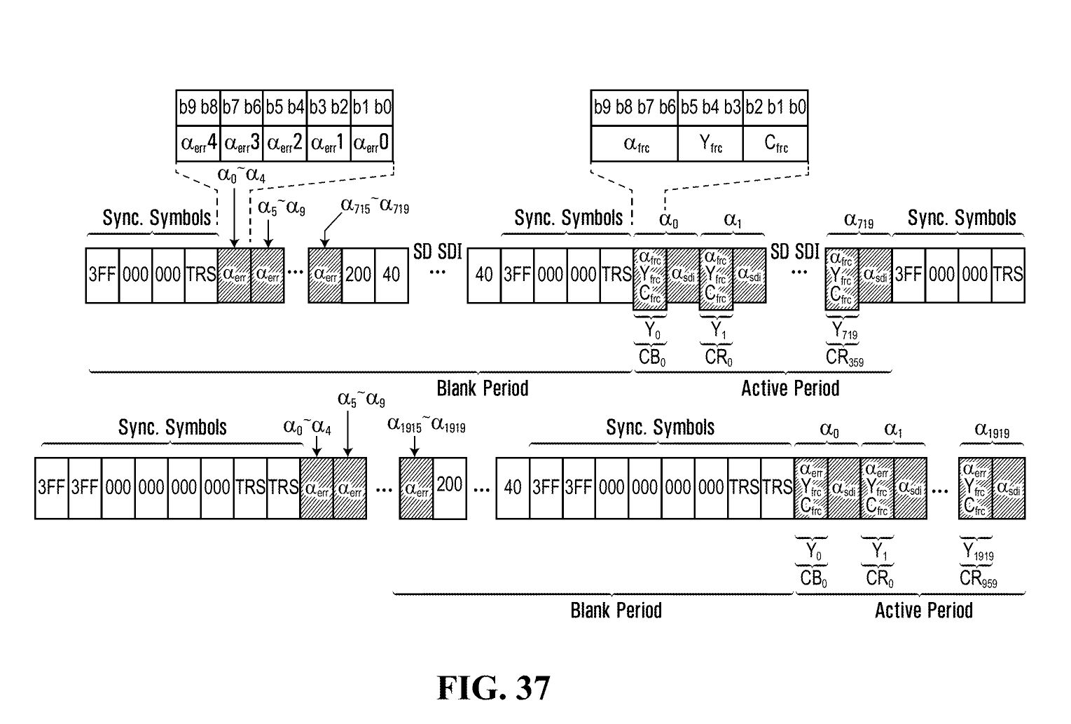

FIG. 37 illustrates example alpha+luma+chroma data structures in which 2-bit errors are embedded into an H blank period in SD SDI and HD SDI. If the H-blank period is used for αₑᵣᵣ, then 2 more bits can be allocated to α_{frc}, as shown. It could be preferable to assign the extra 2 bits, which become available in the chrominance slots by carrying αₑᵣᵣ in the H blank period, to α_{frc} as a way to compensate for a data range loss due to the offset of 4 and the ceiling of 1020 applied to the chrominance slots. The maximum loss in alpha fraction is 7 against 4-bit alpha fraction. However, other allocations of these 2 bits, including separately allocating each bit to carrying different data, are also possible.

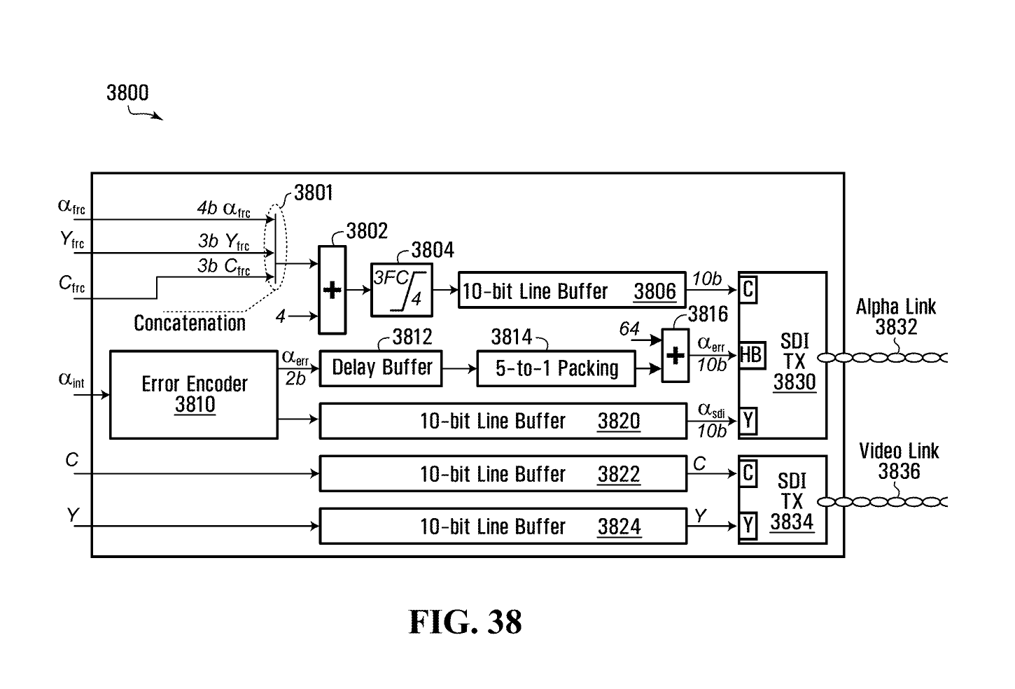

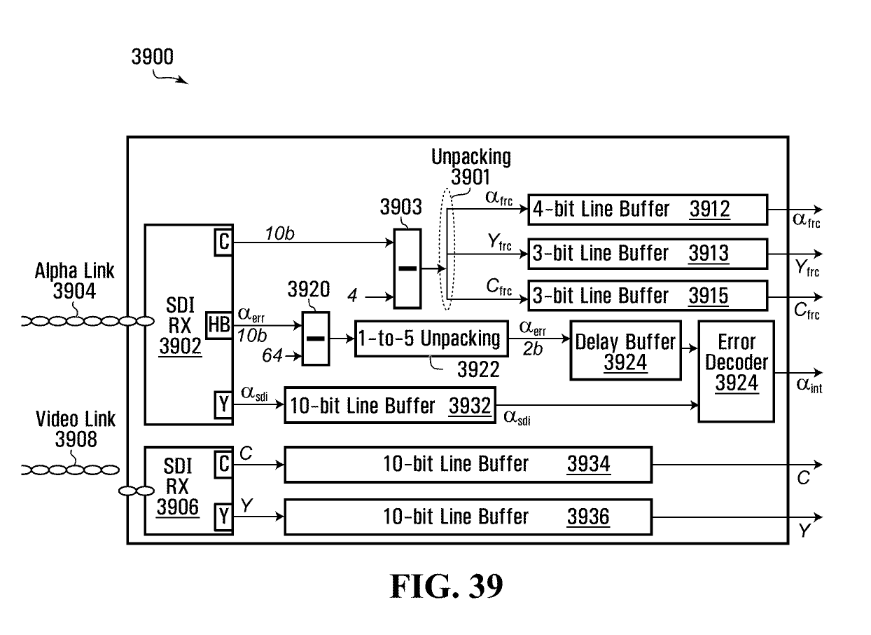

FIGS. 38 and 39 together illustrate an example video processing system that implements an alpha+luma+chroma data structure and embedding of 2-bit alpha errors into the H blank period on an SDI link. FIG. 38 illustrates a block diagram for an example transmitter, and FIG. 39 illustrates a block diagram for an example receiver.

The example transmitter 3800 includes an adder 3802 to add an offset of 4 to a concatenation of α_{frc}, Y_{frc}, C_{frc}, and C_{frc}, a clipper 3804 to clip the offset value of {α_{frc}, Y_{frc}, C_{frc}} to a range between 4 and 1020 (3 FC in hexadecimal), and a 10-bit line buffer 3806 to store the clipped offset value of {α_{frc}, Y_{frc}, C_{frc}}. The error encoder 3810 encodes the expansion form of errors, and examples of such an encoder are shown at 2305 in FIGS. 23 and 2405 in FIG. 24. 2-bit αₑᵣᵣ values are provided to a delay buffer 3812, and the 5-to-1 packing module 3814 concatenates 5 of the 2-bit αₑᵣᵣ values together. An adder 3816 is provided to add an offset of 64 to the resultant 10-bit αₑᵣᵣ value. α_{sdi}, C, and Y values are stored in 10-bit line buffers 3820, 3822, 3824. The components which encode alpha data, alpha error, and extra precision data for transfer over an alpha link 3832 can be considered an example of a data encoder.

SDI TX 3830 and SDI TX 3834 are high-speed transceivers in this example, and convert data between 10-bits parallel data and 1-bit serial data for transfer over the alpha SDI link 3332 and a video SDI link 3336. Each SDI TX 3830, 3834 has a chrominance port C and a luminance port Y, and a horizontal blank port HB is also shown for the SDI TX 3830.

The various components shown in FIG. 38 could be implemented in substantially the same way as in FIGS. 28 and 33. The overall structure of the transmitter 3800 in FIG. 33 could be nearly identical to the transmitters 2800 in FIGS. 28 and 3300 in FIG. 33. However, in FIG. 38 the concatenation {α_{frc}, Y_{frc}, C_{frc}} is used instead of {α_{frc}, Y_{frc}} or α_{frc} alone. The concatenation of α_{frc}, Y_{frc}, and C_{frc} could be handled by a separate component at 3801, or possibly integrated with the adder 3802 or otherwise implemented without any additional specialized component.

Turning to FIG. 39, the example receiver 3900 includes SDI RX 3902 and SDI RX 3906, which are high-speed transceivers in this example to receive data over an alpha SDI link 3904 and a video SDI link 3908. Each SDI RX 3902, 3906 has a chrominance port C and a luminance port Y, and a horizontal blank port HB is also shown for the SDI RX 3902.

An adder 3910 applies a shift to the received concatenation {α_{frc}, Y_{frc}, C_{frc}}, to reverse the offset applied at 3802 (FIG. 38), and the resultant shifted {α_{frc}, Y_{frc}, C_{frc}} value is separated or unpacked into α_{frc}, Y_{frc}, and C_{frc}, which are stored in a 4-bit line buffer 3912 and two 3-bit line buffers 3913, 3915, respectively. The separation or unpacking at 3901 could be implemented in a separate component, or possibly integrated with the adder 3903 or otherwise implemented without a separate specialized component. An adder 3920 applies a shift to the received 10-bit αₑᵣᵣ value, to reverse the offset applied at 3816 (FIG. 38). The 1-to-5 unpacking module 3922 separates the five 2-bit αₑᵣᵣ values which were concatenated together at 3814 (FIG. 38), and the resultant 2-bit αₑᵣᵣ values are aligned to the SDI-compatible alpha α_{sdi} by the 1-to-5 unpacking module and are stored in a delay buffer 3923. The αₑᵣᵣ values are provided to the error decoder 3924, along with received α_{sdi} values which are stored in line buffer 3932. The decoder 3924 decodes the expansion form of errors, and examples of such a decoder are shown at 2344 in FIGS. 23 and 2444 in FIG. 24. These components of the receiver 3900 can be considered an example of a data decoder.

The received C and Y video components are stored in line buffers 3934, 3936.

On comparison of FIGS. 29, 34, and 39 it will be apparent that the example receivers 2900, 3400, and 3900 could be implemented in substantially the same way. In FIG. 39, however, the concatenation {α_{frc}, Y_{frc}, C_{frc}} is received instead of {α_{frc}, Y_{frc}} or α_{frc} alone, and α_{frc}, Y_{frc}, and C_{frc} are separated or unpacked at 3901. The 10-bit line buffer 2912 for α_{frc} in FIG. 29 and the two 5-bit line buffers 3412, 3413 in FIG. 34 are replaced with the 3 line buffers 3912, 3913, 3915. Another possible option would be to buffer the shifted concatenation {α_{frc}, Y_{frc}, C_{frc}} output from the adder 3903 in a 10-bit line buffer and then handle the separation or unpacking into α_{frc}, Y_{frc}, and C_{frc} as part of the buffer read process to read α_{frc}, Y_{frc}, and C_{frc} out of the buffer.

The receiver 3900 in FIG. 39 illustrates line buffers 3912, 3913, 3915, 3932, 3934, 3936 which could be provided at the receiver if the transmitter 3800 does not synchronize the 2-bit errors with video components using the line buffers 3806, 3820, 3822, 3824. The line buffers could be provided in either a transmitter or a receiver, but need not be used at both. The line buffers 3912, 3913, 3915, 3932, 3934, 3936, if used at the receiver 3900, synchronize the alpha data and video data with the 2-bit alpha errors.

### Implementation

Various embodiments are shown in the drawings and described above.

For instance, several illustrative examples of data encoders are shown in FIGS. 20, 21, 23 and 24. In each case, the data encoder includes some form of a data range converter to convert video mix parameter data that is associated with video data into link-compatible video mix parameter data for transfer over an SDI link. The video mix parameter data, illustratively αᵢₙₜ, has a first range of permissible values and the link-compatible video mix parameter data, illustratively α_{sdi}, has a second range of permissible values. The second range is a range of values permissible for the SDI link and is narrower than the first range, as described in detail above by way of example with reference to Table 3. In FIG. 20, for example, the multiplier 2010, the truncator 2012, and the adder 2016 perform data range conversion between αᵢₙₜ and α_{sdi}. The lookup table 2110 (FIG. 21), the combination of the multiplier 2310, the truncator 2312, and the adder 2318 (FIG. 23), and the lookup table 2410 (FIG. 24) are other examples of a data range converter.

Each data encoder also includes a form of error generator operatively coupled to the data range converter to generate, based on the video mix parameter data and data range conversion by the data range converter, error data for transfer over the SDI link. The error data is indicative of an error introduced by the data range conversion. For the direct form of error in FIGS. 20 and 21, the error generator is implemented with the adder 2014 or the lookup table 2112, which generate the error data based on a difference between the video mix parameter data αᵢₙₜ and scaled video mix parameter data α_{scl}. For the indirect form of error in FIGS. 23 and 24, the error generator is implemented with the multiplier 2316, the truncator 2320, and the adder 2322 or the lookup table 2412, which generate the error data αₑᵣᵣ based on a difference between the video mix parameter data αᵢₙₜ and video mix parameter data that has been scaled (α_{scl}) and subsequently upscaled. In FIG. 23, the upscaling of α_{scl} is implemented using the multiplier 2316 and the truncator 2320.

The example data encoders 2003, 2103, 2303, 2403 in FIGS. 21 to 24 may also encode other data such as α_{frc}. In the case of FIGS. 20 and 21, α_{frc} is passed through to the SDI TX 2019, 2114, whereas in FIGS. 23 and 24, α_{frc} is encoded by adding an offset or shift of 64 at the adders 2314, 2414. Although data encoders are not labelled separately from the error encoders in FIGS. 28, 31, 33, 36, and 38 in order to avoid congestion in these drawings, it should be appreciated that these embodiments may implement encoding of other data, such as α_{frc}, Y_{frc}, C_{frc}, as shown.

A transmitter could include such a data encoder and an SDI transceiver operatively coupled to the data encoder. Such SDI transceivers are shown in the drawings by way of example as SDI TX interfaces.

In embodiments disclosed herein, an SDI transceiver is to receive the link-compatible video mix parameter data α_{sdi}, and to transfer the link-compatible video mix parameter data in first video slots (illustratively luminance slots) on the SDI link. Other data may be transferred in at least second video slots on the SDI link.

For example, an SDI transceiver may receive the error data (αₑᵣᵣ) and additional-precision video mix parameter data (α_{frc}) that provides additional precision for the video mix parameter data and transfer the error data concatenated with the additional-precision video mix parameter data in second video slots on the SDI link, illustratively chrominance slots as shown in FIG. 23.

In another embodiment, the SDI transceiver may receive additional-precision video mix parameter data (α_{frc}) that provides additional precision for the video mix parameter data, and a signal that includes the error data (5 blocks of 2-bit error data packed into 10-bit error data), transfer the additional-precision video mix parameter data in second video slots on the SDI link (illustratively chrominance slots as shown in FIG. 28), and transfer the signal comprising the error data in third video slots on the SDI link (illustratively horizontal blank period slots as shown in FIG. 28).

The SDI transceiver, in a further embodiment, could receive a signal that includes a concatenation of the error data, additional-precision video mix parameter data (α_{frc}) that provides additional precision for the video mix parameter data, and additional-precision video data such as Y_{frc} that provides additional precision for a component of the video data, and transfer the signal in second video slots on the SDI link, illustratively chrominance slots as shown in FIG. 31.

According to yet another embodiment, the SDI transceiver may receive a signal that includes the error data, and a signal that includes a concatenation of additional-precision video mix parameter data (α_{frc}) that provides additional precision for the video mix parameter data and additional-precision video data such as Y_{frc} that provides additional precision for a component of the video data, transfer the signal that include the concatenation in second video slots on the SDI link (illustratively chrominance slots as shown in FIG. 33), and transfer the signal that includes the error data in third video slots on the SDI link, such as the horizontal blank period slots as shown in FIG. 33.

Another possible option involves the SDI transceiver receiving a signal that includes a concatenation of the error data, additional-precision video mix parameter data (α_{frc}) that provides additional precision for the video mix parameter data, additional-precision video data such as Y_{frc} that provides additional precision for a first component of the video data, and additional-precision video data such as C_{frc} that provides additional precision for a second component of the video data, and transferring the signal in second video slots on the SDI link, as shown by way of example in FIG. 36, in which the concatenation is shifted by adding 64 in the adder 3616 and transferred in chrominance slots.

In a still further embodiment shown by way of example in FIG. 38, an SDI transceiver may receive a signal including the error data, and a signal including a concatenation of additional-precision video mix parameter data (α_{frc}) that provides additional precision for the video mix parameter data, additional-precision video data such as Y_{frc} that provides additional precision for a first component of the video data, and additional-precision video data such as C_{frc} that provides additional precision for a second component of the video data, transfer the signal that includes the concatenation in second video slots (C slots) on the SDI link, and transfer the signal comprising the error data in third video slots (HB slots) on the SDI link.

At a receiver side, a data decoder includes an input to receive link-compatible video mix parameter data and link-compatible error data that are transferred over an SDI link. The link-compatible error data is indicative of an error introduced in generating the link-compatible video mix parameter data from video mix parameter data that is associated with video data. The input could be simply a connection to an SDI interface, for example. A data decoder also includes an error corrector, operatively coupled to the input, to apply the error data in converting the received link-compatible video mix parameter into recovered video mix parameter data that is associated with the video data. In FIG. 20, for example, the adder 2022 applies the error data to the link-compatible α_{sdi}, and the result is shifted by subtracting 128 at 2024. FIG. 21 includes a similar error corrector, and the error data is also applied by adders 2340 and 2440 in FIGS. 23 and 24.

The data decoder could also include a data range converter to convert the received link-compatible video mix parameter data into converted video mix parameter data having a first range of permissible values, from a second range of permissible values of the link-compatible video mix parameter data. In FIG. 23, the combination of the adder 2334, the multiplier 2336, and the truncator 2338 is one example of a data range converter. The lookup table 2434 in FIG. 24 is another example. The error corrector, illustratively the adders 2340, 2440 in FIGS. 23 and 24, could then be coupled to the data range converter, to apply the error data to the converted video mix parameter data.

Many features noted above with reference to encoders or transmitters may have counterpart features at decoders and receivers. For example, the example data decoders 2005, 2104, 2342, 2442 in FIGS. 21 to 24 may also decode other data such as α_{frc}. In the case of FIGS. 20 and 21, α_{frc} is passed through from the SDI RX 2020, 2120, whereas in FIGS. 23 and 24, α_{frc} is decoded by subtracting an offset or shift of 64 at 2332, 2432. Although data decoders are not labelled separately from the error decoders in FIGS. 29, 31, 34, 36, and 39 in order to avoid congestion in these drawings, it should be appreciated that these embodiments may implement decoding of other data, such as α_{frc}, Y_{frc}, C_{frc}, as shown.

A receiver could include such a data decoder and an SDI transceiver operatively coupled to the data decoder. Such SDI transceivers are shown in the drawings by way of example as SDI RX interfaces.

In embodiments disclosed herein, a decoder side or receiver side SDI transceiver is to receive the link-compatible video mix parameter data α_{sdi} in first video slots (illustratively luminance slots) on the SDI link. Other data may be received in at least second video slots on the SDI link. Various examples of this are described above, and a receiver side SDI transceiver could receive such data in second and/or third video slots on the SDI link, such as chrominance and/or horizontal blank period slots for example. Data and/or signals transferred in video slots on the SDI link by a transmitter SDI transceiver would be received in those video slots on the SDI link by a receiver SDI transceiver that is coupled to the same SDI link.

A video processing system may include both a transmitter and a receiver. The transmitter includes a data encoder as disclosed herein and a first SDI transceiver, operatively coupled to the data encoder, to transfer the link-compatible video mix parameter data in first video slots on the SDI link, and to transfer the error data and additional-precision video mix parameter data that provides additional precision for the video mix parameter data in at least second video slots on the SDI link. In the preceding sentence “at least” is intended to refer to, for example, C slots, HB slots, or both. The receiver includes a second SDI transceiver, operatively coupled to the SDI link, to receive the link-compatible video mix parameter data, the error data, and the additional-precision video mix parameter data on the SDI link; and a data decoder, operatively coupled to the second SDI transceiver. The data decoder includes a data range converter to convert the link-compatible video mix parameter data into recovered video mix parameter data having the first range of permissible values; and an error correction module to apply the error data to the recovered video mix parameter data.

In such a video processing system, the transmitter could also include a third SDI transceiver coupled to receive the video data and to transfer the video data over a second SDI link, and the receiver could also include a fourth SDI transceiver, operatively coupled to the second SDI link, to receive the video data over the second SDI link. Separate video and alpha SDI links are shown, for example, in FIGS. 28, 33, and 38.

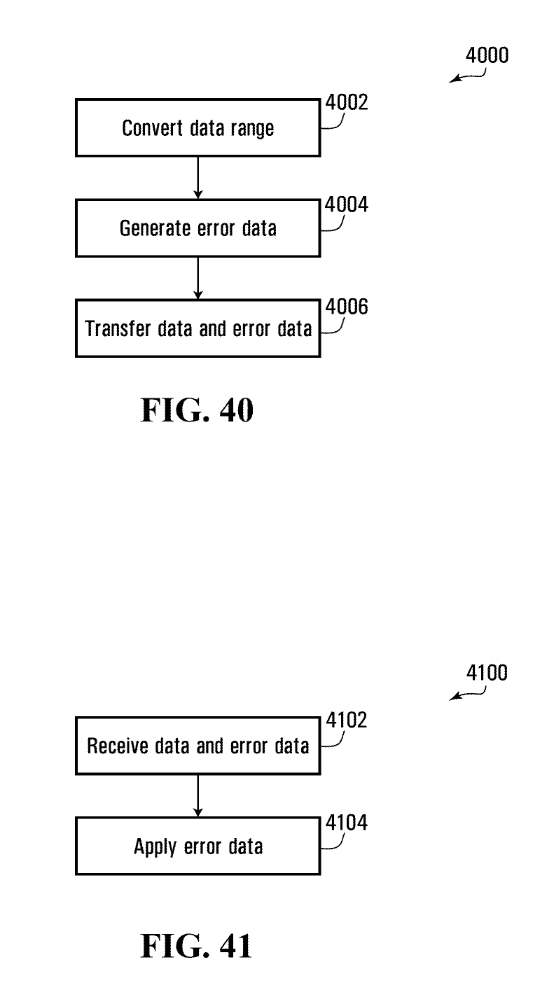

Method embodiments are also contemplated. FIGS. 40 and 41 are flow diagrams illustrating example methods.

The example method 4000 in FIG. 40 involves a data range conversion at 4002. Video mix parameter data that is associated with video data is converted into link-compatible video mix parameter data for transfer over an SDI link. As noted above, the video mix parameter data has a first range of permissible values, the link-compatible video mix parameter data has a second range of permissible values, and the second range is a range of values permissible for the SDI link and narrower than the first range. At 4004, error data for transfer over the SDI link is generated, based on the video mix parameter data and data range conversion the error data indicative of an error introduced by the data range conversion.

The generating at 4004 could involve generating the error data based on a difference between the video mix parameter data and scaled video mix parameter data, or generating the error data based on a difference between the video mix parameter data and video mix parameter data that has been scaled and subsequently upscaled.

In an embodiment, the method also involves transferring the link-compatible video mix parameter data in first video slots on the SDI link, and transferring other data or signals in at least second video slots on the SDI link. This is shown generally in FIG. 40 at 4006, and examples are also discussed below. The various data and signals are also discussed above with reference to illustrative data and signals shown in the drawings.

The transfer at 4006 could involve transferring the error data, concatenated with additional-precision video mix parameter data that provides additional precision for the video mix parameter data, in second video slots on the SDI link.

According to another embodiment, a method involves transferring, in second video slots on the SDI link, additional-precision video mix parameter data that provides additional precision for the video mix parameter data; and transferring a signal comprising the error data in third video slots on the SDI link.

A method could involve transferring, in second video slots on the SDI link, a signal that includes a concatenation of the error data, additional-precision video mix parameter data that provides additional precision for the video mix parameter data, and additional-precision video data that provides additional precision for a component of the video data.

In yet another embodiment, a method involves transferring, in second video slots on the SDI link, a signal that includes a concatenation of additional-precision video mix parameter data that provides additional precision for the video mix parameter data and additional-precision video data that provides additional precision for a component of the video data; and transferring a signal that includes the error data in third video slots on the SDI link.

A method could involve transferring, in second video slots on the SDI link, a signal that includes a concatenation of the error data, additional-precision video mix parameter data that provides additional precision for the video mix parameter data, additional-precision video data that provides additional precision for a first component of the video data, and additional-precision video data that provides additional precision for a second component of the video data.

Another embodiment of such a method involves transferring, in second video slots on the SDI link, a signal that includes a concatenation of additional-precision video mix parameter data that provides additional precision for the video mix parameter data, additional-precision video data that provides additional precision for a first component of the video data, and additional-precision video data that provides additional precision for a second component of the video data; and transferring a signal that includes the error data in third video slots on the SDI link.

In an embodiment, the transferring at 4006 involves transferring, in at least second video slots on the SDI link, the error data and additional-precision video mix parameter data that provides additional precision for the video mix parameter data. In this case the method could include other operations at a receiver, such as receiving the link-compatible video mix parameter data, the error data, and the additional-precision video mix parameter data on the SDI link; converting the link-compatible video mix parameter data into recovered video mix parameter data having the first range of permissible values; and applying the error data to the recovered video mix parameter data.

Receiver side method operations are shown in FIG. 41, which is a flow chart of another example method 4100. Link-compatible video mix parameter data and link-compatible error data that are transferred over an SDI link are received at 4102. The link-compatible error data is indicative of an error introduced in generating the link-compatible video mix parameter data, at a transmitter side, from video mix parameter data that is associated with video data. At 4104, the error data is applied in converting the received link-compatible video mix parameter into recovered video mix parameter data that is associated with the video data.

The method could also involve converting the received link-compatible video mix parameter data into converted video mix parameter data having a first range of permissible values, in which case the applying involves applying the error data to the converted video mix parameter data. The link-compatible video mix parameter data has a second range of permissible values, which is a range of values permissible for the SDI link and narrower than the first range.

FIGS. 40 and 41 are illustrative examples, and other embodiments may include further or fewer operations performed in a similar or different order. For example, various features disclosed herein with reference to apparatus embodiments could also or instead be embodied in method operations.

### CONCLUSION

What has been described is merely illustrative of the application of principles of embodiments of the present disclosure. Other arrangements and methods can be implemented by those skilled in the art.

For example, divisions of functions represented in the drawings are solely for illustrative purposes. Other embodiments could include fewer, more, and/or different components than explicitly shown, interconnected in a similar or different order. Methods could similarly include fewer, more, and/or different operations performed in a similar or different manner than explicitly shown and described herein.

In addition, although described primarily in the context of apparatus and methods, other implementations are also contemplated, as instructions stored on a non-transitory computer-readable medium, for example.

Under a target of L+M bits fraction for each layer mix truncation in parallel structures, for example, any of various data structures could be used to transfer the extra bits for higher precision and fit SDI standard links between parallel devices, where multiple video sources are layered to achieve visual effects for example. A target of L+M bits for fraction in each layer mix truncation could sustain high quality of multiple layer effects in parallel structures, and provide for substantially seamless switching between layers.

The extra data for higher precisions could include, for example,
1) Direct form of errors between source alpha integer part and downscaled alpha integer part or expansion form of errors between source alpha integer part and up-scaled alpha integer part, and
2) source alpha fractional part, and
3) source video fractional part in luma channel and chroma channel.

The expansion form of errors could be embedded into
1) MSBs in the horizontal active period in SDI signalling, or
2) in the horizontal blank period, packed within 10-bit error data covering 5-pixel error.

Extra data to accommodate the additional precision for alpha, luma, and chroma, could be assigned fairly with a number of bits, depending on the particular application. Different bit allocations produce various data structures such as
1) alpha-only structures
2) alpha+luma structures
3) alpha+luma+chroma structures.

As disclosed herein, each data structure could be combined with two methods of embedding the expansion form of errors.

There are also other possible structures which could fit specific applications, and the data structures disclosed herein allow for straightforward extension to other structures for potential applications, including
1) chroma-only structure to transfer extra video bits for special applications
2) luma-only structure, similarly to transfer extra video bits for special applications
3) various orders of concatenation between alpha data and video data, for example.

It should also be appreciated that although the present disclosure focuses on 10-bit data, it allows for extension to other data formats, such as 8-bit or 12-bit SDI, for instance, as defined in the above-referenced SMPTE 274M-2008.

Although the present disclosure does not define information in video payload identification codes for higher precision data, the techniques herein could be extended to user definition in payload codes, such as described in SMPTE ST 352, “Video Payload Identification Codes for Serial Digital Interfaces”.

The various concatenations and bit distributions described herein and/or shown in the drawings are also intended to be non-limiting examples. For instance, the direct form of error could be applied to an H blank data format as well. In the direct form of error as shown in FIG. 19, a 10-bit slot is used to carry 2-bit α_{frc} and 8-bit αₑᵣᵣ. Just as the 2-bit αₑᵣᵣ under expansion form of error can be carried in the H blank period, the 2-bit α_{frc} under direct form of error could be carried in this way, by packing 5 of them together in a 10-bit slot. The αₑᵣᵣ can then be expanded to 10 bits since the 2-bit α_{frc} is being carried in the H blank period.

Other structures, bit distributions, and/or ordering are also possible, and may vary between different applications, requirements, or precision targets.

We claim:

1. A data encoder comprising:
a data range converter to convert video mix parameter data that is associated with video data into link-compatible video mix parameter data for transfer over a Serial Data Interface (SDI) link, the video mix parameter data having a first range of permissible values and the link-compatible video mix parameter data having a second range of permissible values, the second range being a range of values permissible for the SDI link and narrower than the first range;
an error generator operatively coupled to the data range converter to generate, based on the video mix parameter data and data range conversion by the data range converter, error data for transfer over the SDI link, the error data indicative of an error introduced by the data range conversion.

2. The data encoder of claim 1, the error generator being operable to generate the error data based on a difference between the video mix parameter data and scaled video mix parameter data.

3. The data encoder of claim 1, the error generator being operable to generate the error data based on a difference between the video mix parameter data and video mix parameter data that has been scaled and subsequently upscaled.

4. A transmitter comprising:
the data encoder of claim 1;
an SDI transceiver, operatively coupled to the data encoder,
to receive the link-compatible video mix parameter data, the error data, and additional-precision video mix parameter data that provides additional precision for the video mix parameter data,
to transfer the link-compatible video mix parameter data in first video slots on the SDI link, and
to transfer the error data concatenated with the additional-precision video mix parameter data in second video slots on the SDI link.

5. A transmitter comprising:
the data encoder of claim 1;
an SDI transceiver, operatively coupled to the data encoder,
to receive the link-compatible video mix parameter data, additional-precision video mix parameter data that provides additional precision for the video mix parameter data, and a signal comprising the error data,
to transfer the link-compatible video mix parameter data in first video slots on the SDI link,
to transfer the additional-precision video mix parameter data in second video slots on the SDI link, and
to transfer the signal comprising the error data in third video slots on the SDI link.

6. A transmitter comprising:
the data encoder of claim 1;
an SDI transceiver, operatively coupled to the data encoder,
to receive the link-compatible video mix parameter data and a signal comprising a concatenation of the error data, additional-precision video mix parameter data that provides additional precision for the video mix parameter data, and additional-precision video data that provides additional precision for a component of the video data,
to transfer the link-compatible video mix parameter signal in first video slots on the SDI link, and
to transfer the signal comprising the concatenation in second video slots on the SDI link.

7. A transmitter comprising:
the data encoder of claim 1;
an SDI transceiver, operatively coupled to the data encoder,
to receive the link-compatible video mix parameter data, a signal comprising the error data, and a signal comprising a concatenation of additional-precision video mix parameter data that provides additional precision for the video mix parameter data and additional-precision video data that provides additional precision for a component of the video data,
to transfer the link-compatible video mix parameter data in first video slots on the SDI link,
to transfer the signal comprising the concatenation in second video slots on the SDI link, and
to transfer the signal comprising the error data in third video slots on the SDI link.

8. A transmitter comprising:
the data encoder of claim 1;
an SDI transceiver, operatively coupled to the data encoder,
to receive the link-compatible video mix parameter data and a signal comprising a concatenation of the error data, additional-precision video mix parameter data that provides additional precision for the video mix parameter data, additional-precision video data that provides additional precision for a first component of the video data, and additional-precision video data that provides additional precision for a second component of the video data,
to transfer the link-compatible video mix parameter data in first video slots on the SDI link, and
to transfer the signal comprising the concatenation in second video slots on the SDI link.

9. A transmitter comprising:
the data encoder of claim 1;
an SDI transceiver, operatively coupled to the data encoder,
to receive the link-compatible video mix parameter signal, a signal comprising the error data, and a signal comprising a concatenation of additional-precision video mix parameter data that provides additional precision for the video mix parameter data, additional-precision video data that provides additional precision for a first component of the video data, and additional-precision video data that provides additional precision for a second component of the video data,
to transfer the link-compatible video mix parameter data in first video slots on the SDI link,
to transfer the signal comprising the concatenation in second video slots on the SDI link, and
to transfer the signal comprising the error data in third video slots on the SDI link.

10. A video processing system comprising:
a transmitter comprising:
the data encoder of claim 1;
a first SDI transceiver, operatively coupled to the data encoder, to transfer the link-compatible video mix parameter data in first video slots on the SDI link, and to transfer the error data and additional-precision video mix parameter data that provides additional precision for the video mix parameter data in at least second video slots on the SDI link;
a receiver comprising:
a second SDI transceiver, operatively coupled to the SDI link, to receive the link-compatible video mix parameter data, the error data, and the additional-precision video mix parameter data on the SDI link;
a data decoder, operatively coupled to the second SDI transceiver, the data decoder comprising:
a data range converter to convert the link-compatible video mix parameter data into recovered video mix parameter data having the first range of permissible values;
an error correction module to apply the error data to the recovered video mix parameter data.

11. The video processing system of claim 10,
the transmitter further comprising a third SDI transceiver coupled to receive the video data and to transfer the video data over a second SDI link,
the receiver further comprising a fourth SDI transceiver, operatively coupled to the second SDI link, to receive the video data over the second SDI link.

12. A method comprising:
converting video mix parameter data that is associated with video data into link-compatible video mix parameter data for transfer over a Serial Data Interface (SDI) link, the video mix parameter data having a first range of permissible values and the link-compatible video mix parameter data having a second range of permissible values, the second range being a range of values permissible for the SDI link and narrower than the first range;
generating, based on the video mix parameter data and data range conversion, error data for transfer over the SDI link, the error data indicative of an error introduced by the data range conversion.

13. The method of claim 12, the generating comprising generating the error data based on a difference between the video mix parameter data and scaled video mix parameter data.

14. The method of claim 12, the generating comprising generating the error data based on a difference between the video mix parameter data and video mix parameter data that has been scaled and subsequently upscaled.

15. The method of claim 12, further comprising:
transferring the link-compatible video mix parameter data in first video slots on the SDI link;
transferring the error data, concatenated with additional-precision video mix parameter data that provides additional precision for the video mix parameter data, in second video slots on the SDI link.

16. The method of claim 12, further comprising:
transferring the link-compatible video mix parameter data in first video slots on the SDI link;
transferring, in second video slots on the SDI link, additional-precision video mix parameter data that provides additional precision for the video mix parameter data;
transferring a signal comprising the error data in third video slots on the SDI link.

17. The method of claim 12, further comprising:
transferring the link-compatible video mix parameter signal in first video slots on the SDI link;
transferring, in second video slots on the SDI link, a signal comprising a concatenation of the error data, additional-precision video mix parameter data that provides additional precision for the video mix parameter data, and additional-precision video data that provides additional precision for a component of the video data.

18. The method of claim 12, further comprising:
transferring the link-compatible video mix parameter data in first video slots on the SDI link;
transferring, in second video slots on the SDI link, a signal comprising a concatenation of additional-precision video mix parameter data that provides additional precision for the video mix parameter data and additional-precision video data that provides additional precision for a component of the video data;
transferring a signal comprising the error data in third video slots on the SDI link.

19. The method of claim 12, further comprising:
transferring the link-compatible video mix parameter data in first video slots on the SDI link;
transferring, in second video slots on the SDI link, a signal comprising a concatenation of the error data, additional-precision video mix parameter data that provides additional precision for the video mix parameter data, additional-precision video data that provides additional precision for a first component of the video data, and additional-precision video data that provides additional precision for a second component of the video data.

20. The method of claim 12, further comprising:
transferring the link-compatible video mix parameter data in first video slots on the SDI link;
transferring, in second video slots on the SDI link, a signal comprising a concatenation of additional-precision video mix parameter data that provides additional precision for the video mix parameter data, additional-precision video data that provides additional precision for a first component of the video data, and additional-precision video data that provides additional precision for a second component of the video data;
transferring a signal comprising the error data in third video slots on the SDI link.

21. The method of claim 12, further comprising:
transferring the link-compatible video mix parameter data in first video slots on the SDI link;
transferring, in at least second video slots on the SDI link, the error data and additional-precision video mix parameter data that provides additional precision for the video mix parameter data;
at a receiver:
receiving the link-compatible video mix parameter data, the error data, and the additional-precision video mix parameter data on the SDI link;
converting the link-compatible video mix parameter data into recovered video mix parameter data having the first range of permissible values;
applying the error data to the recovered video mix parameter data.

22. A data decoder comprising:
an input to receive link-compatible video mix parameter data and link-compatible error data that are transferred over a Serial Data Interface (SDI) link, the link-compatible error data being indicative of an error introduced in generating the link-compatible video mix parameter data from video mix parameter data that is associated with video data;
an error corrector, operatively coupled to the input, to apply the error data in converting the received link-compatible video mix parameter into recovered video mix parameter data that is associated with the video data.

23. The data decoder of claim 22, further comprising:
a data range converter to convert the received link-compatible video mix parameter data into converted video mix parameter data having a first range of permissible values, the link-compatible video mix parameter data having a second range of permissible values, the second range being a range of values permissible for the SDI link and narrower than the first range,
the error corrector being coupled to the data range converter, to apply the error data to the converted video mix parameter data.

24. A method comprising:
receiving link-compatible video mix parameter data and link-compatible error data that are transferred over a Serial Data Interface (SDI) link, the link-compatible error data being indicative of an error introduced in generating the link-compatible video mix parameter data from video mix parameter data that is associated with video data;
applying the error data in converting the received link-compatible video mix parameter data into recovered video mix parameter data that is associated with the video data.

25. The method of claim 24, further comprising:
converting the received link-compatible video mix parameter data into converted video mix parameter data having a first range of permissible values, the link-compatible video mix parameter data having a second range of permissible values, the second range being a range of values permissible for the SDI link and narrower than the first range,
the applying comprising applying the error data to the converted video mix parameter data.
